(19) United States
(12) Patent Application Publication
(10) Pub. No.: US 2008/0010365 A1
(43) Pub. Date: Jan. 10, 2008

(54) Methods, products, systems, and devices for processing reusable information

(76) Inventor: Eric Schneider, University Heights, OH (US)

Correspondence Address: ERIC SCHNEIDER, 1730 SOUTH FEDERAL HWY, #104, DELRAY BEACH, FL, 33483, US

(21) Appl. No.: 10/064,864

(22) Filed: Aug. 25, 2002

Related U.S. Application Data
(63) Continuation-in-part of application No. 09/683,481, filed on Jan. 5, 2002, now abandoned.
Application No. 09/683,481 is a continuation-in-part of application No. 09/683,465, filed on Jan. 3, 2002, now Pat. No. 6,678,717.
Application No. 09/683,465 is a continuation-in-part of application No. 09/682,351, filed on Aug. 23, 2001, now abandoned.
Application No. 09/682,351 is a continuation-in-part of application No. 09/682,133, filed on Jul. 25, 2001, now Pat. No. 7,194,552.
Application No. 09/682,133 is a continuation-in-part of application No. 09/681,448, filed on Apr. 7, 2001, now Pat. No. 7,120,236.
Application No. 09/681,448 is a continuation-in-part of application No. 09/663,094, filed on Sep. 15, 2000, now Pat. No. 6,944,658.
Application No. 09/663,094 is a continuation-in-part of application No. 09/653,100, filed on Aug. 31, 2000, now Pat. No. 6,760,746.
Application No. 09/653,100 is a continuation-in-part of application No. 09/650,827, filed on Aug. 30, 2000, now Pat. No. 6,901,436.
Application No. 09/650,827 is a continuation-in-part of application No. 09/598,134, filed on Jun. 21, 2000, now Pat. No. 6,895,430.
Application No. 09/598,134 is a continuation-in-part of application No. 09/532,500, filed on Mar. 21, 2000, now Pat. No. 7,136,932.
Application No. 09/532,500 is a continuation-in-part of application No. 09/440,606, filed on Nov. 15, 1999, now Pat. No. 6,442,549.
Application No. 09/440,606 is a continuation-in-part of application No. 08/900,437, filed on Jul. 25, 1997, now Pat. No. 5,987,464.

(51) Int. Cl. G06F 15/173

(52) U.S. Cl. 709/223

(57) ABSTRACT

In a communication network having at least one communication link connecting at least one provider and a client, where the at least one provider is in communication with at least one database storing at least one identifier having variable ownership status, a method includes establishing that at least one identifier of significance to the client is unavailable for ownership by the client, communicating to the at least one provider at least one desired action the at least one provider is to take on behalf of the client to obtain an ownership interest in the at least one identifier of significance to the client, where the at least one identifier of significance to the client is unavailable for ownership by the client at the time of the communication, and determining whether to perform the at least one desired action without monitoring the ownership status of the at least one identifier of significance to the client.

### CROSS REFERENCE TO RELATED APPLICATIONS

This application claims the benefit of the following patent applications, which are hereby incorporated by reference: U.S. patent application Ser. No. 09/683,481 filed Jan. 5, 2002, by Schneider, entitled “Method, product, and apparatus for resource identifier registration and aftermarket services”. U.S. patent application Ser. No. 09/683,465 filed Jan. 3, 2002, by Schneider, entitled “Method, product, and apparatus for requesting a network resource”, U.S. patent application Ser. No. 09/682,351 filed Aug. 23, 2001, by Schneider, entitled “Fictitious domain name method, system, product, and apparatus”, U.S. patent application Ser. No. 09/682,133 filed Jul. 25, 2001, by Schneider, entitled “Method, product, and apparatus for requesting a network resource”, U.S. patent application Ser. No. 09/681,448 filed Apr. 7, 2001, by Schneider, entitled “Notification method, product, and apparatus”, U.S. patent application Ser. No. 09/663,094 filed Sep. 15, 2000, by Schneider entitled “Method, product, and apparatus for resource notification”, U.S. patent application Ser. No. 09/653,100 filed Aug. 31, 2000, by Schneider, entitled “Method, product, and apparatus for processing a data request”, U.S. patent application Ser. No. 09/650,827 filed Aug. 30, 2000, by Schneider, entitled “Method, product, and apparatus for determining the availability of similar identifiers across naming systems”, U.S. patent application Ser. No. 09/598,134 filed Jun. 21, 2000, by Schneider, entitled “Method and apparatus for integrating resolution services, registration services, and search services”, U.S. patent application Ser. No. 09/532,500 filed Mar. 21, 2000, by Schneider, entitled “Fictitious domain name method, product, and apparatus”, U.S. patent application Ser. No. 09/440,606 filed Nov. 15, 1 999, by Schneider, entitled “Method, product, and apparatus for processing reusable information”, which claims the benefit of U.S. patent application Ser. No. 08/900,437 filed Jul. 25, 1997, by Schneider entitled “Method and apparatus for periodically updating data records having an expiry time”, which claims the benefit of U.S. Provisional Application Ser. No. 60/022,714 filed Jul. 26, 1996, by Schneider entitled “Method of information delivery and use.”

### BACKGROUND OF INVENTION

1. Field of the Invention

This invention generally relates to methods and systems of providing information, and more specifically relates to methods, products, systems, and devices for processing reusable information.

2. Description of the Related Art

Law divides property into real property (e.g., real estate, personal property) and intellectual property (e.g., patents, trademarks, copyrights, trade secrets). Lack of maintaining such property rights due to failure of payment may cause such property right to lapse and become transferred, expired, abandoned, or forfeited. A property may further enter the public domain upon lapse of property right. Such lapsed properties become the effect of a failed or forfeited transaction and can either be auctioned off or remain an end result with no additional steps taken after the term of a terminable property right lapses.

In exchange for disclosure of an invention, the issuance of a U.S. patent is a twenty year grant from the time filed by the government of a property right to the inventor to ‘exclude others from making, using, or selling the invention’, with the patentee losing rights to the invention upon expiration. Title 37 Code of Federal Regulations (CFR), Section 1.362(d) provides that maintenance fees may be paid without surcharge for the six-month period beginning three, seven, and eleven years after the date of issue of patents based on applications filed on or after Dec. 12, 1980. An additional six-month grace period is provided by 35 U.S.C. 41(b) and 37 CFR 1.362(e) for payment of the maintenance fee with the surcharge set forth in 37 CFR 1.20(h), as amended effective Dec. 16, 1991. If the maintenance fee is not paid in the patent requiring such payment the patent will expire on the fourth, eighth, or twelfth anniversary of the grant. Eleven years since the first premature patent expiration in December 1985, over 275,000 patents have prematurely expired and entered the public domain with additional 1,000 patents prematurely expiring each week.

A common use of patent information and an early step in assessing the patentability of an invention is to perform prior art searches of existing patents. To assist patent examiners, the Automated Patent System (APS) was implemented in April of 1984 by the U.S. Patent and Trademark Office (PTO) with over 400 million dollars of taxpayer money to provide sophisticated centralized on-line search capabilities. U.S. patents offered by commercial data vendors is based on sole-source data furnished by the USPTO. USPTO offers copies of data that include information used as input in the building of the APS database. The early expiration of a patent has never been a search requirement for the patent examiner. As a result, there has been no need for the USPTO to incorporate this new reference information into the APS database. Currently, the APS database is the representation of the original library files of patent text data at the time of issuance and does not provide a data field for the premature expiration status of a patent. Though this is the primary source of data provided for sale by the USPTO, commercial data vendors in turn have not recognized the potentially unrealized value of premature expiration information.

It is government's responsibility to publish what the public can not make, use, or sell. Aside from disclosure of the full patent document, the government also publishes the front-page information of the patent document in the Official Gazette. The following is from Chapter 2575 of the Manual of Patent Examining Procedure (MPEP) Sixth Edition, Revision 1, September 1995. “A notice will appear in each issue of the Official Gazette which will indicate which patents have been granted 3, 7, and 11 years earlier, that the window period has opened, and that maintenance fee payments will now be accepted for those patents. Another Official Gazette notice published after expiration of the grace period will indicate any patent that has prematurely expired due to nonpayment of maintenance fees and any patents that have been reinstated. An annual compilation of such expirations and reinstatements will also be published.”

This passage denotes the intention of government to publish what the public can make, use, or sell. All patents prior to December 1985 expire seventeen years after being granted. For example, if it is the first week of the year 1996 and the public wanted to read what patents had just expired, one would look at the Official Gazette from the first week of 1979. Essentially a book published seventeen years ago would be retrieved. For the first 195 years of the U.S. Patent System, there was no need to republish or compile expired patent information because it was previously published by default.

On Dec. 10, 1985, nearly 200 years since the first patent issued, the Official Gazette (OG) Notice had listed Pat. No. 4,291,808 to become the first patent ever to prematurely expire for failure to pay maintenance fees. Since then, the USPTO has published weekly in the OG notices the patent numbers of the expiring patents. The release of the patent numbers only, limits the public to a manual, exhaustive, and inefficient cross-referenced retrieval of the newest patent documents that have prematurely expired, thereby creating for the first time a new need to compile this information. In addition, USPTO publishes weekly in OG notices the serial and registration numbers of expiring trademarks. The release of trademark identifiers only, limits the public to a manual, exhaustive, and inefficient cross-referenced retrieval of the newest trademark information that have expired, thereby creating a new need to compile this information for the purpose of mitigating such unnecessary use of human resources. More recently, since the 23rd week of 2001, the USPTO has reflected these trademark identifiers in electronic OG notices accessible via the Internet but yet there remains no such data source that has presented each week such expiring trademark images and words corresponding to each such published serial number.

In 1987, the USPTO released a series of CD-ROM subscription products including the Classification and Search Support Information System Bibliographic disc (CASSIS-BIB). This disc offers the search and retrieval of title-only patent information dating back to 1969. The subscriber can search for the status of a patent (withdrawn, reinstated, abandoned, or prematurely expired) and view the most current list of premature expired patents. Although the release of the CASSIS-BIB disc can help with the search of patent expirations and allows the subscriber the privacy and cost benefits of such a system, searching is limited to patent titles only, the disc is updated every two months and is not cost effective to update more frequently.

Because of significant changes in technology, revisions to the Office of Management and Budget (OMB) Circular A-130, and the passage of the Paperwork Reduction Act of 1995 (Public Law 104-13), public access has further expanded through a variety of programs administered by the USPTO's Office of Information Dissemination to include the access of patent and trademark information made available via the Internet and USPTO Bulletin Board System (PTO-BBS). Upon browsing Internet sites, patent servers at the Center for Networked Information Discovery and Retrieval (CNIDR), Community of Science, Chemical Abstracts Society (CAS), and IBM to name a few, have all neglected to allow searching for the expiration status of a patent. The IBM Patent Server has come closest to this accomplishment where on Jun. 4, 1997, a maintenance status field was integrated into the database which lists the status of a patent upon retrieval only, and is not yet a searchable field.

In November of 1994 the USPTO established an on-line BBS. The USPTO began to list exclusive files of premature expired patent numbers weekly and list master files of premature expired patent numbers every two months. The patent numbers are published in natural ascending order, and for more than ten years have been keyed in manually by the USPTO. As a result, it is not uncommon to see occasional errors like the reversal of digits within the patent number based on an operator's manual entry. In 1995, the USPTO added the release of the OG Notices on-line. In the OG Notice on Feb. 6, 1996, the USPTO published the premature expired patent numbers for the week of Feb. 13, 1996 instead of the current week. On Mar. 12, 1996 the OG corrected the omission while the USPTO-BBS did not. Since then, the exclusive files have been reported one week ahead of the OG Notices upon issue. The master list of premature expired patent numbers released on the USPTO-BBS for Dec. 31, 1996 omitted about 6,000 premature expired patent numbers. This omission represents the eight and twelve year expirations since the previous master list on Oct. 31, 1996. This omission is in turn reflected in the December 1996 issue of the CASSIS-BIB CD-ROM. There were further omissions in the February 1997 issue and the CASSIS-BIB subscription disc does not remain corrected to this date. In May 1997, the USPTO-BBS shut down due to a diminished user base and the increasing popularity of the Internet. The above inconsistencies indicate that there is no system for detecting error or omission that may be subject to manual labor or clerical errors. The issuance of the premature expired patent numbers by the USPTO has now become questionable in regard to method, policy, and accuracy of its use.

USPTO in effect performs the function as sole source data provider of patent and trademark information and has never allowed direct access to fee payment information except by responding at most to a handful of payment information requests at a time by customers via telephone. Only recently, has the USPTO enabled access to maintenance fee payment information via the Patent Application Information Retrieval (PAIR) system, however such payment information remains distributed and has never before been available to the public as a centralized data source.

In order to track updated status information for patents and pending patent applications, such as examiner name, assigned art unit and class/subclass, etc., applicants and/or their representatives can have the ability to interface to USPTO's Patent Application Information Retrieval (PAIR) system using appropriate digital certificates. Some providers have released software for automating the process of periodically manually checking for updates on the USPTO-PAIR web page. For instance Oppedahl & Larson LLP has released a status monitoring program called Partridge for monitoring U.S. patent applications, “http://www.patents.com/partridge”. The software allows a user to build up a list of their own U.S. patent applications and patents to monitor. Though the software is helpful for periodically obtaining the status and any changes of each patent application and/or patent, there is no mechanism for obtaining maintenance fee payment information nor does the software, provide a generalized mechanism for determining which patents issued in a given week have been previously published while still pending.

U.S. Pat. No. 6,298,327 issued on Oct. 2, 2001 by Hunter, et al., entitled, “Expert support system for authoring invention disclosures” discloses a computer-implemented expert support system for authoring invention disclosures and for evaluating the probable patentability and marketability of a disclosed invention. Though a knowledgebase having a plurality of invention disclosure rules and patentability rules is disclosed, such a knowledgebase pertains to the knowledge needed for drafting a patent application only and does not pertain to knowledge about the inventor nor knowledge about a pre-grant patent publication or issued patent.

U.S. Published Patent Application 20020069080, published on Jun. 6, 2002 by Roy, et al., entitled, “System for cataloging, inventorying, selecting, measuring, valuing and matching intellectual capital and skills with a skill requirement” discloses a system for matching intellectual capital skills and matching or inquiring of an individual's skills, and particularly to a system for finding candidates for an employment or consulting position having requisite skills, and more particularly to a system for creating a searchable knowledge base of individuals skills indexed in a hierarchical cataloging, measuring and valuation system. Though an improved employment matching system based on intellectual capital is disclosed, there is know mention of marketing employment opportunities specifically to inventors by accessing public patent data to assist in identifying and locating inventors that may qualify for employment opportunities. Furthermore, there is no mention of building or accessing an inventor knowledgebase.

As previously provided in co-pending patent application Ser. No. 09/440,606 methods of information delivery and updating extend far beyond the field of patent and trademark information. For instance, Applicant has shown the need for distributing encrypted confidential/unreleased information to a subscriber in advance of a release date. Other art including, U.S. Pat. No. 6,324,650 issued on Nov. 27, 2001 by Ogilvie, entitled, “Message content protection and conditional disclosure” discloses methods and systems for controlling the disclosure of sensitive information. Disclosure is controlled in the sense that the information is not disclosed until predefined conditions are met, such as the passage of a certain time, copies of the information are protected by encryption and hidden in a network, so that at least one copy will be available when disclosure is required, and when disclosure is required, the information is sent to predefined destinations such as email addresses or posted to web sites, in a predefined format. Though confidential information is distributed before it is to be made available, released information is only first sent to the intended recipient after such information is made available, which does not solve the associated bandwidth and synchronization problems of delivering such newly available information to subscribers and/or the public.

New information generated from the renewed availability of potentially reusable old information is also applicable to any forfeited property (real or intellectual) including real estate, copyrights, domain names, license plate identifiers, telephone numbers, IP addresses, keywords, stock symbols, and station identifiers to name a few. Name space is a set of names in which all names are unique. Address space is a set of addresses in which all addresses are unique. Names are commonly used as mnemonic devices to help remember information. For instance, names are used to remember telephone numbers, and domain names are used to remember Internet addresses.

Currently, national phone numbers take the form of an international dialing code, area code, prefix, and number (e.g., 1-212-555-1212). During the turn of the century, phone companies built “exchanges” known as Central Offices to serve a certain geographical area. The exchange was named after the first prefix installed in that office. Before phones had dials on them, an operator connected the caller's request to the name of the exchange and number, such as Spring 3456 or Pennsylvania 5000. In the late 1920's, once dials started appearing on phones, a caller could connect the phone number by first dialing the first three letters of the exchange and then the number. For example, the caller would dial the S-P-R in Spring and then the 3456 or the P-E-N in Pennsylvania 5000. Back then, phone numbers were written with the dialed letters capitalized such as SPRing 3456 and PENnsylvania 5000, as a mnemonic device.

By the 1930s, large cities were dropping the third letter from the dialing routine and replacing it with a number, in order to increase the available numbers for each exchange. So numbers such as SPRing 3456 would become SPring2-3456 and PENnsylvania 5000 would become PEnnsylvania6-5000. This simple change added 80,000 new numbers to existing exchanges. Exchange names helped foster a sense of place, and community, in the same way that cities do. For over 30 years exchange names were published in phone directories and had become common use worldwide.

Telephone calls are routed from a calling Subscriber to a called Subscriber through a network of switches. Subscribers connected to a common switch, are assigned a unique directory number, NXX-XXXX, where “N” refers to any digit except 0 or 1 and “X” refers to any one of 10 digits. The telephone system divides the United States into “area codes”, more technically referred to as Numbering Plan Area (NPA). When a call is made from one “area code” to another “area code”, the three digit Numbering Plan Area code, NPA, prefix must be supplied to the called Subscriber's directory number (DN). Thus, in effect, each telephone Subscriber is associated with a unique ten digit directory number; NPA-NXX-XXXX.

By the early 1960's, area codes were being used up faster than was predicted in 1947 when the area code scheme was finalized as part of the North American Numbering Plan (NANP). As a result, exchange names were continually being reassigned causing confusion and aggravation in communities throughout major cities in the country. During the early 1970's, as exchange names were phased out and 1-800 toll free numbers introduced, industry recognized and extended the use of mnemonics for commercial advertising and name branding. During the 1980's, 1-800 names were popularized to the point where brokers would buy names with the hope of selling or leasing the 1-800 names from their growing portfolio. In fact, courts have almost unanimously held that telephone mnemonics may be protected as trademarks. In recent years, the shortage of seven letter names used as a mnemonic device led to the strategy for obtaining telephone numbers that correspond to eight and nine letter names. In recent years, two new toll free exchanges (1-888, 1-877) were added due to the saturation of 1-800 numbers. Exchange names are but one example of name space. A recent area of worldwide concern is the allocation of name space on the Internet.

The Internet is a vast computer network having many smaller networks that span the entire world. A network is a distributed communicating system of computers that are interconnected by various electronic communication links and computer software protocols. Because of the Internet's distributed and open network architecture, it is possible to transfer data from one computer to any other computer world wide. In 1991, the World-Wide Web (Web or WWW), revolutionized the way information is managed and distributed through the Internet.

The Web is based on the concept of hypertext and a transfer method known as Hypertext Transfer Protocol (HTTP) which is designed to run primarily over a Transmission Control Protocol/Internet Protocol (TCP/IP) connection that employs a standard Internet setup. A server computer may provide the data and a client computer may display or process it. TCP may then convert messages into streams of packets at the source, then reassembles them back into messages at the destination. Internet Protocol (IP) handles the addressing, seeing to it that packets are routed across multiple nodes and even across multiple networks with multiple standards. HTTP protocol permits client systems connected to the Internet to access independent and geographically scattered server systems also connected to the Internet. Client side browsers, such as Netscape Navigator or Microsoft Internet Explorer provide efficient graphical user interface (GUI) based client applications that implement the client side portion of the HTTP protocol. One format for information transfer is to create documents using Hypertext Markup Language (HTML). HTML pages are made up of standard text as well as formatting codes that indicate how the page should be displayed. The client side browser reads these codes in order to display the page.

A web page is static when it requires no variables to display information or link to other predetermined web pages. A web page is dynamic when arguments are passed which are either hidden in the web page or entered from the client browser to supply the necessary inputs displayed on the web page. Common Gateway Interface (CGI) is a standard for running external programs from a web server. CGI specifies how to pass arguments to the executing program as part of the HTTP server request. Commonly, a CGI script can take the name and value arguments from an input form of a first web page which is be used as a query to access a database server and generate an HTML web page with customized data results as output that is passed back to the client browser for display.

A Uniform Resource Identifier (URI) is a compact string of characters for identifying an abstract or physical resource. URIs, is the generic set of all names and addresses that refer to objects on the Internet. URIs that refer to objects accessed with existing protocols are known as URLs. A URL is the address of a file accessible on the Internet. The URL contains the name of the protocol required to access the resource, a domain name or IP address that identifies a specific computer on the Internet, and a hierarchical description of a file location on the computer. For example the URL “http://www.example.com/index.html”, where “http:” is the scheme or protocol, “//www.example.com” is the fully qualified domain name FQDN), and “/index.html” is the filename located on the server.

Because an Internet address is a relatively long string of numbers (e.g., 31.41.59.26) that is difficult to remember, Internet users rely on domain names, memorable and sometimes catchy words corresponding to these numbers, in order to use electronic mail (e-mail) and to connect to Internet sites on the Web. The Domain Name System (DNS) is a set of protocols and services on a network that allows users to utilize domain names when looking for other hosts (e.g., computers) on the network. DNS is composed of a distributed database of names. The names in the DNS database establish a logical tree structure called the domain name space. Each node or domain in the domain name space is named and can contain subdomains. Domains and subdomains are grouped into zones to allow for distributed administration of the name space.

A domain name includes two parts: a host and a domain. Technically, the letters to the right of the “dot” (e.g., unames.com) are referred to as Top Level Domains (TLDs), while hosts, computers with assigned IP addresses that are listed in specific TLD registries are known as second-level domains (SLDs). For the domain name “unames.com”; “.com” is the TLD and “unames” is the SLD. Domain name space is the ordered hierarchical set of all possible domain names either in use or to be used for locating an IP address on the Internet. TLDs are known as top-level domains because they comprise the highest-order name space available on the Internet. Second-level domains, as well as third-level domains (3LDs) such as “my.unames.com”, are subsidiary to TLDs in the hierarchy of the Internet's DNS. There are two types of top-level domains, generic and country code.

Generic top-level domains (gTLDs) were created to allocate resources to the growing community of institutional networks, while country code top-level domains (ccTLDs) were created for use by each individual country, as deemed necessary. More than 200 national, or country-code TLDs (e.g., United States (.us), Japan (.jp), Germany (.de) etc.) are administered by their corresponding governments or by private entities with the appropriate national government's acquiescence. A small set of gTLDs does not carry any national identifier, but denote the intended function of that portion of the domain space. For example, “.com” was established for commercial networks, “.org” for not-for-profit organizations, and “.net” for network gateways. The set of gTLDs was established early in the history of the DNS and has not been changed or augmented in recent years (COM, ORG, GOV, and MIL were created by January 1985, NET in July 1985, and INT was added in November 1988).

The DNS is operated by a Network Information Center (NIC) in each country to act as authority for administering the respective ccTLD zone file portion of the DNS database. The Internet Network Information Center (InterNIC), which administered by the National Science Foundation (NSF), was formed to preside as authority over the gTLD zone files. In 1993, InterNIC was privatized and Network Solutions Inc. (NSI) performed the registration and propagation of these key gTLDs, under a five-year cooperative agreement with the NSF. The agreement, extended until March 2000 was to have originally expired March 1998.

Beginning Sep. 14, 1995, the Cooperative Agreement directed the Registrar to require direct payment from domain name applicants/registrants for registration and renewal of the domain names at the second level of the five listed top-level domains. New registrations had until January 2001 been in effect for a mandatory two-year period. Near the end of the initial two-year registration period, and every year thereafter, a Registrar will send an invoice for re-registering the domain name. Therefore the date of the first domain name to ever become newly available to the public due to failure to pay a renewal fee was in September 1997. However, U.S. Pat. No. 5,987,464 filed Jul. 25, 1997 by Schneider (parent application to Ser. No. 09/440,606) states that delivery and updating methods are applicable to the renewed availability of domain name related information solving a need several months before the need became evident.

Incorporated and headquartered in California, the Internet Corporation for Assigned Names and Numbers (ICANN) is the non-profit corporation that was formed to take over responsibility for the IP address space allocation, protocol parameter assignment, domain name system management, and root server system management functions now performed under U.S. Government contract by Internet Assigned Numbers Authority (IANA) and other entities. The IANA, also headquartered in California, is the overall authority for day-to-day administration of the DNS. IANA staff carry out administrative responsibilities for the assignment of IP Addresses, Autonomous System Numbers, TLDs, and other unique parameters of the DNS and its protocols.

With respect to domain name management, the term “registry” refers to an entity responsible for managing allocation of domain names within a particular name space, such as a TLD. The term “registrar” refers to any one of several entities with authority to add names to the registry for a name space. Entities that wish to register a domain name do so through a “registrar”. The term “registrant” refers to the entity registering the domain name. In some name spaces, the registry and registrar functions can be operated by the same entity, so as to combine the concepts and functions of the registrar and registry. The combined registry-registrar model is implemented in many ccTLDs and a few gTLDs. By Jun. 1, 1999, Network Solutions (NSI) Registry (now VeriSign) had implemented a shared registration system (SRS) to support multiple licensed, accredited registrars offering registration services.

VeriSign Global Registry Services (GRS) is the leading provider of domain name registry services and DNS support to the Internet and is responsible for the infrastructure that propagates this information throughout the Internet and responds to over 1.5 billion DNS look-ups daily. The registry stores information about registered domain names and associated name servers. A domain name's data includes its name, name servers, registrar, registration expiration date, and status. A name server's data includes its server name, IP addresses, and registrar.

As explained in S. Hollenbeck, et. al, “Informational RFC (Request for Comment) 2832: NSI Registry Registrar Protocol (RRP) Version 1.1.0”, Internet Engineering Task Force (IETF), May 2000, “http://www.faqs.org/rfcs/rfc2832.html” and in S. Hollenbeck, “Informational Draft: Extensible Provisioning Protocol (EPP)”, Internet Engineering Task Force (IETF), Oct. 2, 2001, “http://www.ietf.org/internet-drafts/draft-ietf-provreg-epp-05.txt”, VeriSign GRS has developed a registration protocol for use within the SRS. Internet domain name registration typically involves three entities: a registrant who wishes to register a domain name, a registrar who provides services to the registrant, and a registry that provides services to the registrar while serving as the authoritative repository of all functional information required to resolve names registered in the registry's TLDs. EPP is an XML protocol that can be layered over multiple transport protocols and provides four basic service elements: service discovery, commands, responses, and an extension framework that supports definition of managed objects and the relationship of protocol requests and responses to those objects.

A Registrar may access the Registry via RRP or EPP to perform registration service procedures such as determining if a domain name has been registered, registering a domain name, renewing the registration of a domain name, canceling the registration of a domain name, updating the name servers of a domain name, transferring a domain name from another registrar, examining or modifying the status of domain names that the registrar has registered, determining if a name server has been registered, registering a name server, updating the IP addresses of a name server, deleting a name server, and examining the status of name servers that the registrar has registered.

Domain name registrant information for a given NIC authority can be accessed by a TCP/IP application called WHOIS, which queries a NIC database to find the registration date, the name of network and system administrators, system and network points-of-contact, and other individuals who are registered in appropriate databases. Domain names are identifiers used for both accessing a resource and retrieving contact information of the registrant or domain name holder of that resource. The availability of a domain name from a NIC authority for a given TLD can usually be determined by submitting a WHOIS request.

Though the WHOIS database is a collection of facts and therefore can not be copyrighted. NSI has been asserting claims of ownership of the WHOIS database based on “sweat of the brow” or by the labor of collecting and compiling customer data. On Jan. 21, 1999 an on-line CNET News article quotes a NSI spokesperson, “There does not seem to be any reason why third parties need to know the anniversary date or status of domain names for which they have no association and, if they do feel they need this information, they could contact the registrant to request this information”. On Jan. 19, 1999 another on-line CNET News article reports, “In an apparent attempt to combat the speculators, NSI today stopped disclosing in its WHOIS database whether domain names are on hold or when the address was originally registered. NSI deems a site on hold when it has been suspended for any number of reasons, such as nonpayment of fees. The information—which, until today, had been a part of the database for years—makes it easier for people to guess when a popular site that is on hold—for example e-shopping.com—will become available.”

It is apparent from these news articles that there is an ongoing struggle for control and ownership of the WHOIS database. Tactics have been used to suppress the domain name registration date from the results of a WHOIS query or control the distribution of the TLD zone files, which is critically relied on by all devices connected to the Internet for the purpose of name resolution. Certainly, at a minimum the domain name and registration date, is not “customer data” and is considered fact that the public should have access to. These measures are an attempt to inhibit the public from snatching up domain names that are newly available and fall back into the public domain.

Though co-pending patent application Ser. No. 09/440,606 discloses an identifier back-ordering system where a provider in communication with a client provides to the client, identifiers such as domain names and telephone numbers that are unavailable for registration, and in turn, receives a request from the client to either reserve, subscribe, reserve, queue, pre-order, pre-register, order, and/or monitor at least one selected identifier with the provider, U.S. Published Patent Application 20020091827, published on Jul. 11, 2002 by King, et al., entitled, “Domain name acquisition and management system and method” discloses improvements to such a back-ordering system by showing how the success rate of re-registering a newly available domain name can be increased. A high success rate in domain name acquisition can be achieved by implementing a “deleting domain name acquisition cluster” which is a distributed system designed to monitor and register domain names as soon as possible after they are deleted from a registry. Domain names found to be in a state of near availability are transmitted to one or more of the acquisition arrays.

On Jul. 16, 2001 VeriSign published an advisory, entitled, “Equitable Allocation of Shared Registration System Resources”, which states that “the deletion and subsequent availability of large numbers of domain names have caused a domain “land rush” during certain hours of the day. During these daily “land rushes” some registrars acquire unnecessarily large numbers of RRP sessions, making it difficult for other registrars to acquire the minimal number needed to conduct normal business.” A second advisory was published by VeriSign on Aug. 10, 2001 stating that “batch releases of deleted .com, .net and .org domain names will be temporarily suspended to assure continued service quality within the SRS. They will be released once a satisfactory plan is implemented to return them to the pool of available names under which all registrars Receive Equivalent Access.”

The abuse of SRS system resources can be attributed to factors such as not knowing precisely when or which domain names are purged from the registry, an accelerating domain name expiration rate, particularly in the “.com” registry, and the increased organization of resources among the growing number of competing accredited registrars. Though a registry can be considered a sole-source data provider, no registry has ever published in advance precisely when which domain names are to become soon to be or newly available for registration because this might create too much demand or even chaos in a first come first serve (FCFS) system. Instead, further strain and load by unnecessarily over accessing other system resources such as name servers, zone files, and WHOIS databases is becoming increasingly abused in an attempt to determine which domain names have the potential to soon be available for registration.

Similarly telephone numbers, are a valuable and finite resource. Number resource management has become a critical function of telecommunications service providers. When a subscriber or provider terminates service of a telephone number, the telephone number is held ninety days for residents and one year for businesses before released and made available to other subscribers. During this pending time, a subscriber may renew service so it is unclear as to what telephone numbers are inevitably available on the given telephone number release date. Telephone number availability has remained to this day transparent and unquestioned by the public. It is the public's right to know both what is and what is not available property in order to make an informed decision.

The process of managing and tracking numbers, available to a local service customer base is predominantly manual, increasing potential for error and loss of data integrity. A common cause of rejects during the telecommunications service provisioning process is directly related to the use of numbers that are already in service or do not belong to the telecommunications service provider. Lack of specific business rules regarding number reservation and assignment have caused an inefficient use of the numbers and have negatively impacted sales and revenue. It would be desirable to provide an integrated means for managing number resources, including the reservation, assignment, and status tracking of local telephone numbers and would be additionally desirable to provide a highly automated process enabling local sales personnel and order entry staff of a telecommunications service provider immediate access to available number resources for expedient processing of customer orders.

U.S. Pat. No. 6,298,352 issued on Oct. 2, 2001 by Kannan, et al., entitled, “Apparatus and method for managing number sources” discloses a Number Resource Management (NRM) system that provides an integrated means for the reservation, assignment, status tracking, and overall management of local telephone numbers (TNs) including those numbers that are assigned to a carrier by a Public Utility Commission (PUC) or other regulatory body, and those numbers that port into a carrier when a customer leaves one carrier and signs up for local service with another carrier. In addition, NRM provides automated interfaces with other systems to provide an overall local number management system that is tied in with the local service order entry and provisioning process. Unfortunately, such a NRM system is not adapted to be in any communication with a national phone number status database enabling such system functions to operate regardless of geography.

The specified NRM also tracks the status of each TN including the following statuses. “OPEN”—which status indicates that the TN is available for reservation/assignment. For example, when a new TN number is first entered into NRM, or, after a disconnected number has been aged for a certain time, it is assigned a status of “OPEN”. “RESERVE”—which status indicates that a TN has been reserved for a customer and is typically performed by a sales agent via the NRM graphical user interface (GUI). “ASSIGN”—which status indicates that a TN has been assigned to a customer service order which assignment is typically performed by Service Resource Management System (“SRMS”) which is a service order entry and provisioning system used to enter and provision orders for local services for customers, and can automatically assign telephone numbers to a customer. “WORKING”—which status indicates that the service order to which a number is assigned has been provisioned. This is performed by SRMS, when the number has been successfully provisioned in a switch. “SUSPEND”—which status indicates that a TN is reserved for a customer, but will not be activated for some time, usually a limited time period. Numbers may be kept reserved for a customer only for that limited time. This is typically performed by a sales agent via the NRM GUI. “DISCONNECT”—which status indicates that the service to which a number was assigned has been disconnected. To perform a number disconnect, a sales agent enters a service disconnect order in SRMS. When the order is completed, SRMS sends a message to NRM to update the status of the associated number(s) from “working” to “disconnected”. The update to a “Disconnect” status begins an aging process whereby a disconnected number must be kept in this status for a defined time period (e.g., 60 days), after which it is automatically updated by NRM to a status of “OPEN”. The aging process thus allows a number that has been disconnected to be available to the customer for some time period, in case the customer comes back and wants to activate the number again.

Accordingly, in light of the above, there is a strong need in the art to overcome such limitations by providing new methods, products, systems, and devices for processing reusable information.

### SUMMARY OF INVENTION

The present invention optimizes the on-line transmission size of time sensitive information to a subscriber. The invention utilizes renewal information and previous expiration information to increase the subscription period. The present invention minimizes the use of using portable storage media by buffering or caching data to be used in the near future. The invention provides a hands-free automated clipping service to encourage the potential use and easier access of information to the public.

The present invention provides an automated preview service that utilizes the time delay between receiving control/reference data for building newly available information and receiving newly issued information. The invention reduces the search and retrieval time for accessing master database information and newly available information. The present invention also implements methods of verification to assure the accuracy and reliability of newly available information. The invention streamlines the document delivery process by accessing document images off-line. The invention maintains privacy of a subscriber's query off-line and when possible limits on-line to retrieval only, of for querying non-semantic or keyword search strategies, such as but not limited to classification and cross-reference searching.

The present invention uses Service Providers (SPs) for tiered subscribing to act as a proxy on behalf of their clients (other subscribers) allowing for less distribution costs, reduced network bandwidth from data queries and updates, and privacy to the end user when querying and accessing data while the invention remains ubiquitous but yet transparent to the end-user. The invention allows for small portions or recursively smaller portions of large databases (compiled or distributed) to be updated by sending both a query and encoded bit mask for determining a query subset that is compiled and constitutes new use. The present invention provides an arrangement of first data of a first data size at a first time for the purpose of generating a second data at a second time having a data size that is minimized with respect to the first data size.

The present invention provides a status checkbox for determining which index to select and use for retrieving data from a main database rather than or in addition to determining whether to select a main or expired database. The invention provides a payment/monitoring gateway system that can be adapted to broker payment monitoring requests and payment transaction requests between the public, government, and its customers. The present invention provides a means for back-ordering identifiers such as domain names, telephone numbers, trademarks, and license plate identifiers. The invention enables the processing of any identifiers determined available for pre-order or back-order in response to determining that such an identifier is newly provisioned/registered. The present invention enables a trademark application to be submitted on behalf of a client when such a desired trademark is determined to have expired.

The invention provides an identifier resource management (IRM) system that can be adapted to compare status changes with customer/subscriber watch lists for the purpose of reporting to the customer any such status changes with the option of performing an operative action, such as that of an automatic reservation or provisioning request. The present invention enables a number block administrator (NBA) such as a central office to operate an IRM system adapted to report all real-time status changes to a phone number status gateway enabling an identifier status registry such as a phone number status registry to be populated. The invention enables a Department of Motor Vehicles (DMV) of a given state to operate a similar IRM system adapted to report all status changes to an identifier status registry having license plate identifiers. Such a registry can be accessed by licensed registration providers on behalf of customers desiring to register, reserve, renew, and back-order their license plate of choice.

The present invention provides a means for automatically selecting a subject image corresponding to a specific time of day and/or time of year. The invention provides a means for releasing public information that was at one time confidential. The present invention allows clients to be notified when a newly issued patent has previously been published while pending. The invention enables domain names to be generated/selected in response to determining that a trademark has expired. The present invention provides a means for integrating network resource requests with navigation, search, registration, and back-order services. The present invention assists in establishing at least one identifier of significance to a client is unavailable for ownership and communicating to a provider at least one desired action to take on behalf of the client to obtain an ownership interest in an identifier of significance.

The present invention provides a means to help reduce the likelihood of patents and trademarks expiring early for failure to maintenance/renewal fees. The invention provides a means for constructing a property right knowledge database that can be used for assessing the likelihood of assisting in maintaining the property right, communicating with a property right creator and/or designated agent/representative, determining whether to assist in preventing the patent from expiring early or in reinstating a premature expired patent, generating contact information of a property right creator and/or designated agent/representative, brokering an employment transaction between two or more parties and accessing the property right knowledgebase via a communication network for the educational, informational, and historical purposes.

In general, in accordance with a preferred aspect of the present invention (see FIG. 28), in a communication network having at least one communication link connecting at least one provider and a client, where the at least one provider is in communication with at least one database storing at least one identifier having variable ownership status, a method includes establishing that at least one identifier of significance to the client is unavailable for ownership by the client, communicating to the at least one provider at least one desired action the at least one provider is to take on behalf of the client to obtain an ownership interest in the at least one identifier of significance to the client, where the at least one identifier of significance to the client is unavailable for ownership by the client at the time of the communication, and determining whether to perform the at least one desired action without monitoring the ownership status of the at least one identifier of significance to the client.

In accordance with an another aspect of the present invention, in a computer system having a storage facility, a method for receiving new information from a provider includes the steps of storing a first data received from the provider at a first time, the first data including information of first use wherein at least a portion of the first data is potentially reusable, storing a second data received from the provider at a second time, the second data including reference data, the reference data indicating that at least a portion of the potentially reusable portion of the first data is reusable wherein one of a reference data and second time is unknown at the first time, and generating from the reference data and the first data, a third data having information of second use independent of the first use wherein the third data comprises updated subset of the first data, wherein at least a portion of the third data is potentially reusable and the third data includes one of a soon to be available data, newly available data, and newly issued data.

In accordance with an yet another aspect of the present invention, in a communication network having at least one communication link connecting at least one provider to one or more clients, where each provider is in communication with one of a registry and registrar storing one or more identifiers, a method includes communicating from at least one provider to one or more clients at least a portion of the one or more identifiers where each identifier is a potentially available or soon to be available telephone number, domain name, trademark, license plate identifier, IP address, keyword, stock symbol, and station identifier where each identifier is not available for one of a registration, assignment, and provisioning at the time of the communication, selecting at least one identifier from the at least a portion of the one or more identifiers, and at least one of a bidding, reserving, queuing, subscribing, ordering, pre-ordering, back-ordering, pre-registering, and monitoring the at least one selected identifier with at least one provider, where the at least one selected identifier is communicated to the provider before the at least one selected identifier is available for one of a registration, assignment, and provisioning.

In accordance with an aspect of the present invention, in a communication network having at least one communication link connecting a provider and a client, where the provider is in communication with a database storing one or more trademarks having an expiry status, a method includes determining that at least one trademark from the one or more trademarks has expired, and one of a generating and selecting at least one domain name corresponding to the at least one trademark.

In accordance with another aspect of the present invention, in a communication network having at least one communication link connecting at least one provider and one or more clients, where the at least one provider is in communication with a database storing one or more published patent applications having at least an application identifier and application status, a method includes selecting at least one published patent application from the one or more published patent applications having a pending status, and communicating to the at least one provider a request to monitor the pending status of the at least one selected published patent application, where the at least one selected published patent application is communicated to the at least one provider while the at least one selected published patent application has the pending status.

In accordance with yet another aspect of the present invention, with a first file having one or more identifiers and a second file having one or more identifiers, a method includes generating one or more newly registered identifiers from the first file and the second file, and determining whether at least one newly registered identifier from the one or more newly registered identifiers is available for back-order.

In accordance with an aspect of the present invention, with a database having a plurality of data records where each data record includes a status, a method includes determining whether each data record of the plurality of data records has a premature expired status, and creating a premature expired database of new use independent from the database having all data records that have been determined to have a premature expired status.

In accordance with another aspect of the present invention, with a plurality of subject images where each subject image includes at least a first background image representative of one of a first time of year and first time of day, and a second background image representative of one of a second time of year and second time of day, a method includes requesting at one of a given time of year and given time of day at least one subject image from the plurality of subject images, determining that one of a first time of year and first time of day is a closest match to one of a given time of year and given time of day, and providing the subject image having at least one first background image representative of one of a first time of year and first time of day.

In accordance with yet another aspect of the present invention, with a data arrangement, a method for minimizing data size includes at a first time, generating an arrangement of a first data having a first use where a portion of the first data is of a first data size, the portion of the first data having a second use at a second time, generating a second data, the second data corresponding to the portion of the first data where the second data is of a second data size where the second data size is minimized with respect to the first data size due to the arrangement of the first data, and at the second time, generating the portion of the first data having the second use from the first data and the second data.

In accordance with an aspect of the present invention, in a computer system having operative access to one or more storage facilities with an executable computer program stored therein, a method includes storing encrypted confidential information having one or more release dates where the encrypted confidential information is stored before at least one of the release dates, the encrypted confidential information having an encryption strength sufficient to withstand any attempt to decrypt the encrypted confidential information before any of the one or more release dates, storing one of a control data and decryption key for one of a selecting and decrypting at least a portion of the encrypted confidential information where the control data is stored at a time proximate to or before the one or more release dates, and on or after each release date, executing the computer program for one of a generating and disclosing the release of new information by combining the one of a control data and decryption key with the encrypted confidential information.

In accordance with another aspect of the present invention, with a terminable property right having a term and a most recent owner, wherein at least a portion of the term of the terminable property right that has terminated may be reinstated, a method for maintaining the term of the terminable property right includes determining whether the term of the terminable property right has terminated or may soon terminate, determining whether to assist the most recent owner in reinstating at least a portion of the term of a terminated property right when it is determined that the term of the terminable property right has terminated, and determining the likelihood as to whether the term of the terminable property right may soon terminate, when it is determined that the term of the terminable property right may soon terminate.

In accordance with yet another aspect of the present invention, in a computer system having access to one of a client and provider storage facility with an executable computer program and one of an employment database, patent database, and property right holder knowledgebase stored therein, a method includes matching one or more data records having one of a description, summary, and abstract of an available employment opportunity in the employment database with at least one data record corresponding to one of a patent database and property right holder knowledgebase, and presenting at least one match to the client and/or provider.

In accordance with an aspect of the present invention, in a communication network having at least one communication link connecting an identifier status registry with one or more identifier resource management systems via an identifier status gateway system, the identifier status registry having one or more identifiers, each identifier having a status, each identifier resource management system storing a current status of at least one identifier from the one or more identifiers, a method includes determining that the current status of the at least one identifier has changed, and communicating the status change to the identifier status registry.

In accordance with another aspect of the present invention, a method for requesting a network resource from an identifier having a domain name includes determining whether the domain name is resolvable, determining whether the domain name is available for registration when it is determined that the domain name is not resolvable, determining whether the network resource can be located when it is determined that the domain name is resolvable, requesting the network resource from the identifier when it is determined that the network resource can be located, and determining whether the domain name is available for back-order when it is determined that the network resource can not be located.

In accordance with additional aspects of the present invention, an apparatus and/or system which implements substantially the same functionality in substantially the same manner as the methods described above is provided.

In accordance with yet other additional aspects of the present invention, a computer-readable medium that includes computer-executable instructions may be used to perform substantially the same methods as those described above is provided.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### BRIEF DESCRIPTION OF DRAWINGS

FIG. 1 is a block diagram of a computer system in accordance with the present invention.

FIG. 2a is a schematic representation of a packet format in accordance with the present invention.

FIG. 2b is a block diagram of a distributed computer system in accordance with the present invention.

FIG. 2c illustrates a block diagram of a computing device in accordance with the present invention.

FIG. 3a is a block diagram illustrating how newly available information can be generated in accordance with the present invention.

FIG. 3b illustrates the steps performed for generating newly available information in accordance with the present invention.

FIG. 4a is a block diagram illustrating a provider delivery and update process in accordance with the present invention.

FIG. 4b is a block diagram illustrating relationships between the provider, client subscriber, and ISP/ASP subscriber in accordance with the present invention.

FIG. 4c is a block diagram illustrating how off-line indexes can be generated for retrieving on-line document images in accordance with the present invention.

FIG. 5 is a block diagram illustrating how a subscriber can operate an executable program in accordance with the present invention.

FIG. 6 is a block diagram illustrating how a scheduler and update retrieval system can be provided in accordance with the present invention.

FIG. 7a is a flow chart illustrating the steps performed for verifying and assuring quality data of newly released or soon to be released expiring patent data in accordance with the present invention.

FIG. 7b is a lookup table used to determine if a patent number is within an expected range of patent numbers in accordance with the present invention.

FIG. 8a is a flow chart illustrating the steps performed for generating encoded reference data in accordance with the present invention.

FIG. 8b is a flow chart illustrating the steps performed for decoding encoded reference data used for generating a searchable indexed database of newly available information in accordance with the present invention.

FIG. 9a is an exemplary table illustrating projected delivery sizes of control data in accordance with the present invention.

FIG. 9b is a graph illustrating the change in potential of expiring information in accordance with the present invention.

FIG. 9c is a flow chart illustrating the steps performed for minimizing reference data size in relation to the size and data arrangement of an originating data repository in accordance with the present invention.

FIG. 10a is a block diagram illustrating the relationship of different component systems with respect to fee payment and status information in accordance with the present invention.

FIG. 10b is a flow chart illustrating the steps performed for accessing renewal information such a maintenance fee payment and status information in accordance with the present invention.

FIG. 11a is a block diagram illustrating a more detailed aspect of reference data in accordance with the present invention.

FIG. 11b is a flow chart of illustrating the steps performed for generating recursive data subsets of new information in accordance with the present invention.

FIG. 11c is a block diagram illustrating a phone number provisioning and back-ordering system in accordance with the present invention.

FIG. 12a is a flow chart illustrating the steps performed for indicating how a provider can be notified of a data selection that may soon become available for reuse in accordance with the present invention.

FIG. 12b is a flow chart illustrating the steps performed for determining if a newly registered domain name is available for back-order in accordance with the present invention.

FIG. 12c is a flow chart illustrating the steps performed for determining if a newly provisioned phone number is available for back-order in accordance with the present invention.

FIG. 12d is a flow chart illustrating the steps performed for notifying subscribers of monitored resource identifiers in accordance with the present invention.

FIG. 12e is a flow chart illustrating the steps performed for processing one of a navigation, search, registration, and WHOIS request relating to at least a portion of a domain name in accordance with the present invention.

FIG. 12f is a flow chart illustrating the steps performed after communicating selection information to a provider system in accordance with the present invention.

FIG. 13 is a block diagram illustrating how query request(s) can be routed to either main and/or expired information database(s) and/or index(s) in accordance with the present invention.

FIG. 14a is a block diagram illustrating how master databases of both main and expiring data can be updated including creating a new file of potentially reusable data when receiving a current delivery in accordance with the present invention.

FIG. 14b is a diagram illustrating the relationship between the data structures needed to create a new file of potentially reusable data in accordance with the present invention.

FIG. 15a is a flow chart illustrating the steps performed for utilizing the time delay between receiving newly issued and newly expiring information in accordance with the present invention.

FIG. 15b is a diagram illustrating data structures pertaining to status updates in an information data repository in accordance with the present invention.

FIG. 16 is an elevation view illustrating a portable storage medium in accordance with the present invention.

FIG. 17 is a flow chart illustrating the steps performed for automatically selecting a subject image corresponding to time of day and/or time of year in accordance with the present invention.

FIG. 18a is a flow chart illustrating a system and steps performed for reusing résumé information of job applicants in accordance with the present invention.

FIG. 18b is a flow chart illustrating the steps performed for the release of new information in accordance with the present invention.

FIG. 19a is a flow chart illustrating the steps performed for updating a list of application identifiers in accordance with the present invention.

FIG. 19b is a flow chart illustrating the steps performed for notifying client of at least a portion of an updated list of identifiers in accordance with the present invention.

FIG. 20a is a flow chart illustrating the steps performed for communicating a monitoring request to a provider in accordance with the present invention.

FIG. 20b is a flow chart illustrating the steps performed for notifying a client of a status change in accordance with the present invention.

FIG. 21 is a flow chart illustrating the steps performed for selecting both trademark and domain name identifiers in accordance with the present invention.

FIG. 22a is a flow chart illustrating the steps performed for building an inventor/patent knowledge database in accordance with the present invention.

FIG. 22b is a flow chart illustrating the steps performed for assessing the likelihood of assisting in maintaining the property right in accordance with the present invention.

FIG. 23a is a flow chart illustrating the steps performed for communicating with a property right creator and/or designated agent/representative in accordance with the present invention.

FIG. 23b is a flow chart illustrating the steps performed for determining whether to assist in reinstating a premature expired patent in accordance with the present invention.

FIG. 23c is a flow chart illustrating the steps performed for determining whether to assist in preventing the patent from expiring early in accordance with the present invention.

FIG. 23d is a flow chart illustrating in further detail the step performed for determining whether to assist in preventing the patent from expiring early or in reinstating a premature expired patent in accordance with the present invention.

FIG. 24 is a flow chart illustrating the steps performed for generating contact information of a property right creator and/or designated agent/representative in accordance with the present invention.

FIG. 25 is a flow chart illustrating the steps performed for brokering an employment transaction between two or more parties in accordance with the present invention.

FIG. 26 is a flow chart illustrating the steps performed for accessing a property right holder knowledgebase via a communication network in accordance with the present invention.

FIG. 27 is a flow chart illustrating the steps performed for requesting a network resource in accordance with the present invention.

FIG. 28 is a flow chart illustrating the steps performed for communicating to a provider a desired action to take on behalf of the client to obtain an ownership interest in accordance with the present invention.

### DETAILED DESCRIPTION

The present invention will now be described with reference to the drawings, wherein like reference numerals are used to refer to like elements throughout.

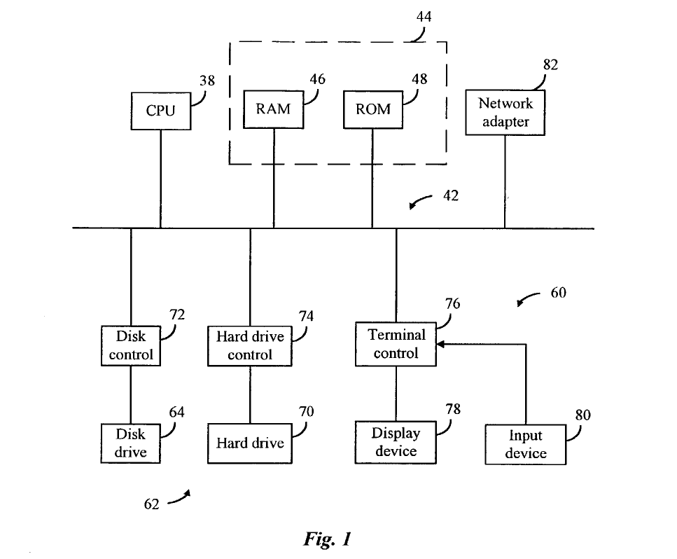

Referring initially to FIG. 1, a detailed block diagram of the computer system 32 is shown in accordance with the present invention. The computer system 32 includes a central processing unit (CPU) 38, which is operatively coupled to a bus 40. The CPU 38 or processor can be any of a plurality of processors, such as a Pentium and other similar and compatible processors. The processor 38 functions to perform various operations described herein as well as for carrying out other operations related to the system The manner in which the processor can be programmed to carry out the functions relating to the present invention will be readily apparent to those having ordinary skill in the art based on the description provided herein.

The bus 40 includes a plurality of signal lines 42 for conveying addresses, data and controls between the CPU 38 and a number of other system bus 40 components. The other system bus 40 components include a memory 44 (including a Random Access Memory (RAM) 46 and a Read Only Memory (ROM) 48) and a plurality of Input/Output (I/O) devices 60. The memory 44 serves as data storage and may store appropriate operating code to be executed by the processor for carrying out the functions described herein.

The RAM 46 provides program instruction storage and working memory for the CPU 38. The ROM 48 contains software instructions known as the Basic Input/Output System (BIOS) for performing interface operations with the I/O devices 60. Also stored in the ROM 48 is a software routine, which operates to load a boot program from the booting device. The boot program will typically be executed when the computer system 32 is powered on or when initialization of the system 32 is needed.

The I/O devices 60 include basic devices such as data storage devices 62 (e.g., floppy disks 64, tape drives, CD-ROMs, hard disks 70, etc.). Typically, the I/O devices 60 communicate with the CPU 38 by generating interrupts. The CPU 38 distinguishes interrupts from among the I/O devices 60 through individual interrupt codes assigned thereto. Responses of the CPU 38 to the I/O device 60 interrupts differ, depending, among other things, on the devices generating the interrupts. Interrupt vectors are provided to direct the CPU 38 to different interrupt handling routines. The interrupt vectors are generated during initialization (i.e., boot up) of the computer system 32 by execution of the BIOS. Because responses of the CPU 38 to device interrupts may need to be changed from time to time, the interrupt vectors may need to be modified from time to time in order to direct the CPU 38 to different interrupt handling routines. To allow for modification of the interrupt vectors, they are stored in the RAM 46 during operation of the computer system 32.

A disk control subsystem 72 bidirectionally couples one or more disk drives (e.g., floppy disk drives, CD-ROM drives, etc.) to the system bus 40. The disk drive works in conjunction with a removable storage medium 62 such as a floppy diskette 64 or CD-ROM. A hard drive control subsystem 74 bidirectionally couples a rotating fixed disk, or hard drive 70 to the system bus 40. The hard drive control subsystem 74 and hard drive 70 provide mass storage 62 for CPU 38 instructions and data. A terminal control subsystem 76 is also coupled to the bus 40 and provides output to a display device 78, typically a CRT monitor, and receives inputs from a manual 80 device such as a keyboard. Manual input may also be provided from a pointing device such as a mouse. A network adapter 82 is provided for coupling the system to a network.

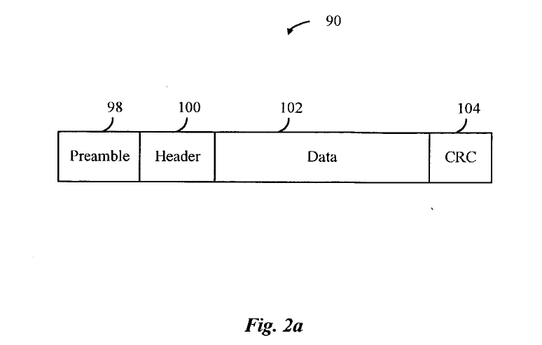

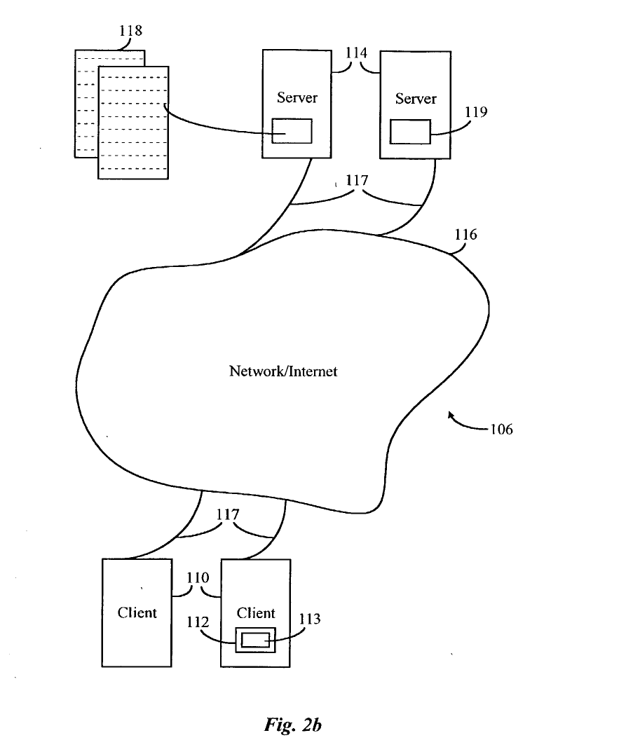

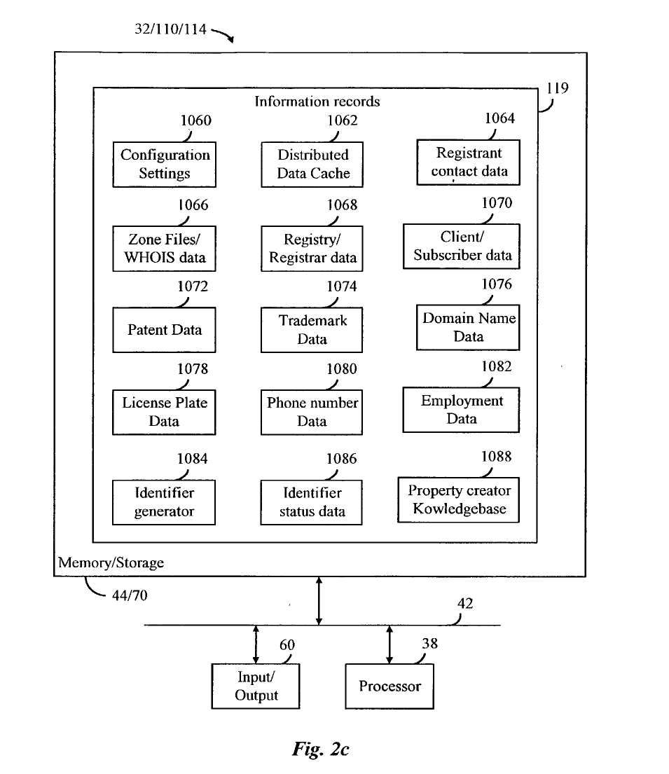

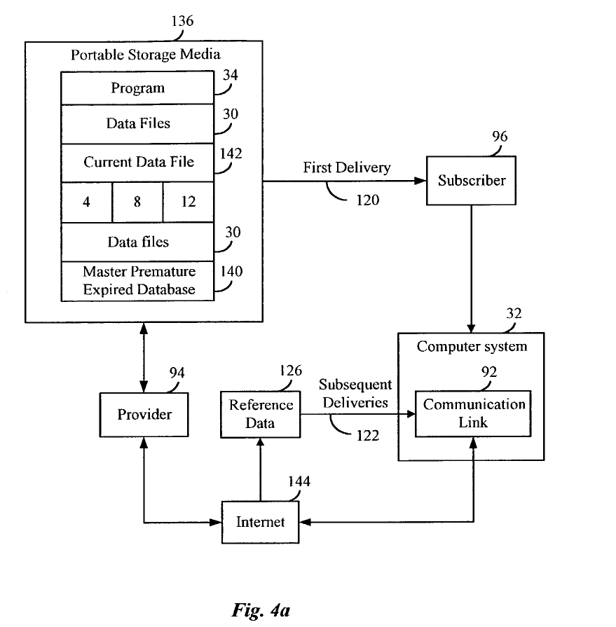

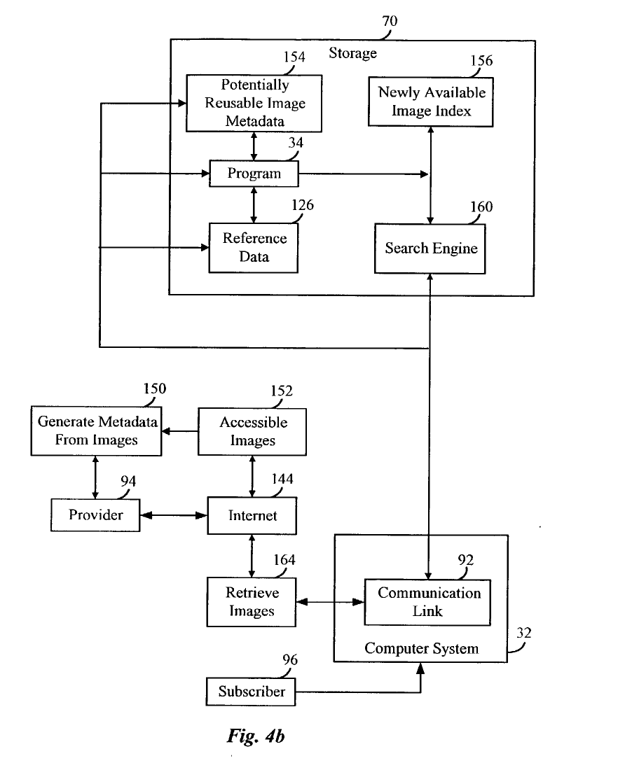

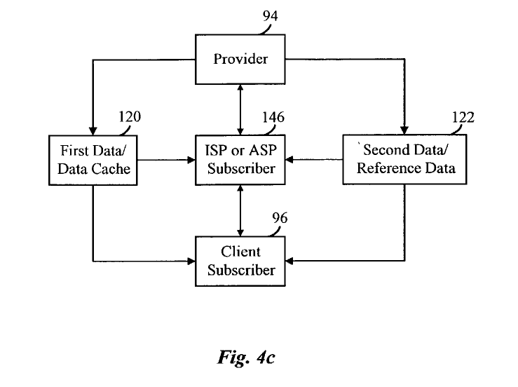

FIG. 2a illustrates the format of an exemplary data packet 90 received by the transceiver 92 (shown in conjunction with FIG. 4). In order to ensure proper routing of messages between the information provider 94 and an intended receiver 96, the messages are initially broken up into data packets 90, each of which receive a destination address according to a consistent protocol, and which are reassembled upon receipt by the target computer 32. The exchange of information between endpoints in a packet network is achieved via a“protocol.” A commonly accepted protocol for this purpose is the Internet Protocol (IP), which provides for networking. Used in conjunction with the IP may be a Transmission Control Protocol (TCP) which provides for a reliable stream delivery of messages or a User Datagram Protocol (UDP) which allows for distinguishing messages among multiple destinations with a given host computer 32. More specifically, the TCP protocol is a popular connection-oriented transport layer protocol that is used around the world. The TCP protocol offers a full duplex reliable virtual end-to-end connection for transporting information between endpoints by using one or more of the packets 90, each of which comprises both control information and data.

As is conventional, the data packet 90 is represented by a sequence of data and/or control information, which is segmented into respective fields. The data packet 90 together with the information contained therein is constructed by the device which subsequently transmits the packet 90 to the transceiver 92. The format of the data packet 90 will typically be governed by the system protocol as is conventional. The data packet 90 includes, in order, a synchronization field 98 (i.e., preamble) including synchronizing bits for synchronizing the receiver; a header field 100 including header information such as the source address of the data packet 90, the header field 100 including at the end thereof a length field including information regarding the length of the packet 90 (e.g., number of bits); a type/address field; a data field 102; and a cyclic redundancy check (CRC) field 104. It is noted that the length of the respective fields as shown in FIG. 2a as well as the other figures herein is not necessarily shown in proper corresponding proportion. In many cases the length of some fields has been exaggerated in the drawings for ease of understanding. Furthermore, it is also noted that the synchronization field may be transmitted at a data rate different from that of the remaining packet 90, as is well known throughout the art.

The type/address field includes the destination address of the packet 90 and information indicating whether or not the packet 90 is of a type, which requires a response. For example, the type/address field can include one or more bits which are set to indicate that the transceiver 92 is required to transmit a positive and/or negative acknowledgment of receipt of the packet 90. In addition, or in the alternative, the type/address field can include information, which identifies the packet 90 as a type which needs to be processed and transmitted by the transceiver 92 in order to forward the information to another location. Regardless of the particular reason why the packet 90 may necessitate a response, the type/address field has one or more predetermined indicia therein for indicating whether the packet 90 is of a type which requires that the transceiver 92 respond by transmitting information or is of a type which does not require that the transceiver 92 respond by transmitting information.

The type/address field is shown located approximately in the middle of the data packet 90, although it will be appreciated that the type/address field could be located elsewhere in the packet 90. In the preferred aspect, however, the type/address field is located within the initial half of the data packet 90 and most preferably towards the front of the packet 90. Following the type/address field, the data packet 90 includes a data field 102 which contains the primary data being sent within the packet 90. The data field 102 is then followed by a cyclic redundancy check (CRC) field 104 which includes a CRC code for error detection as is conventional.

FIG. 2b is a block diagram illustrating a distributed computer system 106 in accordance with the present invention. The distributed system 106 includes client computers or any network access apparatus 110 connected to server computers 114 via a network 116. The network 116 can use Internet communications protocols (IP) to allow clients 110 and servers 114 to communicate. The network access apparatus 110 may be operationally coupled to and/or include a Global Positioning System (GPS) receiver. The modem 92 can communicate with the electronic network 116 via one or more communication links or lines 117 such as a telephone line, an ISDN line, a coaxial line, a cable television line, a fiber optic line, or a computer network line. Alternatively, the modem may wirelessly communicate with the electronic network 116. The electronic network 11 6 may be accessed via an on-line service, an Internet service provider, a local area network service, a wide area network service, a cable television service, a wireless data service, an intranet, a virtual private network, a peer-to-peer network, a satellite service, or the like. Communication links that are used to connect the various systems depicted throughout the present invention may be of various types including hardwire links, optical links, satellite or other wireless communications links, wave propagation links, or any other mechanisms for communication of information.

The client computers 110 can be any network access apparatus including hand held devices, palmtop computers, kiosk, personal digital assistants (PDAs), notebook, laptop, portable computers, desktop PCs, workstations, or larger or smaller computer systems. It is noted that the network access apparatus can have a variety of forms, including but not limited to, a general purpose computer, a network computer, a network television, an internet television, a set top box, a web-enabled telephone, an internet appliance, a portable wireless device, a television receiver, a game player, a video recorder, or an audio component.

Each client 110 typically includes one or more processors, memories, and input/output devices. An input device can be any suitable device for the user to provide input to a client computer 110; for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, or cable box. A data glove, an eye tracking device, or any MIDI device could also be used. A display device could be any suitable output device, such as a display screen, text-to-speech converter, printer, plotter, fax, television set or audio player. Although the input device is typically separate from the display device, they could be combined; for example: a display with an integrated touchscreen, a display with an integrated keyboard, or a speech-recognition unit combined with a text-to-speech converter.

The servers 114 can be similarly configured. However, in many instances server sites 114 include many computers, perhaps connected by a separate private network. In fact, the network 116 may include hundreds of thousands of individual networks of computers. Although the client computers 110 are shown separate from the server computers 114, it should be understood that a single computer can perform the client and server roles.

During operation of the distributed system 106, users of the clients 110 desire to access information records 119 stored by the servers 114 using, for example, the World-Wide-Web (WWW), or in short the “Web.” The records of information 119 can be in the form of Web pages 118. The pages 118 can be data records including as content plain textual information, or more complex digitally encoded multimedia content, such as software programs, graphics, audio signals, videos, and so forth. It should be understood that although this description focuses on locating information on the World-Wide-Web, the system can also be used for locating information via other wide or local area networks (WANs and LANs), or information stored in a single computer using other communications protocols.

The clients 110 can execute Web browser programs 112, such as Netscape Navigator or MS Internet Explorer to locate the pages or records 118. The browser programs 112 allow the users to enter addresses of specific Web pages 118 to be retrieved. Typically, the address of a Web page is specified as a Uniform Resource Identifier (URI) or more specifically as a Uniform Resource Locator (URL). In addition, once a page has been retrieved, the browser programs 112 can provide access to other pages or records by “clicking” on hyperlinks to previously retrieved Web pages. Such hyperlinks provide an automated way to enter the URL of another page, and to retrieve that page.

A client of the DNS is called a resolver 113. Resolvers I13 are typically located in the application layer of the networking software of each TCP/IP capable machine. Users typically do not interact directly with the resolver 113. Resolvers 113 query the DNS by directing queries at name servers, which contain parts of the distributed database that is accessed by using the DNS protocols to translate domain names into IP addresses needed for transmission of information across the network. DNS is commonly employed by other application-layer protocols—including HTTP, SMTP and FTP—to translate user-supplied domain names to IP addresses. When a browser program 112 (e.g., an HTTP client), running on a user's machine, requests a URL having a resolvable domain name, in order for the user's machine to be able to send an HTTP request message to a server 114, the user's machine must obtain the IP address of the domain name. The user machine then runs the resolver 113 (DNS client) on the client-side of the DNS application. The browser 112 extracts the domain name from the URL and passes the domain name to the resolver 113 on the client-side of the DNS application. As part of a DNS query message, the DNS client 113 sends the domain name to a DNS server system connected to the Internet. The DNS client 113 eventually receives a reply, which includes the IP address for the domain name. The browser then opens a TCP connection to the HTTP server process 114 located at the IP address.

FIG. 2c illustrates a block diagram of a computing device in accordance with the present invention. A computing device having a storage device such as memory 44 and/or storage medium 70 is in operative association with a processor 38 and input/output devices 60 via at least one data bus 42. Such a computing device can operate in a self-contained or standalone capacity or in any combination as a client 110 and/or server 114 computing systems of a computer system 32 and/or network access device of client/subscriber system 110 or server/provider system 114. Stored in memory 44 may be programs/scripts, and information records 119 having any combination of exemplary content such as lists, files, and databases. Such records may include for example: configuration settings 1060, distributed data cache 1062, registrant contact data 1064 (e.g., names, addresses, phone and fax numbers, e-mail addresses, and any other billing, administrative, and technical contact information including, if need be, name server information), zone files/whois data 1066, registry/registrar data 1068, client/subscriber data 1070, patent data 1072, trademark data 1074, domain name data 1076, license plate data 1078, phone number data 1080, employment data 1082, identifier generator 1084, identifier status data 1086, and property creator knowledgebase 1088.

These information records are representative of generalized data structures across many applications, markets, and industries. For example, patent data 1072 may further include provisional and non-provisional patents, pre-grant published patent applications, and utility, design, and plant patents. Patent status data may include, but is not limited to, whether it is pending, allowed, issued, reissued, under reexamination, expired, or abandoned. Trademark data 1074 may include common law marks, state registered marks, and federally registered marks, and may be further broken down into trademarks, service marks, certification marks, collective marks, membership marks, or collectively known as “marks”. The identifier generator 1084 may include further components such as word generation methods, dictionary/thesaurus, prefix/suffix and word root/stem, set of heuristic naming rules/namespace syntax, identifier equivalents, language translation, phonetics/phonemes (e.g., word variants, misspelling), identifier watch list (e.g., list of desirable descriptors, personal identifier portfolio, competitor identifier portfolio), mnemonics/abbreviations, namespace mappings, identifier mapping, delimiter mapping, rhyme generation, name/number conversion, identifier history, and the like. These and other information records can be further introduced and discussed in more detail throughout the description of different aspects of the present invention.

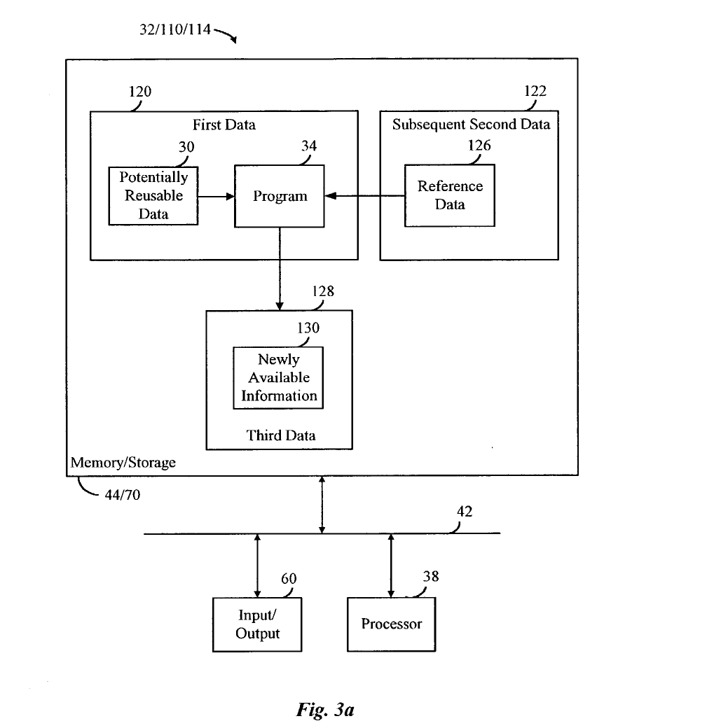

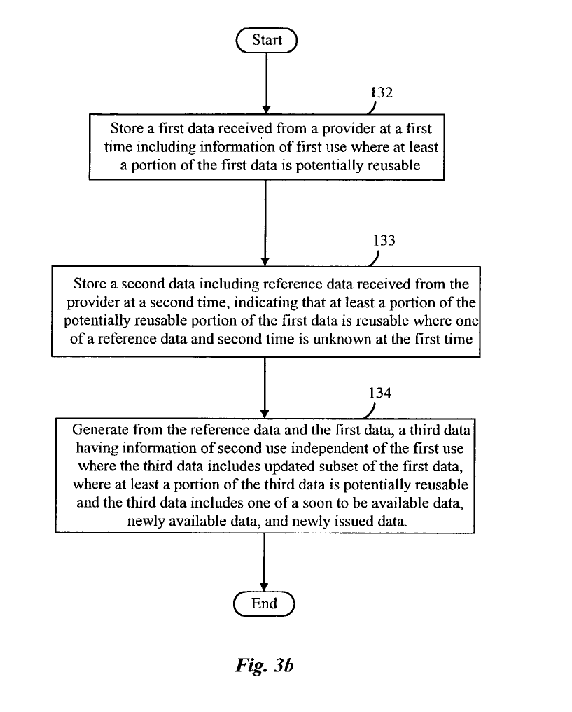

FIG. 3a is a block diagram illustrating how newly available information can be generated in accordance with the present invention. A computing device having a storage device such as memory 44 and/or storage medium 70 is in operative association with a processor 38 and input/output devices 60 via at least one data bus 42. Such a computing device can operate in a self-contained or standalone capacity or in any combination as a client 110 and/or server 114 computing systems of a computer system 32 and/or network access device of client/subscriber system 110 or server/provider system 114. A first data 120 including the program 34 and potentially reusable data 30 is stored in memory 44 and/or on the storage medium 70. In turn, a second data 122 including control/reference data 126 can be subsequently and/or periodically made accessible to the computer system 32. Most typically, the second data is stored on the same storage medium 70 as the first data 120. The content of the control/reference data 126 may or may not be known at the time that the first data 120 was stored. The control/reference data 126 corresponds to a subset of the potentially reusable data 30. The program 34 can be executed to either receive or download the second data or executed in response to receiving or downloading the second data. The executed program combines the control/reference data 126 and the potentially reusable data 30 to create third data 128 including newly available information 130 on the storage medium 70 of the computer system 32 or on any storage medium either operatively coupled or remotely accessible to the computer system 32. The newly available information can then be further indexed, searched, and filtered accordingly by the program as will be further discussed.

Also representative of receiving network accessible updates in addition to the delivery of a computer readable medium such as a portable storage media as discussed above. A storage facility 70 with an executable computer program 34 and a data file having potentially reusable data 30 stored therein and at least one communication link 92 connecting the provider computer system 94 and the subscriber computer system 96 can receive and/or periodically receive from the provider computer system 94, data including control/reference data 126 corresponding to at least one record of the potentially reusable data. The control/reference data indicates whether the received data is to be maintained in a subset of the records of the at least one data file. The computer program is either executed to receive the control/reference data and/or automatically executes in response to the control/reference data on the subscriber computer system to combine the control/reference data with the potentially reusable data to create data of new use that is an updated subset of the potentially reusable data, wherein the new data includes at least one data file of newly issued information having at least one issue date and at least one expiry date.

FIG. 3b illustrates the steps performed for generating newly available information in accordance with the present invention. A first data received from a provider at a first time including information of first use where at least a portion of the first data is potentially reusable can be stored in step 132. Subsequently and/or periodically, a second data can also be stored in step 133 including reference data received from the provider at a second time, indicating that at least a portion of the potentially reusable portion of the first data is reusable where one of a reference data and second time is unknown at the first time. A third data having information of second use independent of the first use where the third data includes updated subset of the first data, where at least a portion of the third data is potentially reusable and the third data includes one of a soon to be available data, newly available data, and newly issued data can be generated in step 134 from the reference data and the first data.

Information updates generally rely upon “new” information that is revealed for the first time. Future events are generally not precisely known if at all. When a news story breaks, “new” information is revealed as facts are discovered while the story unfolds or develops. However as shown in the present invention, an information update can rely on the new use of old or previous information only. The present invention teaches how “new” information is derived under certain conditions from a subset of “old” information yielding new use that benefits the subscriber by having concrete and useful results.

Turning now to a more detailed consideration of an aspect of the present invention, FIG. 4a is a block diagram illustrating a provider delivery and update process in accordance with the present invention. A first delivery of data 120 which is sent to a subscriber 96 from a provider 94 via the portable storage media 136, or received by a subscriber via other forms of transmission. The delivery includes the following: a master premature expired patent database 140, a program 34 that allows a subscriber 96 to monitor, watch, bid, configure, query, browse, select, report, archive, order, or hyperlink from the master expired property right database such as a premature expired patent database 140 or from future databases that can be remotely built by the program 34, and data files 30 of patent information that have the potential to prematurely expire after four, eight, or twelve years from the issue date of the patent. Subsequent deliveries 122 of control/reference data 126 can be periodically sent to the subscriber 96 via e-mail or periodically received/downloaded by a subscriber/client device via any network transfer protocol such as File Transfer Protocol (FTP) or from other forms of transmission (e.g., a set-top-box (STB) receives control/reference data from the Vertical Blanking Interval (VBI) or decoded closed caption data of a television or streaming media broadcast) where the content of such data is either known/unknown at the time of the first delivery. The reference data 126 represents information that corresponds to a subset of records from the current data file 142. Other subscriber/client and/or provider actions can also be performed via the communication network including performing one of a notifying, transferring, registering, assigning, provisioning, bidding, escrowing, reserving, queuing, subscribing, ordering, pre-ordering, back-ordering, and pre-registering action.

At this point, the subscriber 96 can operate the computer system 32 and execute the program 34 to either combine a current data file 142 with the control data 126 or to monitor, watch, bid, configure, query, browse, select, report, archive, order, or hyperlink from the master premature expired database 140 and connect to a network such as the Internet 144 or other on-line services via the transceiver 92 of the computer system 32 to view a selected document image and send order or other information to the provider 94. The first 120 and subsequent deliveries 122 represent information sent during a given subscription period. A subscription period is the time it takes to send a new first delivery 120 of information. For instance, if a portable storage media 136 is updated and sent quarterly, the subscription period is three months. More than three months of data files 30 of patent information that have the potential to prematurely expire are placed on the portable storage media 136 so there is no lapse in coverage for creating indexed databases of newly available information 130 while the portable storage media 136 for the next subscription period is being sent.

Though FIG. 4a illustrates how both a master database and potentially reusable data can be sent on the same portable storage media. A computer readable medium such as a portable storage medium can also be configured to store the master database only or potentially reusable data only as a means to separate original or master files from that of update reference data files. Storing the update files separately, allows for more storage dedicated to updating, thereby further increasing the subscription period of the portable storage media. It is also noted that such storage media is not limited to read-only technology and is applicable to read/writable portable storage media as well including magneto-optical, Write Once Read Many (WORM), and Write Many Read Many (WMRM), etc.

The current data file can include the expiration date as part of the filename, which also matches the filename of the control/reference data file having the same expiration date as part of the filename. To minimize the periodic use of the portable storage media it is preferred that the subscriber use a CD-ROM or DVD-ROM jukebox to virtually eliminate the constant inserting/ejecting of the media which can lead to wear and tear and potentially affect the operation of the computer readable medium. However, when a subscriber has only one available media reader then advantage can be taken of buffering or caching many files in advance by storing several weeks or months of soon to be potentially reusable data files on a storage medium accessible to the subscriber computer system. The program allows a subscriber to configure (not shown) minimum and maximum buffer levels of pre-loading potentially reusable data from the portable storage media. After levels are configured, the program transfers the necessary data to the hard drive and prompts the subscriber in the future whenever the buffering threshold has been exceeded thereby decreasing the frequency of periodic usage of the portable storage media by the subscriber. In effect both the use of the portable storage media and the selection and arrangement of potentially reusable data can be viewed as functionally equivalent to a long-term cache. Each data file that is partitioned by expiration date can, in turn, be viewed as a separate cache.

Conventionally, a cache is used to speed data access by ranking data on criteria such as frequency of use, last use, time-to-live (TTL) or expiration period etc. When it is determined new data is to be cached while the cache is full, the new data is appended and data that has expired, seldom been accessed, or not accessed within a given duration is deleted. The long-term cache of the present invention, however, functions in reverse by placing priority on data that has remained in the cache longer. Data is arranged by TTL, expiration date, or renewal date and more priority is placed on data as the TTL, expiration, or renewal date approaches. The present invention is applicable to caching wherein at subsequent intervals a compiled subset of a cache takes upon new use independent from the use of the original cache.

FIG. 4b is a block diagram illustrating relationships between the provider 94, client subscriber 96, ISP/ASP subscriber 146, and the delivery of first 120 and second data 122 in accordance with the present invention. For instance, the first data 120 represents a long term data cache of information that becomes useful when expired whereas second data 122 includes reference data used to select the specific updated subset of expiring information from the data cache. Tiered subscribing is used by the invention by having subscribers such as Internet Service Providers (ISPs) or Application Service Providers (ASPs) act as a proxy on behalf of their clients (other subscribers) by installing a computer readable medium having a long term cache which receives provider updates. The ISP or ASP can centralize jukebox servers, which is used to shift the burden from client subscribers managing portable storage media. By distributing updates to the ISP or any intermediary, advantages such as less distribution costs, reduced network bandwidth from data queries and updates, and privacy to the end user when querying and accessing data are realized while such a system remains ubiquitous yet transparent to the end-user. Tiered subscribing can be further applied and extended to content-on-demand, web caching, and streaming media applications to name a few.

FIG. 4c is a block diagram illustrating how off-line indexes can be generated for retrieving on-line document images in accordance with the present invention. A provider 94 extracts text descriptions 150 of on-line document images 152 from the Internet 144 to be prepared for delivery. A first delivery 120 is sent to the storage 70 of a subscriber's 96 computer system 32 via the transceiver 92 which includes a program 34 and data files of potentially searchable descriptions of document images 154. The program 34 receives via the transceiver 92 a subsequent delivery 122 of control data 126 which combines with the potentially searchable descriptions 154 to form indexes 156 of the location information of the on-line document images 152 and indexes 156 of the searchable descriptions 154 of the document images 152. The subscriber 96 uses the search engine 160 from the program 34 to search and select for desirable document descriptions 154. To retrieve an on-line document 152, a subscriber 96 uses the search engine 160 to use the indexes of document location information 156 and retrieve document images 164 from the Internet 144 via the transceiver 92 of the computer system 32.

Each on-line document image can be accessed via a network from a resource identifier such as a Uniform Resource Identifier (URI) or more specifically as a Uniform Resource Locator (URL). In addition, extracted full-text of a document image can also be accessed from a URL which serves as a means for any client computer connected to a public network such as the Internet to globally access a specific on-line resource from any other computer system (provider or subscriber) worldwide.

Potentially reusable data is applicable to a given set of URLs wherein at a subsequent time the compiled subset from the set of URLs take upon new use independent from the original set of URLs. A compilation of URLs represents an index of a distributed database. As shown in the present invention, there are cases where the compilation of a subset from the database (distributed or not) constitutes a new use having independent utility from the superset of information from which it was derived. In turn, the compilation of a subset of URLs also constitutes a new use as of such wherein keyword indexing is generated from the accessed content of the URLs as a means for efficiently searching and retrieving the newly issued and/or compiled URL subset. In addition, the original set of URLs can be compiled and cached by sending such information to licensed service providers for use in tiered subscribing applications.

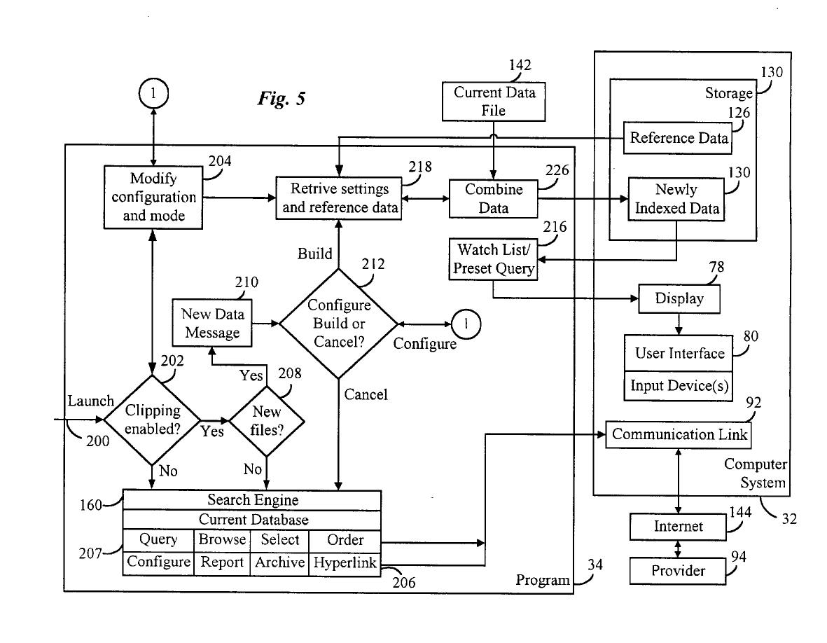

FIG. 5 is a block diagram illustrating how a subscriber can operate an executable program in accordance with the present invention. Set out below is an illustration of the update program 34 for applying modifications or updates to the reference data files 30 of the system 32. The update program 34 is in program design language from which source code and machine code are derivable. In the following general description of the update program 34, it is to be assumed that system is under mouse and keyboard device control. Moreover, it is assumed that the update program 34 is invoked from a driver program contained in the operating system which facilitates the display of all of the screen panels, the monitoring of the keyboard and the installation of the plurality of separately installable features or components of the software program.

When a subscriber 96 launches the program 34 in step 200, the status of the automated clipping service is determined in step 202 by retrieving configuration 204 information to determine if the clipping mode is enabled (step 202) and if the clipping mode 204 is automated. If the clipping mode is disabled, the program 34 enters the search engine 160 allowing the subscriber 96 to configure, query, browse, select, report, archive, order, or hyperlink 206 from the current database 207. The ordering module can be adapted to perform many requests including that of bidding, reserving, queuing, subscribing, ordering, pre-ordering, back-ordering, pre-registering, and monitoring. When the clipping mode 202 is enabled and it is determined in step 208 that there are no control files available, the program 34 enters the search engine 160. However, when there are new control files expected to be available (step 208) or there are old control files available, a message can be presented in step 210 stating that newly available information 130 is waiting to be built.

Along with the presented message (step 210), a subscriber 96 can be presented in step 212 with up to three choices to select from. A first choice allows the subscriber 96 to configure two parameters 204 in order to automate the clipping service 202. These parameters are the default data path to find the most recent control data 126 available, and the filename and data path to find the provider/subscriber preset defined query/watch list 216 that filters the newly available information to be built. Each data path can be of course further be represented by a URI. The second choice (step 212) allows the subscriber 96 to cancel the message. By doing so, the program 34 can access the search engine 160. The third choice (step 212) allows the subscriber 96 to build and view the newly available information 130. When this selection is made, the user configuration 204 information can be retrieved in step 218 and the program 34 can combine in step 226 the new control data 126 with the corresponding current file 142 of potentially reusable data 30 and build an indexed database of newly available information 130 in storage 70. The program 34 then filters the newly created indexed database 130 with the user-defined preset query/watch list 216 and send the information of interest to be displayed 78. If the clipping mode 204 is automated, then the above choices and messages can be bypassed, and subscriber 96 preferences are retrieved from configuration 204 to determine what new information is filtered 216 or ‘automatically clipped’ and sent to the display 78 without any required input or operative action from the subscriber 96.

From this point, the subscriber 96 can operate a computer user interface 80 (e.g., through an input device such as a keyboard, mouse, etc.) to configure, query, browse, select, report, archive, order, or hyperlink 206 from the search engine 160 and connect to the Internet 144 or other on-line services via the transceiver 92 of the computer system 32 to view a selected document image and send order 206 or other information to the provider 94 for further document delivery.

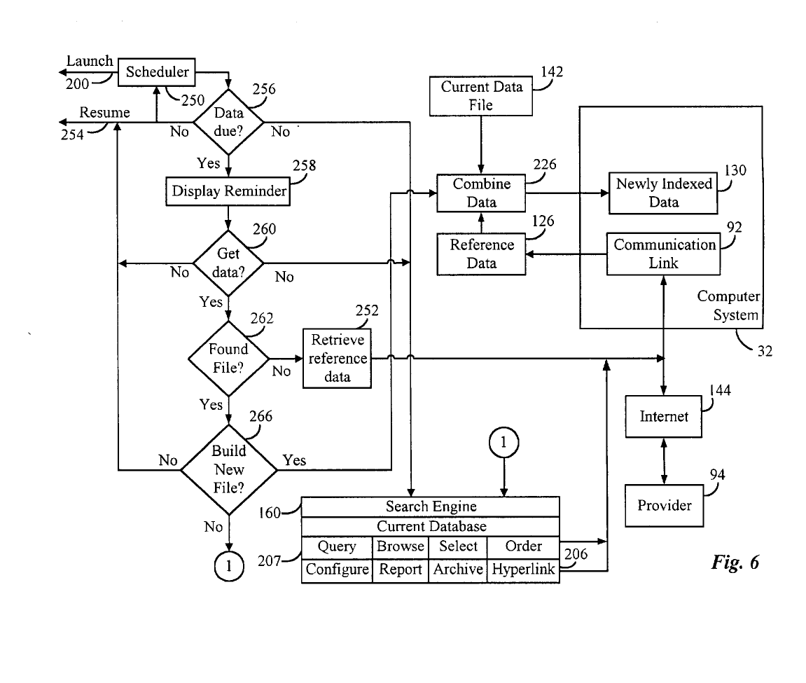

In another aspect of the present invention, FIG. 6 is a block diagram illustrating how a scheduler 250 and update retrieval system 252 can be provided in accordance with the present invention. First, when the computer system is powered up, the operating system is loaded and activates a scheduler 250 to periodically check the system time in comparison to the next scheduled delivery of control data 126. Computing activity is resumed 254 until the current system time exceeds the scheduled delivery time. In the event where the subscriber 96 launches 200 the program 34 and the control data 126 is not due 256, the program 34 enters the search engine 160 allowing the subscriber 96 to configure, query, browse, select, report, archive, order, or hyperlink 206 from the current database 207. In either case, when the control data is due 256, a message 258 is displayed 78 to remind the subscriber 96 that the control data 126 is overdue and asks if the subscriber 96 would like to obtain the latest update 260. If the control data is not due 256, depending upon which case, the computing activity is either resumed 254 by default, or the program 34 enters the search engine 160.

If the subscriber 96 would like to obtain the latest update 260, the program 34 then checks for new control data 126 by searching for the control data file 126 in a default data path. If no data is found 262, an update retrieval 252 procedure is launched to obtain the new control data 126 via the transceiver 92. Upon receipt of the control data 126 or when the data is found 262, a message 266 is displayed 78 that asks if the subscriber 96 would like the potentially reusable data 30 to be built and displayed 78. If not, depending upon which case, the computing activity is once again either resumed 254 by default, or the program 34 enters the search engine 160. If so, the program 34 combines 226 the new control data 126 with the corresponding current file 142 of potentially reusable data 30 and build an indexed database of newly available information 130 as requested by the subscriber 96. E-mail as a delivery mechanism is but one example. Other examples include automatically retrieving data files via HTTP, FTP, etc.

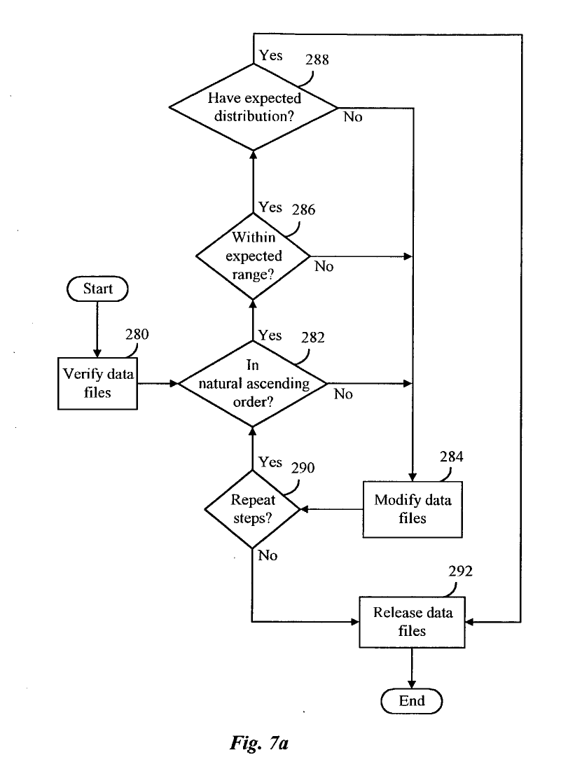

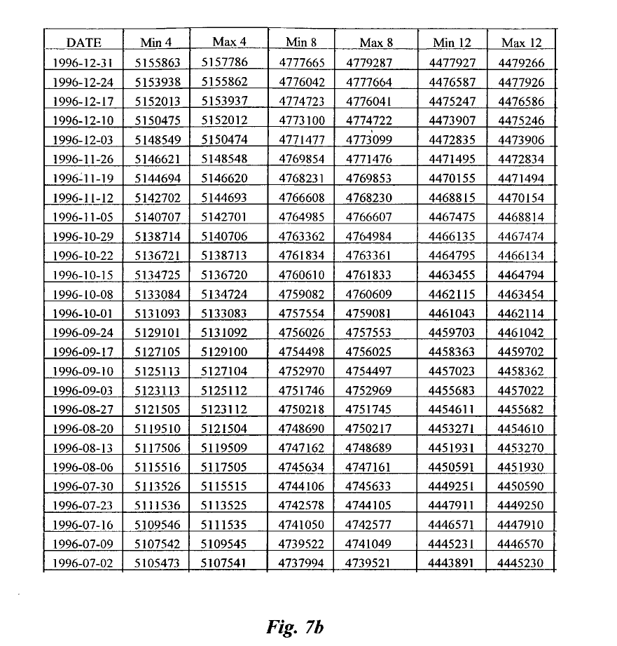

FIG. 7a is a flow chart illustrating the steps performed for verifying newly released or soon to be released expiring patent data and FIG. 7b is a lookup table used to determine whether a patent number is within an expected range of patent numbers in accordance with the present invention. Patent numbers can be checked in step 282 for digit reversals of patent numbers in numerical order. By comparing each record of a database so that the patent number of the current record is always smaller than the patent number of the next record of the database, all records that do not meet this test are flagged to be modified in step 284. Since it is known in advance which patents could potentially expire early in a given week, all patent numbers to be verified should fall within an expected range of patent numbers. By comparing in step 286 all patent numbers for their existence in a lookup table (see Table 7b) of expected ranges in a given week, patent numbers that do not meet this comparison are flagged to be modified in step 284. Periodically, the master list of the nearly 300,000 patent numbers currently expired is checked for omissions at different expiration levels. Variances are established by checking in step 288 for the total number of patents expiring early in a current week and subtracting the total number of early expirations of the previous week. The variance is checked for all weeks, and variances that exceed an accepted level are flagged to be modified (step 284). After modifications, the tests can be repeated in step 290 or if accepted, the new data is successfully verified and ready for release in step 292.

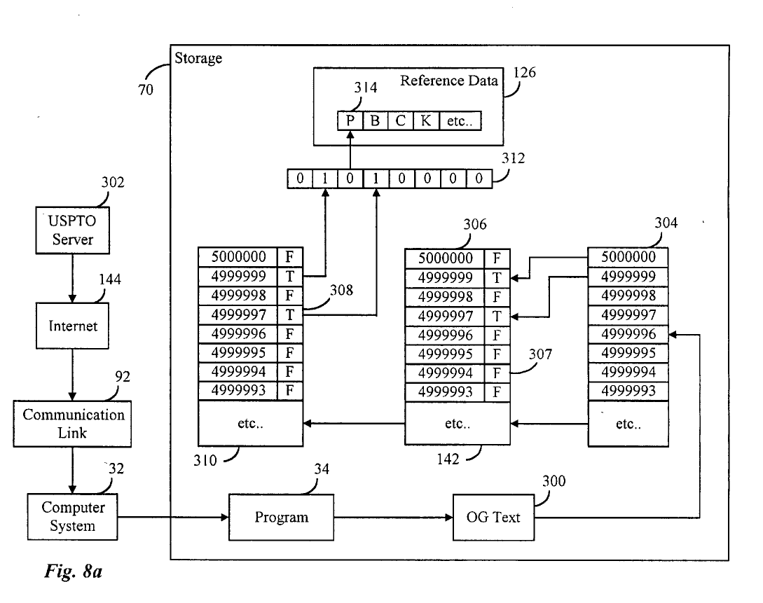

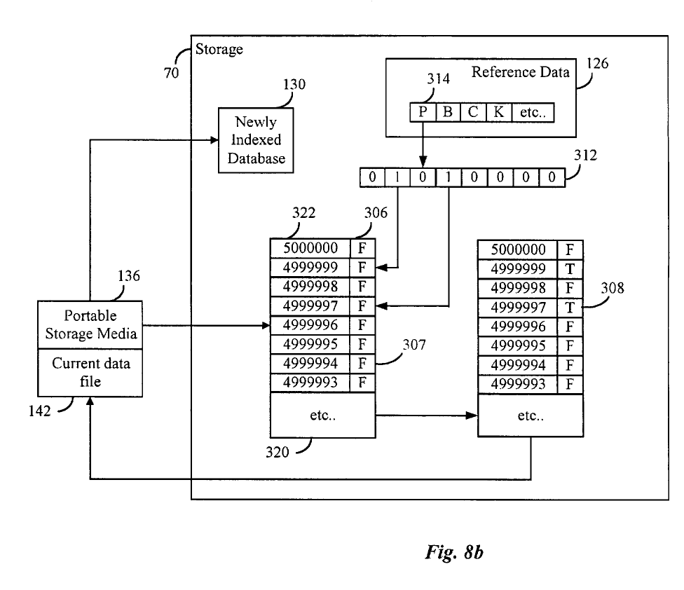

FIG. 8a is a flow chart illustrating the steps performed for generating reference data in accordance with the present invention. The release of the current OG Notice 300 can be received from the USPTO server 302 on the Internet 144 via the transceiver 92 of the computer system 32. The teachings of co-pending provisional application 60/154,411 can be applied as a means for receiving any expected information update including the current OG Notice 300. A program 34 is executed and a temporary database 304 of patent numbers is created and indexed by extracting the premature expired patent numbers from the text file of the OG Notice 300. A relation is set into the temporary database 304 from a current data file 142, which is identical to the subscriber's current file 142 of potentially reusable data 30. By default, all of the records have a logical value of FALSE 307 in the expired field 306. The expired field 306 of the current data file 142 is modified to a logical value of TRUE 308 for all matching records of this relation. Starting from the first record of the modified 310 current data file in batches of eight records at a time, an eight bit string composed of 1's and 0's is formed 312 where the logical value of TRUE 308 in the expired field 306 for a given record is represented by a 1. The eight-bit string is converted into an equivalent binary value. The binary value is then further converted into its equivalent ASCII character 314. A string of ASCII characters 314 are formed by repeating the steps of encoding the data until the end of the modified 310 current data file is reached. The resultant encoded character string referred to as an encoded bit mask becomes the newly created control/reference data 126.

When an update is initiated by a provider, an encoded bit mask is generated by the provider based upon the known arrangement of data records of at least one data file or database residing on the subscriber side. This becomes particularly apparent when providing potentially reusable data stored on read-only portable storage media to a subscriber. At future intervals, a provider generates an encoded bit mask that is applicable specifically to the potentially reusable data stored on read-only portable storage media. When an update is initiated by a subscriber, the subscriber has the added option to send a variety of information such as subscriber preset query filters/watch lists, ‘top picks’ information from the subscriber for the purposes of evaluation or document ordering, and subscriber log files that track index history, database revision and version information, etc. for the purpose of subscriber/provider database synchronization. This log information may be used for encoded bit mask generation on the provider side for delivery to the subscriber.

FIG. 8b is a flow chart illustrating the steps performed for decoding encoded reference data used for generating a searchable indexed database of newly available information in accordance with the present invention. First, a temporary file 320 is created in storage 70 by copying the patent number field 322 and expired field 306 only, from all of the records in the current data file 142 located on the portable storage media 136. By default, all of the records have a logical value of FALSE 307 in the expired field 306. The control data 126 is composed of ASCII characters 314, which represent what records to modify in the expired field 306 of the temporary file 320. The control data or encoded bit mask 126 is decoded by converting each ASCII character 314 to an equivalent binary value. The binary value is then further converted into an eight bit string 312 composed of only 1's and 0's that represents the binary value. Starting from the first record of the temporary file 320 and the first character 314 of the control data 126, the expired field 306 of the temporary file 320 is modified to a logical value of TRUE 308 for all records where the record position of the temporary file 320 equals the character position of the 1's in the decoded character string 312. The steps of decoding and modification are continued until the end of the control data file 126 is reached. A relation is then set from the temporary file 320 to flag the newly available information 130 from the current file 142 of potential reusable data 30 on the portable storage media 136. The flagged records are then copied and indexed to storage 70 to form an indexed database of newly available information 130. Though a preferred aspect of the present invention is to use the encoding/decoding methods discussed in FIG. 8a and FIG. 8b, another means of updating the subscriber is sending the OG Notice as is from the USPTO when it is published online. The executable program can then be modified to parse the premature expired patent numbers that is used to create at the subscriber computer system a new release of searchable premature expired information.

Although it is unknown which patents will prematurely expire each week, the total number of patents previously issued that have the potential to expire early in a given week is known. By assigning a status bit to each of the patents that can potentially expire early, then dividing the total by eight and rounding, the maximum minimized transmission size of the delivery in bytes can be calculated in advance for any given week.

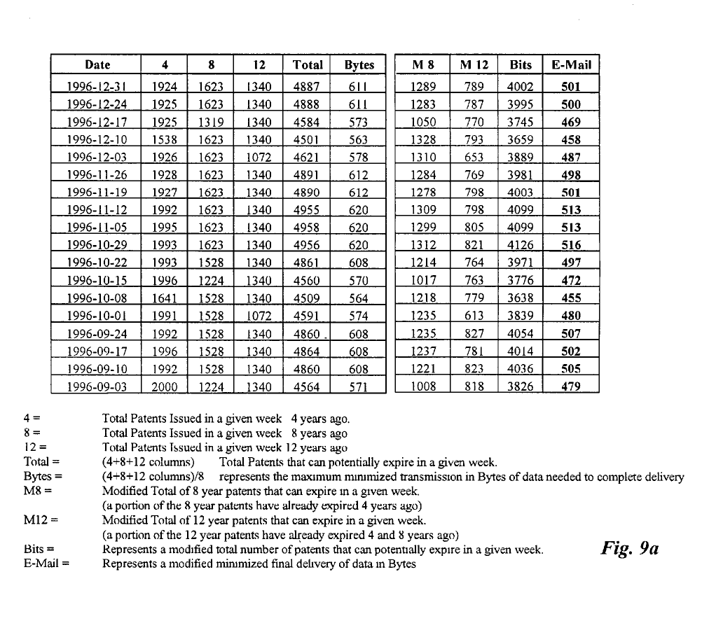

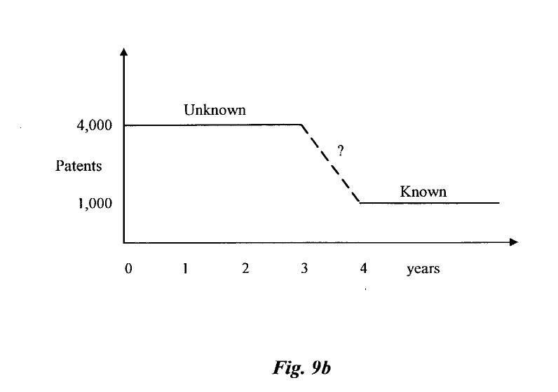

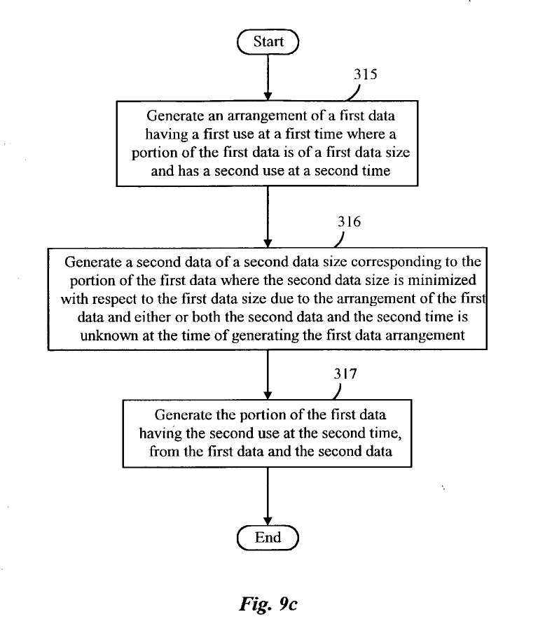

FIG. 9a is an exemplary table illustrating projected delivery sizes of control data in accordance with the present invention. The four, eight, and twelve-year columns represent the number of patents previously issued that have the potential to expire early in a given week. The last four columns in the table show modified values due to previous premature expirations that can reduce the size of the delivery of control data by about 15%. Patents issued eight years ago have already had premature expirations four years ago, and patents issued twelve years ago have already had premature expirations four and eight years ago. There is a way to further reduce the maximum minimized transmission size of the delivery of control data and reduce the storage size of the potentially reusable data per week allowing more weeks to be sent in advance, thereby increasing the subscription period of the disc. The potential for a patent to prematurely expire is created at the time of issuance, and in turn, that potential is removed upon a patent's premature expiration.

FIG. 9b is a graph illustrating the change in potential of expiring information in accordance with the present invention. For a given weekly data set having potentially expiring information such as patent information there are about 4,000 patents that have the potential to expire early, and of those, only about 1,000 patents actually do expire early in a given week. The number of patents that actually lapse for a given week is generally unknown, thus creating the potential. The fact that a potential was created and then later removed shows not only the existence of potential, but also a change in potential. The fact that maintenance fees can not be paid earlier than one year before the premature expiration of the patent means that the potential for the patent to expire early does not change for the first three years of the expiration cycle. For the case of patents, the expiration cycle is four years. For trademarks, the expiration cycle is ten years. It is to be appreciated that the present invention may be applied to trademarks or other forfeited property rights in an analogous manner as mentioned above with respect to patents. For domain names, there can be multiple expiration cycles ranging from 1-10 years.

From the above example, it is gathered that the maintenance fees of about 3,000 patents have been paid during the last year of the expiration cycle. As fees are paid, there are less patents that have the potential to expire early, thereby creating more space on a portable storage media resulting in the possibility for a longer subscription period. For example, if renewal fees are paid linearly, then there is a total of near 60 renewals for each week. A portable storage media can be delivered, where the first data file includes next week's potential premature expirations of about 1,060 patents. The following week would have about 1,120 patents and so forth. At this rate, 50 weeks of potentially reusable data would total to about 126,500 patents.

Without immediate access to renewal information, the potential number of patents to expire early per week can not be reduced. In light of this, by dividing the 126,500 patents by the 4,000 patents that have the potential to expire early in a given week, only 31 complete weeks of information can be stored in the same space as the 50 weeks, thereby increasing the subscription period by 60%. As shown, by using renewal information, the minimum of potential expirations can drop to as low as about 1,060 patents. Dividing by 8 and rounding, the minimum minimized transmission size of the delivery can be calculated to about 133 bytes, thereby further reducing the on-line transmission size by as much as an additional 74%.

The benefits of an increased subscription period becomes critical when applying this application particularly to the search and retrieval of patent document images on Digital Versatile Disc (DVD-ROM). A single layer, single sided DVD-ROM has a maximum storage capacity of about 4.7 GB, and is seven times greater than the storage capacity of CD-ROM which is about 650 MB. Currently, about 1,000 searchable patent document images can fit on CD-ROM, and in turn, roughly 7,000 patents can be placed on DVD-ROM. By placing 4,000 patents per week on disc, as stated from the above example, only one week of patent document images that have the potential to expire early can fit on DVD-ROM. However, with access to renewal information, a full six weeks of patent document images that have the potential to expire early can be stored in advance, thereby increasing the subscription period by 600%. This DVD-ROM application serves further utility because it removes the need for on-line document retrieval. By streamlining the document delivery process, the subscriber 96 is saved the cost and time of on-line document ordering, and allows for complete privacy of unlimited off-line searching, retrieval, and reporting of premature expired patent documents.

FIG. 9c is a flow chart illustrating the steps performed for minimizing reference data size in relation to the size and data arrangement of an originating data repository in accordance with the present invention. The techniques shown above for providing an arrangement of first data of a first data size at a first time for the purpose of generating a second data at a second time having a data size that is minimized with respect to the first data size can have generalized application as shown in the following steps. An arrangement of a first data having a first use at a first time where a portion of the first data is of a first data size and has a second use at a second time can be generated in step 315. A second data of a second data size corresponding to the portion of the first data where the second data size is minimized with respect to the first data size due to the arrangement of the first data can also be subsequently and/or periodically generated in step 316 with the optional condition that either or both the second data and the second time is unknown at the time of generating the first data arrangement. The portion of the first data having the second use at the second time, can then be generated in step 317 from the first data and the second data.

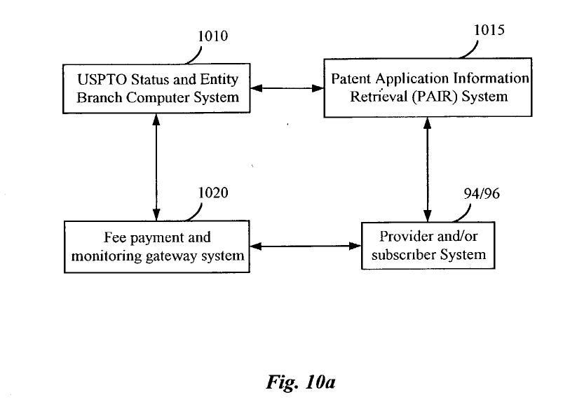

FIG. 10a is a block diagram illustrating the relationship of different component systems with respect to fee payment and status information in accordance with the present invention. USPTO in effect performs the function as sole source data provider of patent and trademark information and has never allowed direct access to fee payment information except by responding at most to a handful of payment information requests at a time by customers via telephone. In one aspect, an office status branch payment system such as the USPTO Status and Entity Branch system 1010 can be operatively associated with a patent application information retrieval system such as the USPTO PAIR system 1015. Furthermore, a designated fee payment and monitoring gateway system 1020 preferably operated by a sole source data provider in the private sector such as a third party annuity or renewal service can be in communication via at least one communication link with the USPTO Status and Entity Branch system 1010 and/or PAIR system 1015. Such a gateway system 1020 can be adapted to broker payment monitoring requests and payment transaction requests between the public, government, and its customers. More particularly, a provider and/or subscriber system 94/96 whether tiered or not, can communicate transaction and monitoring requests to a patent office such as the USPTO via the gateway system 1020 as well as direct access to the PAIR system.

Only recently, has the USPTO enabled access to maintenance fee payment information via the PAIR system, however such payment information remains distributed and has never before been available to the public as a centralized data source. The gateway system database (not shown) can be populated by using as input a data file 142 representative of a weekly dataset of all patents that can potentially expire at the four, eight, and twelve year mark for the purpose of successively querying the PAIR system 1015 to compile payment information for each given weekly dataset. For instance, a script such as a Perl or CGI script can be used to autofetch and compile payment data. A URL can be constructed representative of each patent in the dataset and then used to locate and access a network resource with respect to payment information corresponding to the patent. Only three variables are needed to perform this compilation function which include the patent number, application/serial number, and the maintenance fee year in question. The following template includes variables called issno, appno, and myear which can be used for constructing a URL:

[“https://rampsdev.uspto.gov/ram26/Controller? from=mf_view.jsp&submit=a&a=mf_statement_view.jsp&mfPatentNumber=“.issno.”&mfSerialN

In turn, a URL can be constructed representative of each patent in the dataset and then used to locate and access a network resource with respect to contact information corresponding to the patent. Only two variables are needed to perform this compilation function which include the patent number and application/serial number. The following template includes variables called issno and appno, which can be used for constructing a URL:

[“https://rampsdev.uspto.gov/ram26/Controller? from=mf_view.jsp&submit=a&a=mf_validate_view.jsp&mfPatentNumber=“.issno.”&mfSerialNum

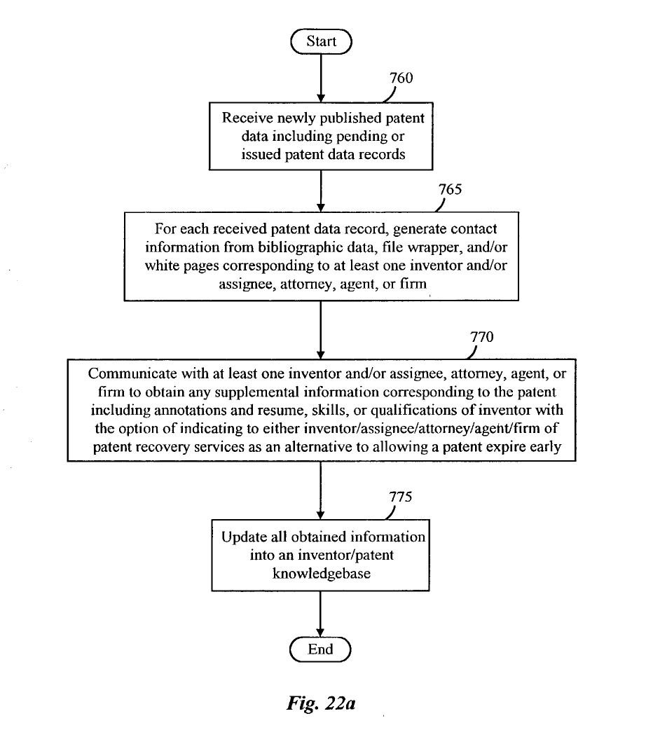

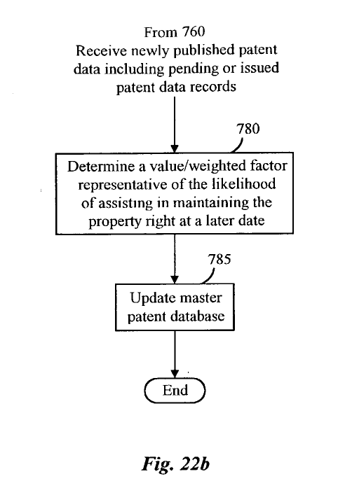

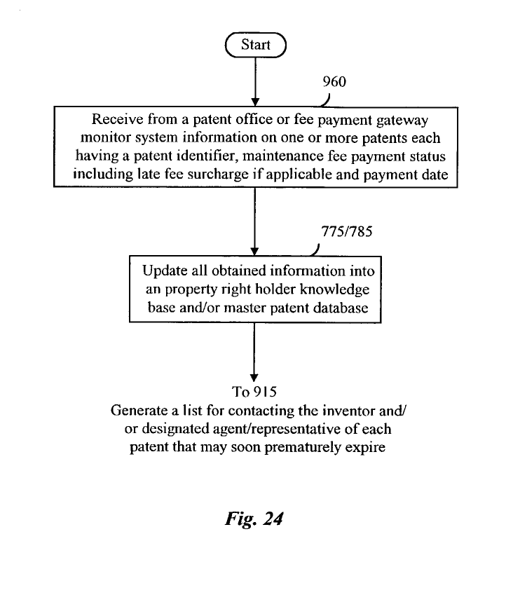

Output can include indicators such as whether or not payment was made and whether there was a surcharge if paid. Other indicators can include a date and amount of payment, contact information as to who made payment and whether or not the assignee/inventor is a small entity. Much can be learned by compiling this new source of distributed information. For instance, at least 90% or better of all payments are made during the first six months of the one year payment window. There are numerous benefits for determining when a maintenance fee has been paid including the ability to increase the subscription period on a portable storage media as discussed above and more quickly and accurately with less resources identify, locate, and communicate with a new market segment of patent owners that have a high likelihood of failing to pay for an upcoming maintenance fee. As a result, and as will be discussed (see FIG. 22a and FIG. 24) there can emerge an entirely new set of product and service offerings to this newly accessible market segment.

FIG. 10b is a flow chart illustrating the steps performed for accessing renewal information such a maintenance fee payment and status information in accordance with the present invention. When a fee payment corresponding to a property right such as a patent or trademark is accepted in step 1030 by an intellectual property office such as a patent and/or trademark office, the fee payment information is updated in step 1035 in an office status branch payment system 1010. In the case of the USPTO, maintenance fee payment can be accepted either directly from a subscriber/provider system 94/96 or via a fee payment gateway monitor system 1020 in communication the patent office status branch payment system 1010 and the like. In turn, the USPTO Status and Entity Branch system 1010 or any such similar system can reflect such updated payment information in the PAIR database system 1015. Upon any event reflecting a payment status change in the sole source payment data corresponding to an office status Branch system 1010 or any such similar system such as the USPTO PAIR database system 1015, the fee payment gateway monitor system 1020 can be automatically notified in step 1040 of any such event changes. In turn, the gateway system 1020 can store/forward or relay at least a portion of the status update in step 1045 to any provider/subscriber system 94/96 who has previously requested such status updates from the gateway system 1020.

While a patent is in effect, the utility to the public is the knowledge gained from the disclosure of the invention. When a patent expires, the utility to the public changes, allowing anyone to practice or use the knowledge gained from the patent by ‘making, using, or selling the invention.’ There is in turn an on-line implementation for reducing the search and retrieval time of premature expired patent documents. As shown, the premature expiration of a patent is seen, if at all, as a status or subset of all patents. As a result, all search requests for premature expirations, if any, are searched in relation to a database of all patents. Because the utility to the public of premature expired patent information changes, the arrangement of premature expired data offers new use when searched. The premature expired information is partitioned and arranged as a new set of data (independent of its previous subset or status in relation to all data) and its resultant search time becomes significantly reduced. This new compilation restores the temporal displacement of information resulting from the potential of multiple premature expirations. Applying a search and retrieval system to this new compilation gives the user reduced storage and increased access speed regardless of where the compilation resides.

The primary goal of information dissemination of public information is to increase the potential of its accessibility to the public. This is accomplished by reducing distribution costs and creating incentives for the ease of retrieval that has been previously shown. Currently, the premature expiration status of a patent can be searched on the CASSIS-BIB disc or searched via a dedicated on-line connection to a select few commercial data vendors at most. There have been patent servers in existence on the Internet for more than two years offering up to twenty-seven different fields for selective searching of patent information. However, there are no patent servers of any kind on the Internet that allow for the specific search of premature expired patent information.

Because patent examiners have had no immediate use for premature expired information, the APS data available to commercial data vendors and the public has never been designed to be reconciled with future premature expirations. Furthermore, commercial data vendors have been motivated by the profits of existing niche markets, and in turn, have had no immediate need or basis to solve the problem of facilitating access of premature expired patents or trademarks to the public at large. Even though compiled or partitioned arrangement of premature expired patent information is the best way to search for it, as of yet there is no evidence or intention by anyone or any entity to facilitate searching on the Internet for premature expired patent information regardless of whether the arrangement of premature expired patent information is compiled or not (e.g., centralized/distributed).

Aspects of the present invention as discussed above are specific to a preferred set of embodiments that focus on the renewal or expiration of a data record. In effect, the delivery of data records that are selected and arranged (e.g., sorted, ordered, etc.) by potential expiration date to a subscriber serves as a functional arrangement of data which serves use at a future date or repeated use at future dates. The data arrangement becomes immediately useful for quickly searching those records that may soon potentially expire and such arrangement serves a further use at a later date when it is determined what records from the arrangement have actually expired. By creating a long term data cache sorted by renewal date or date of potential expiration, small amounts of data records (which are typically scattered through large amounts of data) can be consecutively buffered, in advance, to minimize bandwidth of final delivery for determining what data has or has not been renewed/expired.

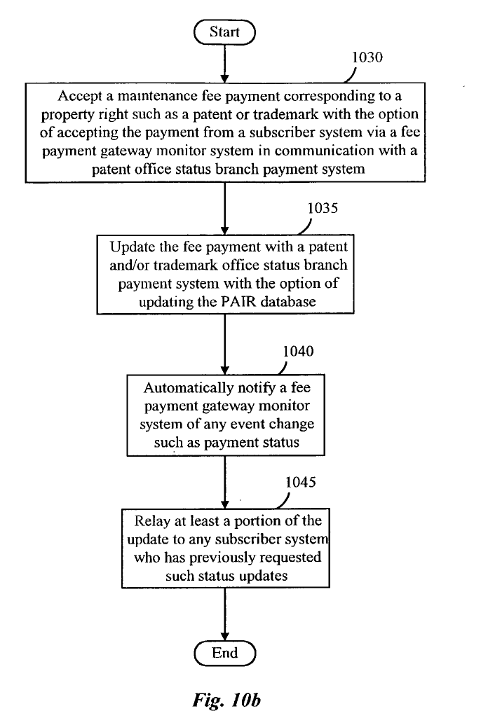

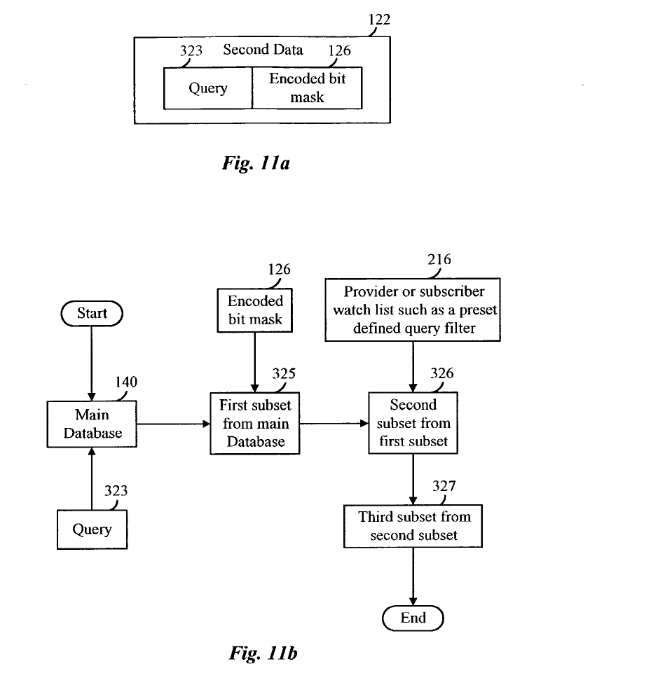

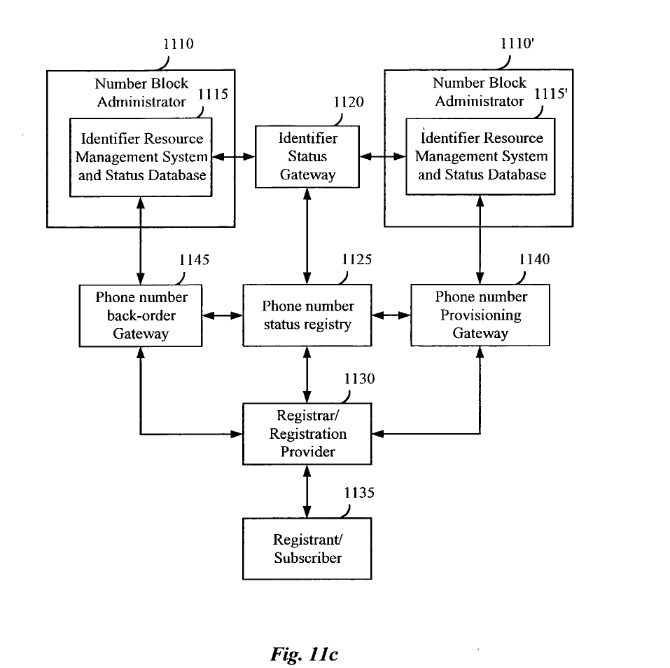

FIG. 11a is a block diagram illustrating a more detailed aspect of reference data in accordance with the present invention. When different data fields have variable expiration periods or when different portions of the database are updateable, a query or query structure can be included with the delivery of the control data so that a subset of data is remotely determined and/or generated on the subscriber/client side for the encoded bit mask to be overlaid to determine the “new” information update derived from a portion of the existing data. Rather than sending a bit for every data record on the subscriber/client side, reference data can include a query 323 for selecting a portion of the database and also include an encoded bit mask 126 representing the status of the query to further reduce bandwidth and control/reference data size.

FIG. 11b is a flow chart of illustrating the steps performed for generating recursive data subsets of new information in accordance with the present invention. There are broader aspects of the present invention that are applicable to the subject of remotely updating data such as data files and/or databases particularly pertaining to data having a very large file size or having millions of data records. The issue date or expiry date are arbitrary fields in a data file or database, which is used to derive new use based upon unknown status/control/reference data determined at a later date. As shown, any data element or data elements (field/fields) of a database 140 or any substantial portion thereof can have further application. In effect as discussed, data records sharing a common expiry date (An initial query 323) constitute a first subset 325 of data records of the database 140 wherein a second subset 326 within the first subset 325 of the database 140 can be determined at a later date from the delivered encoded bit mask 126. In turn, the user/customer/registrant/client/provider/subscriber preset query filter/watch list 216 can be viewed as a third subset 327 within the second subset of data 326. In general, the selection of recursive data subsets from a previous data subset over time can be applicable for distilling and compiling data of new use.

For example, there is a database having 8 million data records (such as a telephone number database for a given area code) which would require a maximum minimum delivery size of control data representing 8 million bits or 1 million bytes (1 Meg) of data to determine a status update or to generate a new compilation from a subset of data records. In this case, such an update represents the notification of available telephone numbers for a given area code for a given time. After an apparatus performs the information update in accordance with the present invention, the generated list of available telephone numbers are then used to create mnemonic representations of such numbers for the purpose of making a list available to the public that is desirable to those interested in using telephone numbers for reasons of vanity, commercial interest, or that such available numbers are easier to remember, etc.

When an update for a given telephone exchange is needed. Rather than sending the 1 Meg update spanning all data records, 10,000 bits (1.25K bytes) and a query such as a SQL statement having the search term “212-555” which equates to a couple hundred bytes at most are sent as control data. The present invention is further configured to receive the control data, query the main database, generate a smaller database representing a subset of 10,000 data records for the telephone numbers that range from “212-555-0000” to “212-555-9999”. After database generation, the encoded bit mask of 10,000 bits is overlaid over the first subset to generate a second subset to finally compile and determine the phone numbers available for the given telephone exchange. By creating recursive data subsets the file size of the control data is compressed by a ratio as of roughly 750:1 or so. The invention has further application when telephone databases are partitioned in a reverse hierarchy. For instance, an “8800” database is created having data records representing telephone numbers across scattered geographies in the form of NPA-NXX-8800. An “8800” control file is sent, so that at any given time, the availability of telephone numbers ending with the number “8800” can be determined with minimized transmission of reference data.

FIG. 11c is a block diagram illustrating a phone number provisioning and back-ordering system in accordance with the present invention. There are plurality of pooling administrators or number block administrators (NBA) 1110/1110′ responsible for the provisioning of telephone numbers. Such NBAs could be a central office managing one or more local exchanges or any telecommunications provider with the authority to assign and provision phone numbers. Each administrator can operate an identifier resource management (IRM) system and status database 1115/1115′ including a service management system (SMS) (not shown), which is a service order entry and provisioning system used to enter and provision orders for local services for customers, and can automatically assign telephone numbers to a customer. Such status indicators can include (not shown) “OPEN”, “RESERVE”, “ASSIGN”, “WORKING”, “SUSPEND”, “DISCONNECT”, “BACK-ORDER”, and “MONITOR”. The “BACK-ORDER” flag of a data record indicates whether there is a wait list, pre-ordering queue, or back-order request on a telephone number that is not “OPEN” or available for customer subscription. The “MONITOR” flag of a data record indicates that when the status of a telephone number changes, that such status change is reported in real-time to an identifier status gateway such as the phone number status gateway 1120. In another aspect, the IRM system can be adapted to compare such flagged status changes to customer/subscriber watch lists 216 for the purpose of reporting to the customer of any such status changes with the option of performing an operative action, such as that of an automatic reservation or provisioning request depending on having met a set of business rules, a threshold value, or other minimum criteria.

A central registry status authority can administer and manage a phone number status gateway 1120 that is in operative association via at least one communication link with a plurality of IRM systems 1115/1115′ for the purpose of populating and maintaining in real-time a national/state/regional phone number status registry 1125 in operative association with the status gateway 1120 enabling registration providers/registrars such as a Licensed Phone Registrar (LPR) 1130 in communication with the status registry 1125 to provide telephone number reservation, status check, back-order, and provisioning services to registrants and subscribers 1135 on behalf of all participating NBAs 1110/1110′. Whenever a service request is performed on behalf of the subscriber, either the registration provider 1130 and/or registry administrator 1125 can communicate such service requests to the appropriate NBA-IRM system via one or more specialized gateways such as a phone number provisioning gateway 1140 and/or phone number back-ordering gateway 1145 or any other similar request gateways (not shown) that are operatively associated between the registry/registrar 1125/1130 and the appropriate IRM systems 11 15/1115′. Such specialized gateways may act as a routing gateway, if need be, for the purpose of enabling a registration provider 1130 to connect/route a subscriber/registrant 1135 directly to the appropriate NBA 1110/1110′ to complete any such service requests.

In one implementation a central registry status authority can enter into a contractual agreement with the option of providing compensation to each participating NBA, for example. In exchange for each NBA that adapts their IRM system to report all real-time status changes to an identifier status gateway such as a phone number status gateway 1120 enabling an identifier status registry such as a phone number status registry 1125 to be populated, each NBA can be compensated whenever their portion of the registry is accessed by a registrar/registration provider 1130 who pays the registry for the privilege of querying and accessing the database. Each IRM system can be further adapted to determine whether a phone number is back-ordered before making any status change to a selected phone number. More particularly, back-ordering verification can be determined before the phone number status changes from any state to an “OPEN” state. When a back-order for a given phone number is detected and the aging process for a “DISCONNECT” status has completed, then the phone number can automatically be reserved, reassigned, and/or provisioned by the adapted IRM system by retrieving the appropriate data records corresponding to the back-order subscriber/registrant.

Though it is preferred that identifier status gateways are primarily used to route communication across a variety of protocols (e.g., SOAP, UDDI, Web Services, etc.) and data formats between resource systems distributed across one or more networks, the present invention does not need to rely on such a gateway system and can instead provide application programming interfaces (APIs) for operators of IRM systems to install and adapt such systems to import/export real time event data and status data directly to the identifier status registry via a common data format (e.g., XML format). Furthermore, other existing databases could be adapted to perform functions equivalent to the identifier status registry, for instance, a data base, called the Line Information Data Base (LIDB), is part of the infrastructure that facilitates call handling in the United States circuit-switched telephone network. LIDB is an application program that resides on a service control point (SCP) and provides validation information for use in alternate billing services, such as telephone calling cards. LIDB contains up-to-date records of all working lines, calling card numbers, and other data required for validation services. Other databases can include but are not limited to local number portability (LNP) databases, Mobile DataBase Station (MDBS), DataBase Administration System (DBAS), and the like. Similarly, such status information can be communicated across a series of telecommunications switching devices adapted to communicate such information.

In another aspect, the above system can readily be adapted by one of ordinary skill in the art for the management of license plate identifiers as well. For instance, the Department of Motor Vehicles (DMV) of each state can operate a similar IRM system adapted to report all status changes to an identifier status registry having license plate identifiers. Such a registry can be accessed by licensed registration providers on behalf of customers desiring to register, reserve, renew, and back-order their license plate of choice. In addition, whenever a license plate identifier is registered, reserved, or renewed, at least one domain name corresponding to the license plate identifier can then be generated and/or selected (not shown) with the option of selecting at least one domain name from an identifier database having one or more domain names.

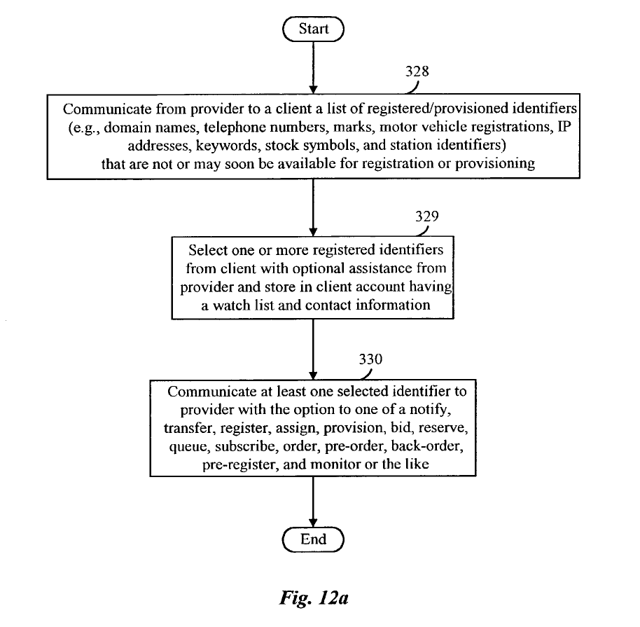

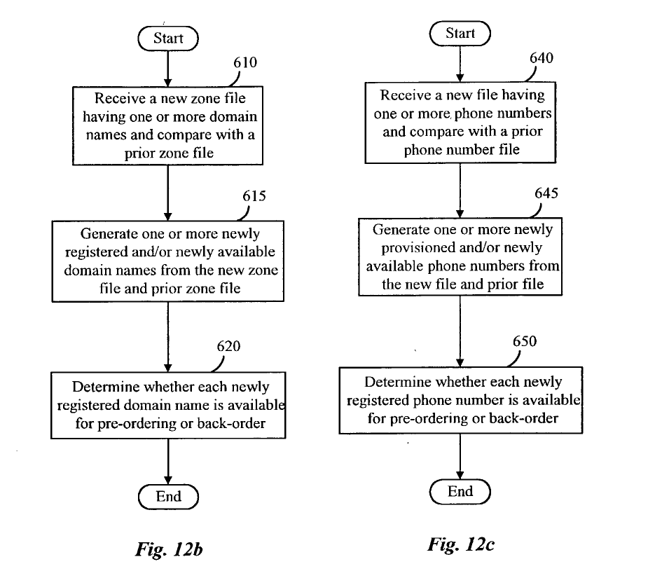

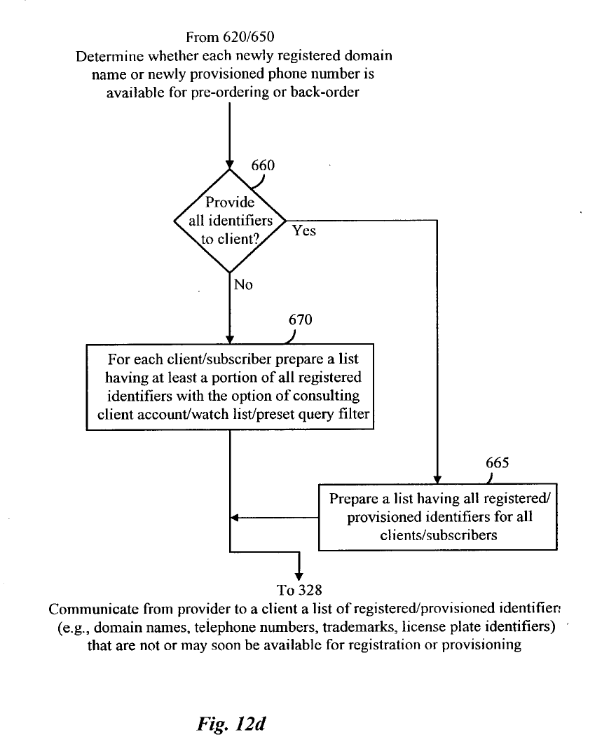

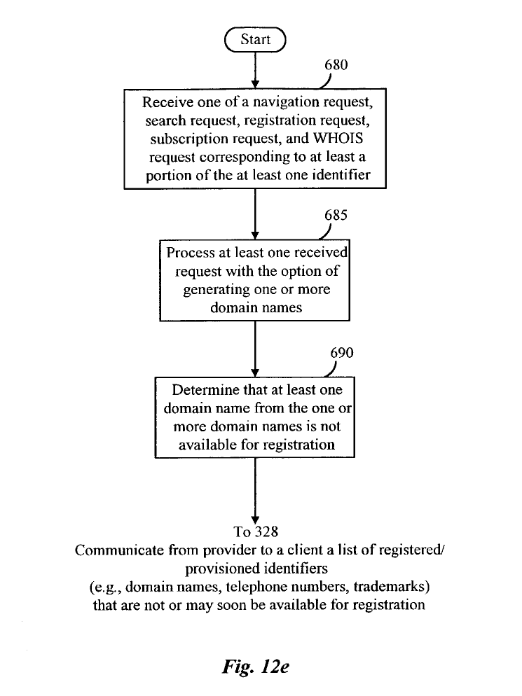

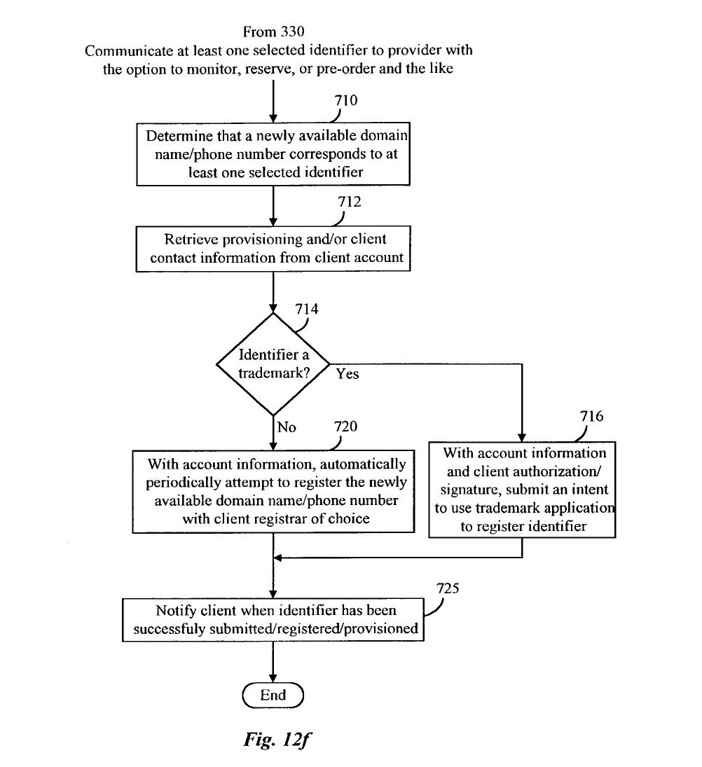

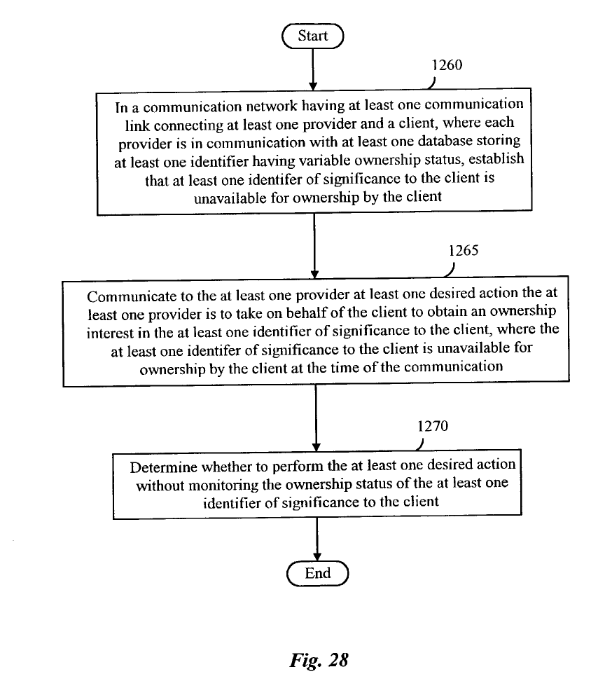

Though a top level flow chart illustrating the steps of a preferred aspect of the present invention is presented in FIG. 28, the following flow charts (FIG. 12a - FIG. 12f) depict other aspects of the present invention. FIG. 12a is a flow chart illustrating the steps performed for indicating how a provider can be notified of a data selection that may soon become available for reuse in accordance with the present invention. When a list of registered/provisioned identifiers (e.g., domain names, telephone numbers, marks, motor vehicle registrations, IP addresses, keywords, stock symbols, and station identifiers) that are not or may soon be available for registration or provisioning is communicated in step 328 from a provider to one or more clients, one or more registered identifiers can be selected in step 329 by a client with optional assistance from provider and stored in a client account having a watch list and contact/registrant information. At least one selected identifier can be communicated in step 330 to the provider with the option to one of a bid, reserve, queue, subscribe, order, pre-order, back-order, pre-register, and monitor the selected identifier. Monitoring services can be used by registrants/subscribers/customers/clients to track either active or inactive identifiers. Such monitoring technology employed by aspects of the present invention is capable of processing information about real time events that is communicated through push, pull, or other communication strategies with registrars, registries, providers, clients, registrants, subscribers, and the like.

Telephone numbers, domain names, marks, vehicle registration identifier (e.g., license plate numbers) are representative of some exemplary identifiers that can be re-registered, re-reserved and/or re-assigned, and re-provisioned. It can be appreciated that those of ordinary skill of the art can practice the present invention with other identifiers including but not limited to IP addresses, ENUM identifiers, Internet Keywords, fictitious domain names, numerical domain names, multilingual domain names, domain names including the path portion of a URL (e.g., surf.to/patents, can be back-ordered or re-registered and the like), stock symbols, station identifiers including broadcast call letters, and so forth. Steps for processing fictitious domain names are explained in U.S. patent application Ser. No. 09/532,500 filed Mar. 21, 2000, by Schneider, entitled “Fictitious domain name method, product, and apparatus”, which is herein incorporated by reference. Furthermore, systems and steps for contemporaneously determining whether such identifiers across naming systems are available for back-order can be constructed by one of ordinary skill in the art as explained in U.S. patent application Ser. No. 09/650,827 filed Aug. 30, 2000, by Schneider, entitled “Method, product, and apparatus for determining the availability of similar identifiers across naming systems”, which is herein incorporated by reference.

Though it may be unknown when a property is forfeited, the holding, pending, or grace period of a property is known before such property enters the public domain. For instance, immediate use can be made by the public having access to those telephone numbers that are on hold before it is determined what telephone numbers are newly available. When a subscriber or provider terminates service of a telephone number, the telephone number is aged ninety days for residents and one year for businesses before released or changed to an “OPEN” status and made available to other subscribers. During this pending time, a subscriber may renew service so it is unclear as to what telephone numbers are inevitably available at the release date.

Registered and/or provisioned identifiers such as telephone numbers, domain names, trademarks, license plate numbers, IP addresses, keywords, stock symbols, and station identifiers have the potential of becoming newly available for registration. For example, each day identifiers such as newly forfeited telephone numbers that are put on hold or disconnected can be communicated in step 328 to a subscriber/registrant/customer or published as public information. In addition, a control/reference file can be sent and combined with previously transmitted telephone numbers that are on hold to compile a subset of newly available subscriber telephone numbers. The invention is not limited to sending the control/reference data to generate telephone numbers, but rather, a list of telephone numbers can be sent as is instead.

The provider or subscriber/client can execute a script or program to make mnemonic conversions of identifiers such as telephone numbers into letters to determine and select in step 329 at least one identifier such as a phone number that might have a personal significance or commercial purpose, etc. yielding further information for the subscriber 96 to identify potentially newly available desirable telephone numbers in advance. Features of such a program include, converting numbers into words (including words that have more than 7 placeholders; e.g., 1-555-288-6662=1-555-AUT-OMOB=1-555-AUTOMOBILE), repeating digits (e.g., retrieving all available numbers ending in “00” across all local exchanges), etc. A bidding, wait list, back-order, monitoring, event notification, alerting, and/or auction system can be operatively associated to a registrar, registry, administrator, and/or one or more provider systems by those of ordinary skill in the art in order communicate with the provider and/or client and used in conjunction with communicating information back to one or more providers in step 330 by having one or more clients/subscribers/registrant perform one of a bidding, reserving, queuing, subscribing, ordering, pre-ordering, back-ordering, pre-registering, and monitoring request of a selected identifier such as soon to be available telephone numbers.

Telephone provisioning providers such as Licensed Phone Registrars (LPRs) can compete for auctioned bids on behalf of their client or for random/pooled electronic bidding when identifiers such as telephone numbers and the like do become available for subscription, registration, assignment, provisioning. Such provider/client communications can take place via a communication network such as a telephone network. For instance, a telephone operator or registration provider can call or receive a call from a subscriber/client to personally assist in the identifier selection and order taking process. In addition, correspondence such as fax, snail mail, and e-mail can also be used to perform the above operations. Either the registry and/or registrar can be the provider. The provider can be a subscription provider and/or registration provider and the client can be a subscriber and/or registrant.

Another field of application pertains to the availability of trademarks/servicemarks and the like. For example, each week there can be thousands of U.S. federal trademarks that expire for failure to perpetuate the granted property right by the owner (failure to pay renewal fees). A client can pre-register a trademark of interest in a selected goods/services category and provide the minimum information necessary to a provider via a communication network to help expedite the filing of such a trademark application at a possible later date if and when such a trademark of interest expires.

Yet another field of application pertains to the availability of domain names. In addition to telephone numbers, trademarks, license plate numbers, identifiers such as domain names that may soon be available can be queried by a subscriber 96 or distributed in step 328 in advance to a subscriber 96 as well, so that domain names of interest can be selected in step 329 with the option of being ordered, registered, subscribed, or reserved in step 330 in a preordering queue from either the client 110 or server 114 side. In addition, subscriber contact information can be used to automatically populate a registration form with completed registration information and then submitted (not shown) to or by a registrar on behalf of the subscriber/registrant when the soon to be available domain name that is selected does become available for registration.

Methods can be applied to TLD zone files for determining registration or expiration dates of domain names. These methods can be used to overcome the inability of accessing the registration dates of domain names from the WHOIS database. The TLD zone files are used to help perform the function of routing Internet communications. Further use can be derived from the TLD zone files by determining the difference between TLD zone file updates and extract both new domain names issued and old domain names that are inactive into at least one database. Registration dates and expiry dates are assigned accordingly to such extracted domain name data. More specifically, each release of a given TLD zone file is compared to the previous TLD zone file released. Those entries that no longer exist are appended to a soon to be available domain name database. Entries that have never existed are assigned a registration date and appended to a newly issued domain name database. Near the end of an expiration cycle when such newly registered domain names may potentially expire for failure to pay renewal fees, data sets of domain names can be formed by expiry time and cached by appending such data sets to the soon to be available domain name database.

FIG. 12b is a flow chart illustrating the steps performed for determining if a newly registered domain name is available for back-order in accordance with the present invention. When a new zone file having one or more domain names is received and compared in step 610 with a prior zone file, one or more newly registered and/or newly available domain names can be generated in step 615 from the new zone file and prior zone file. Furthermore, responsive to detecting that one or more domain names have been newly registered, it can further be determined in step 620 whether each newly registered domain name is available for pre-ordering or back-order.

FIG. 12c is a flow chart illustrating the steps performed for determining if a newly provisioned phone number is available for back-order in accordance with the present invention. When a new file having one or more phone numbers is received and compared in step 640 with a prior file, one or more newly provisioned and/or newly available phone numbers can be generated in step 645 from the new file and prior file. Furthermore, responsive to detecting that one or more phone numbers have been newly provisioned/registered, it can further be determined in step 650 whether each newly provisioned phone number is available for pre-ordering or back-order.

FIG. 12d is a flow chart illustrating the steps performed for notifying subscribers of monitored resource identifiers in accordance with the present invention. When it is determined (step 620/650) that each newly registered domain name or newly provisioned phone number is available for pre-ordering or back-order, then it can be determined in step 660 whether to provide such a list in its entirety. When this is the case, the list having all registered/provisioned identifiers for all clients/subscribers can be prepared in step 665 otherwise a list having at least a portion of all registered identifiers with the option of consulting client account/watch list/preset query filter 216 can be provided in step 670 to each client/subscriber. This can be accomplished (step 328) by communicating from provider to a client a list of registered/provisioned resource identifiers (e.g., domain names, telephone numbers, trademarks, vehicle license/registration identifiers, IP addresses, keywords, stock symbols, and station identifiers) that are not or may soon be available for registration.

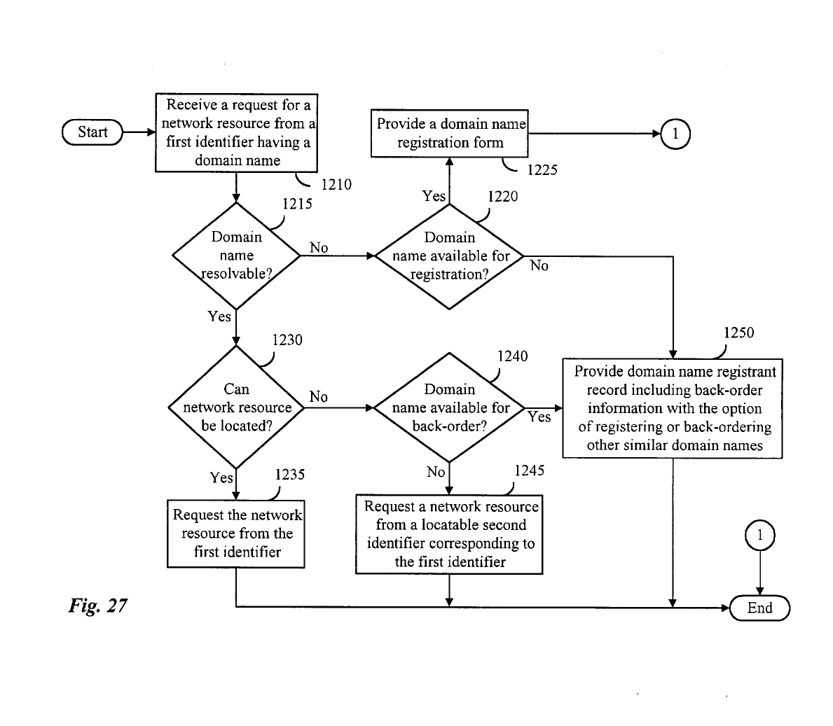

U.S. patent application Ser. No. 09/682,133 filed Jul. 25, 2001, by Schneider, which claims the benefit of U.S. patent application Ser. No. 09/525,350 filed Mar. 15, 2000, by Schneider, now U.S. Pat. No. 6,338,082 discloses how registration requests and/or search requests can be performed responsive to the initiation of other request types such as a failed navigation request, where as U.S. patent application Ser. No. 09/440,606 filed Nov. 15, 1999, by Schneider, which claims the benefit of U.S. patent application Ser. No. 08/900,437 filed Jul. 25, 1997, by Schneider, now U.S. Pat. No. 5,987,464 discloses an identifier back-ordering system where a provider in communication with a client provides to the client, identifiers such as domain names and telephone numbers that are unavailable for registration, and in turn, receives a request from the client to either reserve, subscribe, reserve, queue, pre-order, pre-register, order, and/or monitor at least one selected identifier with the provider. Though it is apparent to one of ordinary skill in the art that the teachings disclosed in both of the above patent applications are complimentary and can be readily combined, explicit emphasis can be placed by showing (see FIG. 12e and FIG. 27, for example) some specific ways these complimentary teachings may be provided in combination with respect to an aspect of the present invention.

FIG. 12e is a flow chart illustrating the steps performed for processing one of a navigation, search, registration, and WHOIS request relating to at least a portion of a domain name in accordance with the present invention. When one of a navigation request, search request, registration request, subscription request and WHOIS request relating to at least a portion of a domain name is received in step 680, at least one received request can be processed in step 685 with the option of generating one or more domain names. When it is determined in step 690 that at least one domain name from the one or more domain names is not available for registration, such a list of registered domain names that are not available for registration can be provided or communicated to a client (step 328) and/or the requestor of the navigation request, search request, registration request, and/or WHOIS request. As explained in U.S. patent application Ser. No. 09/598,134 filed Jun. 21, 2000, by Schneider, registrant contact information such as the WHOIS record of a domain name registrant can be modified to provide additional results including metalinks. For instance, when it is determined that a domain name is not available for registration, a record from the WHOIS database may be displayed including metalinks for accessing the aftermarket status of the domain name such as the back-order status and may include a sale price by the registrant or from an auction. Such steps can also be applied by those of ordinary skill in the art to identifiers such as trademarks and telephone numbers as well.

FIG. 12f is a flow chart illustrating the steps performed after communicating selection information to a provider system in accordance with the present invention. When at least one selected identifier is communicated (step 330) to provider with the option to watch, bid, monitor, reserve, or pre-order and the like, it can be determined in step 710 when a newly available domain name/phone number corresponds to at least one selected identifier. Client account contact information can be retrieved in step 712 from a client account and used with the option of automatically and/or periodically attempting in step 720 to register/provision the newly available domain name/phone number with the client registrar of choice. If however, the identifier is determined in step 714 to be a trademark/servicemark/tradename and the like, then with account information and client authorization including an appropriate signature, an intent to use trademark application can be submitted in step 716 on behalf of the client to register the identifier. In either case, the client can then be notified in step 725 when the corresponding resource identifier has been successfully submitted, registered and/or provisioned.

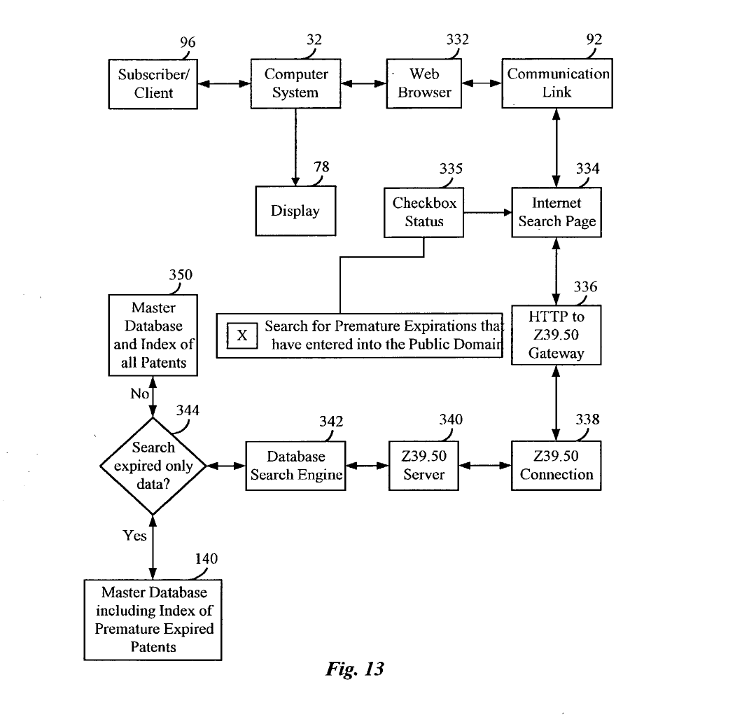

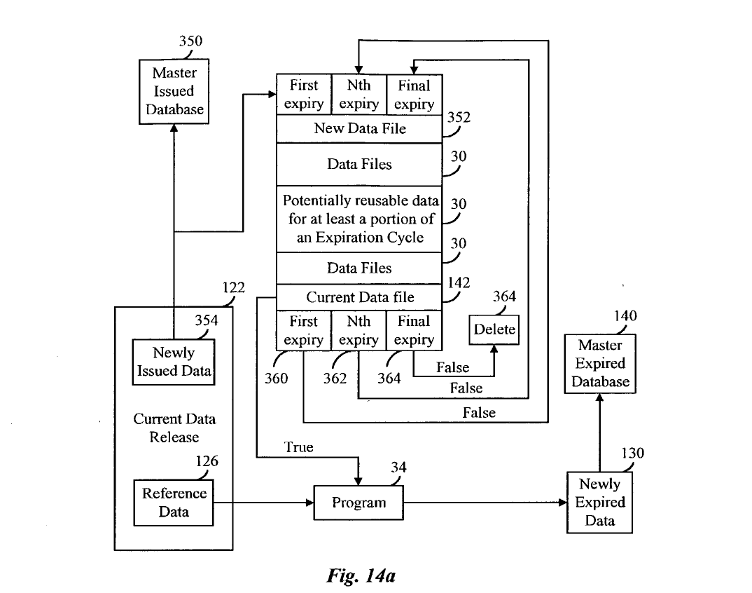

FIG. 13 is a block diagram illustrating how query request(s) can be routed to either main and/or expired information database(s) and/or index(s) in accordance with the present invention. Though such techniques are applicable to different data set types such as domain names, trademarks, telephone numbers, copyrights, etc., in a preferred aspect a subscriber 96 performs a query on a web page 334 at a web site on the Internet via the transceiver 92 of a computer system 32 by using a World Wide Web (WWW) browser 332 which is a program that interprets many different on-line protocols and displays 78 such information received by these protocols in a desired manner to the subscriber 96. One such protocol called the HyperText Transfer Protocol (HTTP) is the most common method to access information via the web pages 334 of a Web server on the Internet. Requests for information accessed are sent and received in the form of HyperText Markup Language (HTML) which is an understood format for the HTTP. Another communications protocol that has been universally accepted as a standard for on-line database searching is called the Z39.50 protocol. The Z39.50 server 340 accepts TCP connections from the transceiver 92 of a computer system 32 and requests to search and retrieve from available databases accessible through the database search engine 342.

When a subscriber 96 requests a patent search at the provider's search page 334 on the Internet, a connection to the correct database is established before a query session can begin. The status of a checkbox 335 is assessed to see if the subscriber would like to intentionally search for premature expirations that have entered into the public domain. The WWW browser 332 connects to the HTTP server 334 at a web site on the Internet and posts a HTML form containing information related to a new or existing Z39.50 session. The Z39.50 gateway 336 parses the HTML form and starts a new Z39.50 connection 338 or connects to an existing Z39.S0 connection 338. The subscriber's request is then passed from the Z39.50 gateway 336 to the appropriate Z39.50 connection 338, which in turn communicates with the remote Z39.50 server 340. A query is extracted from the parsed HTML form and is passed on from the Z39.50 server to the database search engine 342 for obtaining search results. Based on the status of the checkbox 335, the search engine 342 decides 344 to query either the premature expired patent database 140 or the entire patent database 350. The search and retrieval of premature expired patents can be obtained regardless of which database is being used. The results are passed back from the Z39.50 server 340 to the Z39.50 connection 338, back to the Z39.50 gateway 336, to the HTTP server 334 and back to the WWW browser 332 for display 78 to the subscriber 96. The Z39.50 gateway 336 process then exits, but the associated Z39.50 connection 338 process stays, holding open the Z39.50 connection 338. If a Z39.50 connection 338 process receives no input for a pre-configured period of time, then the connection times out and exits.

Providing two separate databases is but one implementation of illustrating the exclusive use of a compiled master premature expired database. Instead of a status checkbox, a web page or web site is used exclusively for the display and selection of premature expired property listings or for the search and retrieval of premature expired property information only. To date, the patent community has neglected to offer services devoted exclusively to the publication of premature expired information. The compiled database remains, to date, an overlooked resource that has never been utilized as a “new” self-contained whole having its own utility and does not rely upon the utility from the original data source from where the compilation is derived. Another implementation is to have a main index and a premature expired index that both correspond to one master database of all patents. Yet another implementation of the status checkbox is to determine which index to select and use to retrieve data from a main database rather than or in addition to determining which database to select.

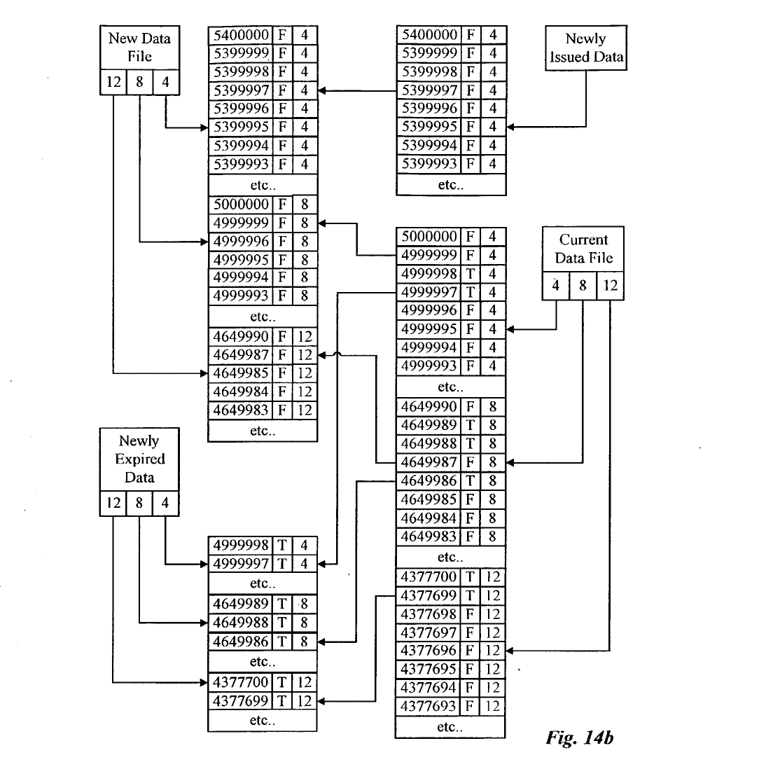

FIG. 14a is a block diagram illustrating how master databases of both main and expiring data can be updated including creating a new file of potentially reusable data when receiving a current delivery in accordance with the present invention. Though such techniques are applicable to different data set types such as domain names, trademarks, copyrights, etc., in a preferred aspect a master database of all patents 350, a master database of premature expired patents 140, are updated and used to create a new file 352 of potentially reusable data 30. A program 34 is executed to receive a current delivery 122 of data containing both newly issued patent data 354 and control data 126. The newly issued patent data 354 is appended to update the master database of all patent information 350. As previously outlined, all records having a logical value of TRUE in the expired field of the current data file 142 are extracted by the program 34 to form the newest premature expired patents 130, which in turn is appended to update the master database of all premature expired patents 140. A new file 352 of potentially reusable data 30 is created by first copying newly issued patent data 354 to a new data file 352. The expired level field of the current data file 142 is then incremented to the next potential expiration level and is modified by replacing a 4 with an 8, and an 8 with a 12 for all four 360 and eight year 362 records having a logical value of FALSE in the expired field of the current data file 142. The modified data is then appended to the new data file 352 creating a new file 352 of potentially reusable data 30. The next level of expiration for twelve year 364 records having a logical value of FALSE are final. Therefore, the twelve year 364 records have no further use. All records of the current data file 142 have been updated and put into other files and in turn, have no further use. The current data file 142 is then deleted. FIG. 14b is a diagram of the relationship of the data structures needed to create a new file of potentially reusable data as shown in FIG. 14a in accordance with the present invention.

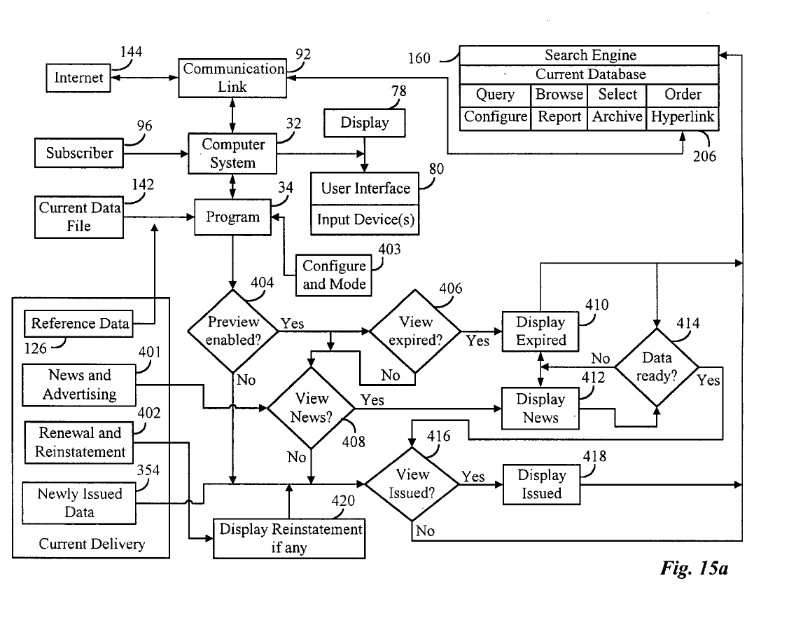

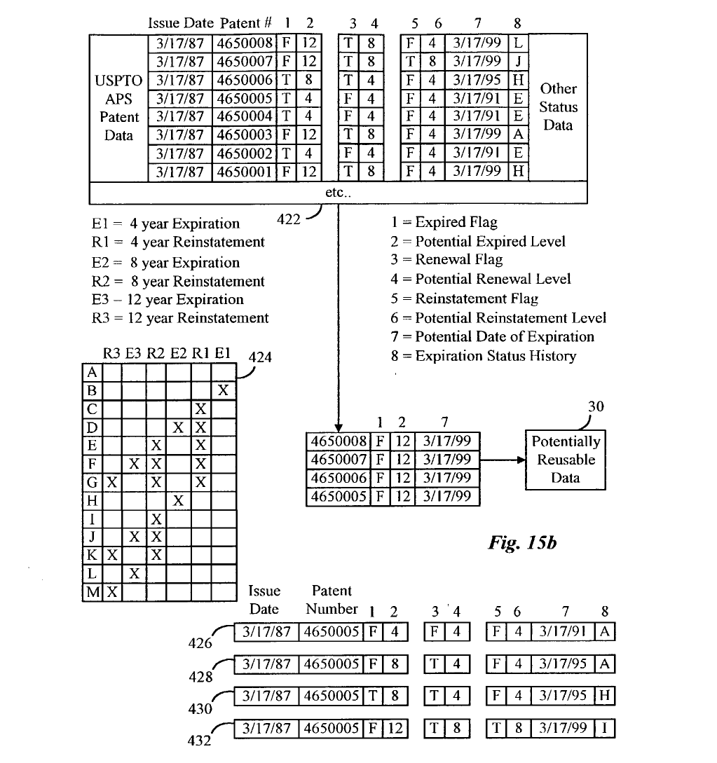

FIG. 15a is a flow chart illustrating the steps performed for utilizing the time delay between receiving newly issued and newly expiring information in accordance with the present invention. Though such techniques are applicable to different data set types such as domain names, trademarks, copyrights, etc., in a preferred aspect a subscriber 96 obtains a current delivery 400 including control data 126, news and advertising data 401, renewal, reinstatement and other status data 402, and newly issued patent data 354 by launching a program 34 that receives the current delivery 400 from the Internet 144 via the transceiver 92 of the computer system 32. Because of download size, installation, and remote indexing, the total delivery can take up to 15 minutes via 56K modem to view newly issued patent information 354. This download time can be utilized by viewing the newest premature expired patent information 130 and/or patent news and advertising of current events 401. Also, there are options to display any reinstatement information 420 that might be present. The files are downloaded in a batch where the control data 126 takes seconds to receive. In turn news and advertising data 401 can take less than 60 seconds to be received. Advantage can be taken of the multitasking operating system and if so desired, build and view the newest premature expirations 130 in less than 90 seconds with a 28.8K Baud modem speed.

While the newly issued data 354 is downloading, the program 34 retrieves configuration 403 information to determine if the preview mode is enabled 404 and if the preview mode 403 is automated. When the preview feature is enabled 404, a message is displayed 78 to view current expirations 406. If so, expirations are viewed 410 with search capabilities 160 until data is ready 414 with the option of viewing news 412 if enabled. If not, another message is displayed 78 to view the latest news and advertising 408. If so, news and advertising are viewed 412. When data is ready 414, or both the expirations 406 and news 408 are not to be viewed, or the automated preview service 404 is disabled, then a message is displayed 78 to ask if newly issued patents are to be viewed 416. If so, newly issued patents 354 are viewed 416 with search capabilities 160. If not, then the search engine 160 is activated. If the preview mode 403 is automated, then the above choices and messages are bypassed and subscriber 96 preferences are retrieved from configuration 403 to determine what preview features to display 78. At this point, the subscriber 96 can operate a computer user interface 80 (e.g., input device, such as a keyboard, mouse, etc.) to configure, query, browse, select, report, archive, order, or hyperlink 206 from the search engine 160 and connect to the Internet 144 or other on-line services via the transceiver 92 of the computer system 32 to view a selected document image and send order 206 or other information to the provider 94 for further document delivery or for ordering other request types such as back-ordering, reserving and the like.

FIG. 15b is a diagram illustrating data structures pertaining to status updates in an information data repository in accordance with the present invention. Though such techniques are applicable to different data set types such as domain names, trademarks, copyrights, etc., in a preferred aspect data structures of patent status information are shown. It is necessary to extend the data structures of patent database information 422 to manage status updates. Fields 1 through 6 are used to list the most recent status change of premature expirations, reinstatements, and renewal of maintenance fees. (Field 7) lists the potential date of expiration and (field 8) shows a complete history of expiration updates in fields 1 through 6. There is a lookup table 424, that have 13 possible outcomes denoted by the characters A through M to determine the status history of a premature expiration during the patent's enforcement. The outcome corresponds to (field 8) in the previous data structure 422. An example of the continued update for a given record 426 is provided. When a maintenance fee is paid 428, the renewal flag (field 3) is modified to a TRUE. In turn, the expired level (field 2), the potential expiration date (field 7), and the expiration status history are advanced to the eight year level. When the patent prematurely expires 430, the expired flag (field 1) is modified to a TRUE and the status history (field 8) is updated. When a late fee is paid 432, the renewal flag (field 3) and the reinstatement flag (field 5) are modified to a TRUE, the expired flag (field 1) is modified to a FALSE, and all other status records are advanced to the next level. Status updates are performed with respect to the anticipation of a future event to assure that the final step of updating is reduced to, if and when possible, the change of a single status bit only (e.g., upon the update of a premature expiration, the potential expiration date (field 7) becomes the actual expiration date). The usage for status updates are shown for example, by querying for all FALSE expired flags (field 1) and grouping data by potential expiration date (field 7). The updated data structures are then used to generate a batch of data files that include potentially reusable data 30 and placed on a portable storage media or sent to a subscriber for immediate transmission. The arrangement of data for each data file is optimized in advance to minimize data size of reference data for subsequent deliveries.

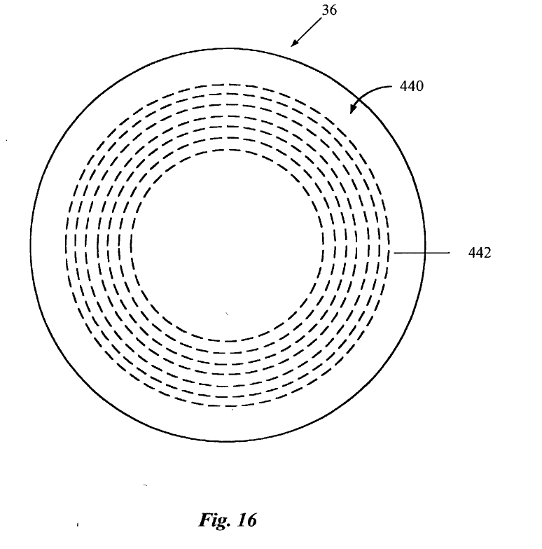

FIG. 16 is an elevation view illustrating a portable storage medium in accordance with the present invention. Though such techniques are applicable to different data set types such as domain names, trademarks, copyrights, etc., in a preferred aspect a preferred portable storage medium 62 is shown. The preferred storage medium 62 is a diskette with representative tracks 440, each track 440 having sectors 442 such as for example sector 442. In the preferred aspect all tracks 440 contain two additional sectors 442 to provide for 160 KB of hidden partitions on an 80-track diskette. The update data of a current delivery 400 including control data 126, news and advertising data 401, renewal, reinstatement and other status data 402 is stored thereon so as to be inaccessible to some degree to conventional programs. The newly issued patent data 354 of the current delivery 400 is stored on the conventional storage portion of the diskette. By storing the current delivery of update data 400 in the hidden partitions, conventional storage capacity of the storage medium 62 is not reduced. The current delivery 400 is preferably stored in a compressed form and decompressed prior to system installation.

The two additional sectors 442 at the end of each track 440 provide a rotational delay between the last conventional sector 442. The delay provides the disk drive enough time to reposition the head on the next track 440 before the first sector 442 of the next track 440 passes under the head thereby speeding up access to data on the diskette. However, it will be appreciated that the present invention has applicability to any suitable storage medium 62 (e.g., diskette, CD-ROM, tape drive, etc.).

As stated, the present invention is not limited to patent related information or other information that passes into the public domain, such as trademarks, domain names (e.g., WHOIS database of a NIC registry or registrar service), telephone numbers, and copyrights. The invention is also used to extend the reuse of information that has an ever-changing availability such as, but not limited to, any information having at least one renewal, expiry, or anniversary date or at least one pending, holding, or grace period. Other information includes a set of URIs and content thereof, content stored on at least one computer readable medium such as storage media or stored in at least one cache, file, spreadsheet, database, or the like. Other examples of information/data include, marks, motor vehicle registrations, IP addresses, keywords, stock symbols, and station identifiers, bankruptcy data, digital certificates, zone files, IP addresses, press releases, intellectual property, real estate (property for sale, lease, rent, forfeitures of property and/or property tax, etc.), judgements, mortgage, liens, auctions, resumes and job availability, advertising (seasonal, personals, classifieds, etc.), news, price lists, periodicals, library books, leasing, licensing, rentals, scheduling (arrival/departure), permits and licenses (e.g., liquor license, etc.), parole dates, coupons, rebates, offers, top lists (top 10/40, bestsellers, etc.), and other lists (shopping, to do, scavenger hunt, etc.).

Other examples of different applications listed above are also discussed. For instance, service providers are licensed to use tiered subscribing and receive the “top 100” songs for a given publication period. Each week the new “top 40” songs are determined and a delivery is sent to a licensed service provider of new songs from the “top 40” that are not part of the “top 100” songs. In addition, reference data/control data is sent to determine which songs from the “top 100” are part of the “top 40” songs. Between receiving the combination of new songs and reference data, a new compilation of the “top 40” songs can be generated. Furthermore, smaller subsets can be derived such as releasing “top 10” songs, etc. These generated subsets can be used as a data source automated to be custom recorded on a portable storage media such in a CD or DVD type format or encoded as a real-time streaming multimedia audio format such as MP3 or Real Audio for access on a network such as the Internet. This method can be applied to any periodical ranking or listing system.

It is known in advance when a parole hearing is heard but is unknown as to the release date of a parolee. A notification service is used to inform the public of the premature release of a parolee. Victims and their family, friends, neighbors, community, and public for reasons of awareness and safety are notified of such information.

Library books, videotapes, other periodicals, and any circulation system where articles are temporarily unavailable are also applicable. For a given day, x number of articles have become unavailable and y number of articles have become available. A delivery of data is prepared that represents both x and y articles. Also, included in the delivery is an encoded update mechanism to indicate what books have been returned early (and/or late).

The duration of the U.S. copyright protection for songs created on or after Jan. 1, 1978, is 50 years after the death of the author or last surviving co-author. For works created prior to Jan. 1, 1978, the duration of U.S. copyright protection is 75 years after the last day of the year in which the copyright was secured. If the composer was an employee of the publisher, therefore making the composition a “work-for-hire,” the duration of the copyright protection is 75 years from the first publication, or 100 years from creation, whichever occurs first. Duration of copyright for countries outside of the United States is generally, but not always, 50 years after the death of the author or last surviving co-author. Again because works copyrighted prior to Jan. 1, 1978 in the U.S. are copyrighted for a certain set amount of years, this leads to inconsistencies when licensing for worldwide rights, and public domain status needs to be verified on a country-by-country basis, which can be a cumbersome and complicated process. Because it is unclear when a copyright enters the public domain, new databases can be created from a main copyright database stored on the subscriber/client side, as it is determined when a copyright will actually expire.

Citation reporting services can be improved by delivering, in advance, a citation cache of material (documents, abstracts, images, database, data files, etc.) that is more frequently cited than other material. For instance, each week as patent information is issued reference is made to prior art of other patents. By sending new patents with the references that correspond to prior art patents that have been delivered as a citation cache in advance, the results of citation reporting is accomplished reducing the bandwidth of each weekly delivery.

The records of all departures for a given time that spans all geography and all modes of scheduled travel are stored in a file or database. An encoded bit mask is then periodically sent to map over the file and is combined with stored data to notify passengers of any such flights that have changed departure time. In addition, those departures that are delayed can be appended to other files or databases that represent a later departure time. A subscriber can use the preset query filter/watch list 216 as a means to notify one of specific travel information. The converse can be applied to arrival information as well.

Coupon and advertising delivery applications may only update partial information such as updated pricing, discount amount, expiration dates, and other pertinent data that is sent in conjunction with the control/reference data to form the newly indexed available information. The partial information is then combined with reusable components of a coupon, ad, rebate, offer, etc. having different expiration periods such as the brand/image/logo, store location, and/or any other information that has the context of being a reusable component and combined to form the renewed coupon, rebate, offer, or seasonal advertisement, etc.

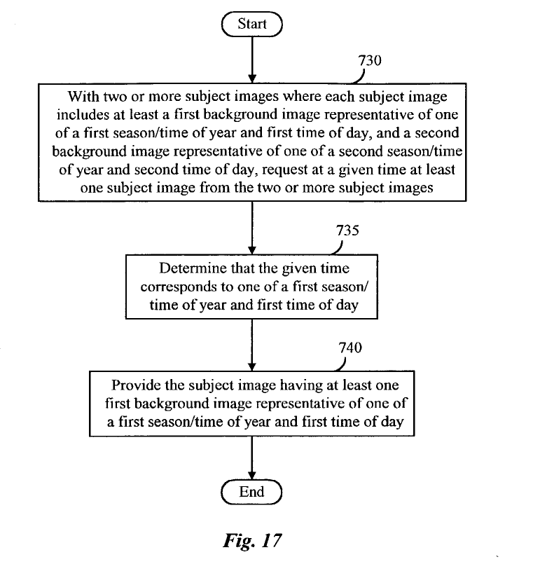

FIG. 17 is a flow chart illustrating the steps performed for automatically selecting a subject image corresponding to time of day and/or time of year in accordance with the present invention. With two or more subject images where each subject image includes at least a first background image representative of one of a first season/first time of year and first time of day, and a second background image representative of one of a second season/second time of year and second time of day, when at least one subject image from the two or more subject images is requested in step 730 at a given time, it can be determined in step 735 that the given time corresponds to one of a first season and first time of day. The subject image having at least one first background image representative of one of a first season and first time of day can then be selected and rendered or provided in step 740. For example, digital images of commercial and residential real estate property for a selected geographic area is stored on a portable storage medium such as CD-ROM or DVD-ROM and delivered in a first delivery to subscribers. In a preferred aspect, a plurality of photos are used to provide front, side, back, or panoramic views of the property or the photos visually represent the property as viewed over the course of the seasons. For instance, photos of a property are taken both in the summer and winter. Subsequent deliveries of reference data can determine which seasonal photo is displayed based on the publication date of the reference data. In a more specific application, rental properties are partitioned by the renewal date of the rental lease. Reference data is generated for each partitioned data set and is used by the subscriber to display newly available properties in a given geographic area.

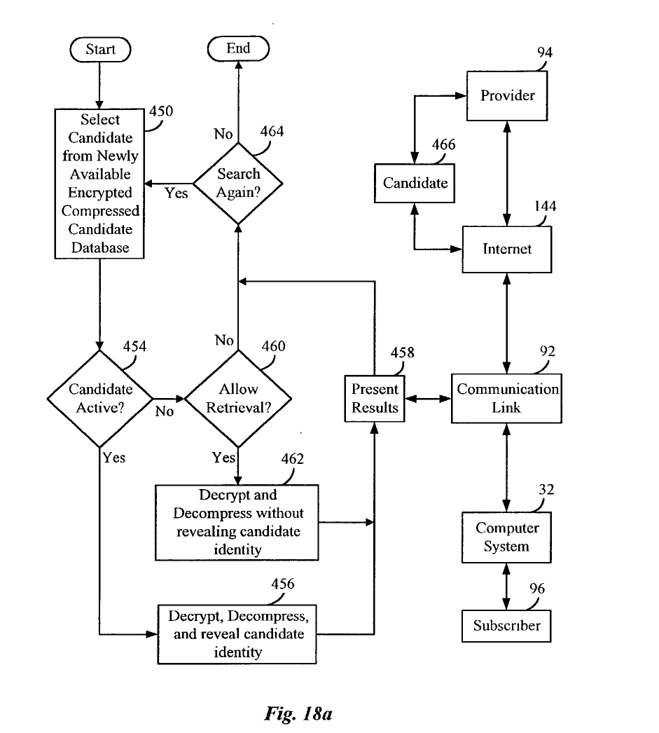

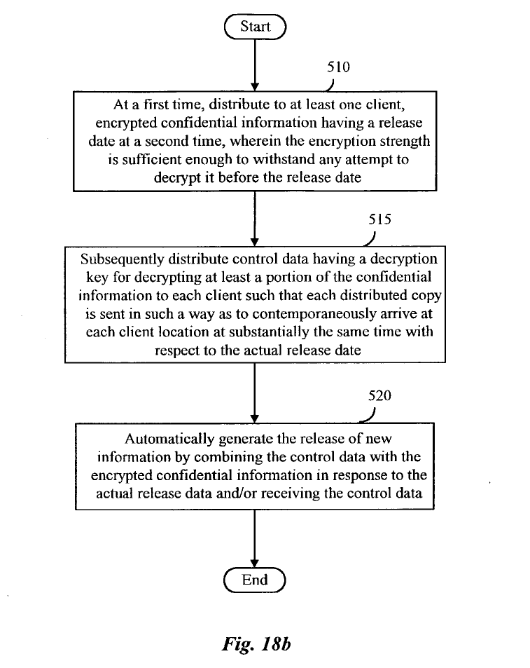

FIG. 18a is a flow chart illustrating a system and steps performed for reusing résumé information of job applicants in accordance with the present invention. All applicant information is encrypted and compressed 450 for privacy. A search 452 is performed where the retrieval 452 of the search 452 is displayed 78 based on the applicant's status. All records where the status of the applicant is active 454 are decrypted and decompressed, and r e sum e information including their name 456 is displayed 78. If the status is not active 454, another status is checked for anonymous retrieval 460. All records where retrieval 452 is not allowed 460 are skipped. When retrieval 452 of the applicant is allowed 460, all records of résumé information without the applicant's name 462 are then decrypted and decompressed for display 78. After all records are displayed 78, the program can perform another search 464. If the subscriber 96 is interested in contacting the anonymously represented applicant 466, the provider 94 can be contacted by telephone or through the Internet 144 via the transceiver 92 of the computer system 32 to act as an intermediary and broker the negotiations between the subscriber 96 and applicant 466. The function of brokering can be applied to other applications (e.g., personal ads, auctions, sealed bids, etc. as listed above) where client confidentiality is requested.

In another example, listings of 800,000 job descriptions are placed on DVD-ROM and each week receive a 100K file of control/reference data to trigger which records to index and to display what jobs are available. In another example, the résumés of job applicants are placed on DVD-ROM. The applicants are either on or off the job search market for a given interval. The applicant may still want to be searched or notified by an employer or recruiter even when the applicant is off the market. The practice of encryption and compression is not limited to this aspect but rather can be applied to all aspects of the present invention in general.

FIG. 18b is a flow chart illustrating the steps performed for the release of new information in accordance with the present invention. At a first time, encrypted confidential information having a release date with an encryption strength sufficient enough to withstand any attempt to decrypt it before the release date can be distributed in step 510 to at least one client. Control data, a decryption key, control data having a decryption key, a decryption key having control data for decrypting at least a portion of the confidential information can then be subsequently distributed in step 515, preferably so that each distributed copy is sent to each client in such a way as to contemporaneously arrive at each client location at substantially the same time with respect to the actual release date. The release of new information can be automatically generated in step 520 by combining the control data with the encrypted confidential information in response to receiving the control data and/or on or after the release date. Such information can be distributed through a variety of mediums. For instance, such information can be stored on a computer readable medium such as portable storage media for client distribution or transmitted via a communication network using a transmission protocol such as a Secure Socket Layer (SSL) encrypted TCP/IP connection.

The control data can be sent/received/updated any time before the release date and need only be relied on for determining which portion of encrypted information to decrypt. An executable program can be provided for the purpose of combining the control data/decryption key with the encrypted confidential information (step 520) and further include a scheduler in communication with a network clock (not shown) such as an atomic clock operatively associated with the communication network for authenticating and determining either when to retrieve the control data/decryption key and/or generate the newly released decrypted information. One or more subscriber identifiers, access levels, release dates, and scheduling rules can be embedded in the control data and/or decryption key for the purpose of authenticating whom, when, where, what, and how information is released. Scheduling rules can further include fuzzy time, intermittence, frequency and/or duration for accessing/pinging a network clock via the scheduler. When it is determined and authenticated that the current time is fuzzy/proximate to the release date, data generation and decryption can be performed accordingly to receive distributed synchronized access to newly released information. Furthermore, each decryption key and/or control data can be assigned a separate distribution time taking into account network speed, provider and subscriber location to assist in enabling, if need be, the widest possible synchronized access to the released information.

A prudent measure for protecting the confidentiality of information is to have a sole centralized source. Copies of this source, particularly if such copies are distributed, can increase the possibility of compromising the security of the information. Because of this, there has remained no need for a provider, and in particular, a sole-source data provider to distribute confidential/unreleased information in advance of a release date (e.g., the moment that confidential information is released to the public or falls in the public domain). Advantage can be taken by the advanced distribution of unreleased (e.g., press releases, copyrighted materials such as literary works, music, movies, etc.) or confidential (e.g., classified or top secret government information, trade secret information or the like) material which carries an encryption (e.g., public-key, PGP, Triple DES, etc.) strong enough to not be decoded before the release or declassification of such material. By using advanced distribution, the final delivery of data sent (e.g., control/reference data and/or decryption key) is minimized for a subscriber or the public to access at least a subset of the encrypted material that allows for the synchronization of contemporaneous access to the dissemination of new information by a wider population, particularly when it is unclear as to exactly when the material is to be released.

For example, a marketing firm can on behalf of a client prepare encrypted information having an ad campaign that over time introduces different portions of the entire ad campaign as a means to enable a campaign or marketing message to unfold or be revealed. By so doing, a single campaign may in effect have multiple release dates and can be accessed by providing over time a decryption key corresponding to each portion or newly introduced aspect of the campaign. In addition, subscribers may have different levels of authorized access which span multiple release dates. For instance, a decryption key is distributed to only a portion of subscribers having premium access. A movie on DVD can be released to the public, but only critics, the press, and other select subscribers can have advanced access to such information.

In another example, a provider of information such as Press Release (PR) firm releases via the Internet encrypted materials of client press releases. The target date for releasing material to the public for client A is three weeks later. However, two days before the release date, the client requests a release date change due to delays in promoting a new campaign. Control/reference data is distributed on the new release date that corresponds to client A within the batch of encrypted material distributed by the PR firm. A provider/subscriber program can be executed to combine the encrypted material with the control data to display for review to a subscriber or the public a decrypted portion of the encrypted material, which in this case releases new information concerning client A. As a result network bandwidth is significantly reduced while eliminating the step of distributing the entire material on the release date.

When the future release of existing information is very time sensitive or have application to a first come first serve (FCFS) system, it is of increased importance to synchronize the release of the information so that the public or as many subscribers/clients as possible have equal opportunity to access or receive such released materials at the substantially the same time in order to make decisions and/or quickly respond to such information accordingly by performing one or more registering, assigning, provisioning, auctioning, ordering, messaging response mechanisms and the like. If the material is not distributed in advance, the problems of bandwidth, bottlenecking, and overload and possible abuse of system resources in a network can occur when too many clients are trying to simultaneously access such information. For instance, such problems can occur in a FCFS system such as a system for re-registering newly available domain names.

There was never an incentive or reason for a sole-source data provider such as a domain name registry to publish in advance precisely when which domain names are to become soon to be or newly available for registration. Abuse of SRS system resources can be mitigated if subscribers/clients such as registrars and registrants have advance access to this information. Removing the doubt of when and which domain names are deleted from the registry and made newly available, will lessen the demand of accessing other system resources such as name servers, zone files, and WHOIS databases as a means of predicting which domain names may soon be available.

In one aspect, a registry can distribute to participating registrars information having a list of domain names that may soon be available for registration at a specified future time. Such a list may optionally be encrypted. Subsequently control data can be sent to make changes, additions, and corrections to the list and/or for accessing and/or decrypting only a portion of the list. For instance, the information can be scheduled to be decrypted ten minutes before registry access by a registrar is allowed for the purpose of competing for re-registration in a FCFS system.

By distributing the encrypted material in advance, as discussed reduces bandwidth and minimizes the final delivery of information allowing the public or subscribers to contemporaneously access the newly released material. In addition, time zones can be taken into account through authentication of subscriber location or based on operatively associating Global Positioning System (GPS) and/or universal network clock with the communication network to assure that the final delivery of a decryption key, for example, can propagate through any public network such as the Internet via satellite or other form of transmission allowing for maximum contemporaneous distributed access to previously distributed encrypted materials or a subset thereof for the purpose of releasing new information. In addition, the encrypted material can be distributed in advance and cached by sending such material to geographically scattered licensed service providers for use in tiered subscribing applications. Encrypted confidential information can be distributed to data escrow providers (DEPs) to safegard data populated in an escrowed data cache. On or about the release date, the information stored at the DEP can be used to increase contemporaneous access while minimizing network bandwidth when providing newly released information.

Control/reference data is the representation of an updated status that is dependent upon knowing when a status will change but not what, knowing what status will be changed but not when, and knowing neither what status will be changed nor when a status will change. The aspects discussed focus primarily on the change in status of potentially reusable data. Furthermore, indexes are not limited to being created remotely at the subscriber site. For cases where the delivery time of the indexes does not exceed the time needed to create the indexes at the subscriber site, the provider sends the indexes. Though control data as an encoded bit mask can in some cases represent the most efficient way to send update information, data updates are not limited to being sent in the form of an encoded bit mask. A database of identifiers such as premature expired patent numbers, telephone numbers or domain names, for instance, can be sent instead. Furthermore, potentially reusable data can be more specifically defined in terms of potentially usable and/or potentially reusable data. Press releases, wills, and the declassification of confidential information or the like that have a one-time use at a future date, serve as examples of potentially usable data.

Though the issue date, expiry date, release date, renewal date, anniversary date, or the like may have a known (one time or periodic) date/time in advance, such a date/time event may be subject to change with little or no notice creating an uncertainty as to when new information is delivered/available. There is a degree of fuzziness as to when an event may occur, known as a “fuzzy date” or “fuzzy expiration” which affects the delivery of newly issued information, potentially reusable information, or control/reference data. Co-pending provisional application 60/154,411 is applied to process these “fuzzy dates” in order to assure information delivery, data updates, and compilation of new information as discussed in the present invention.

The invention has use in a business/legal environment. For example, reference files are maintained containing data that is used in conjunction with various software applications. For instance in a law firm database, rules, regulations, citations, and various statutory dates and deadlines are stored in files that are referenced by software applications that use the reference data in making computations and decisions. If the reference data is incorrect, then it is highly probable that the output computation and/or decision made by the software is erroneous. Thus, if update reference data were stored in conjunction with regular data that is to be applied to the system (in a similar manner to that described above with respect to the data reference updates), the system would be using the most recent reference data.

Further uses of the present invention can include configuring the preset query to flag a group of patents or trademarks that the subscriber is licensing technology from. This customized information assures the subscriber that they're not continuing to pay licensing or royalty fees on a premature expired patent or trademark. By gaining competitive intelligence on abandoned patents and technologies, a subscriber can better evaluate the research and development costs of similar work. For example, a corporation will seek the counsel of a patent law firm to evaluate the potential that their new product may infringe on the intellectual property of a competitor. A competitive intelligence search is performed by the law firm, and all patents and trademarks in question are further searched for premature patent and trademark expiration as information to be used in advising the client that a patent or trademark that may infringe no longer infringes due to the determination of early expiration.

By providing premature expired patents that can be made, used, or sold by anyone, the use of the clipping service to automate subscriber access allows for a new non-technical audience outside of the legal, corporate, and scientific communities to become familiarized with the patent system. Via the Internet, this information can be disseminated to any person in the world with access to a computer and a network or dial-up connection. In addition, professors of science and engineering at universities can now incorporate this lapsed property for use in their syllabus in the form of lab experiments and homework assignments. In addition, the publishing of all resulting statistics associated with premature expired information becomes of new use as well. For instance, the ratio of expirations can be compared law firms to help inform an inventor as to what law firm to select for assistance. Other statistics include that of expirations across companies, geography, and industry as well. Though the detailed description illustrates the invention from a provider/subscriber point of view, the invention does not rely on both parties and can be practiced separately by either party.

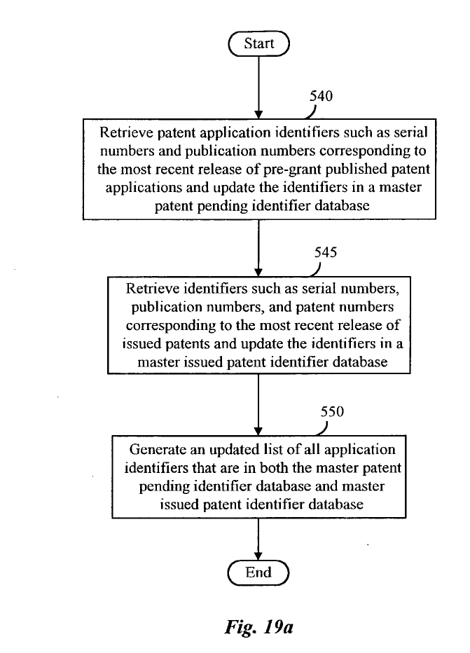

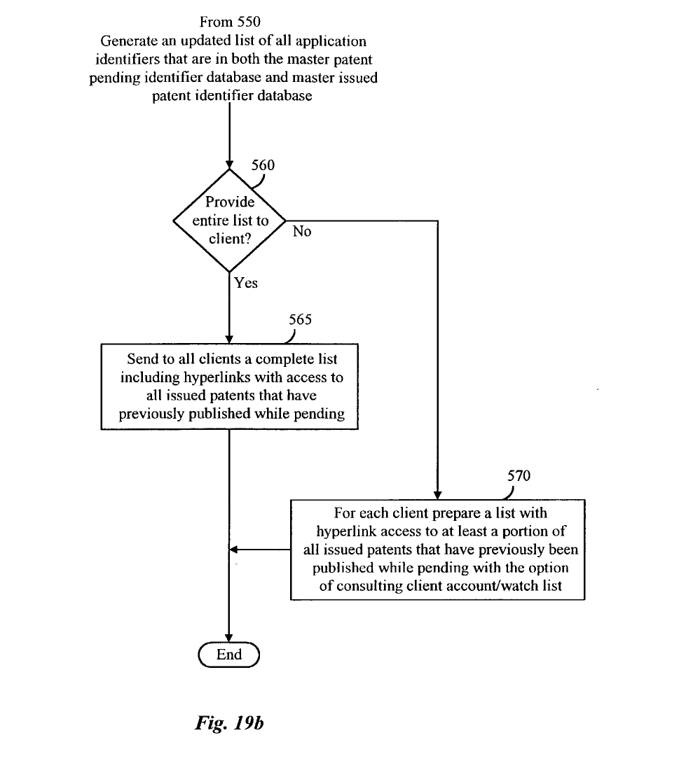

FIG. 19a is a flow chart illustrating the steps performed for updating a list of application identifiers in accordance with the present invention. When the most recent release of pre-grant published patent applications are received, all corresponding patent application identifiers such as serial numbers and publication numbers are then retrieved and updated in step 540 in a master patent pending identifier database. In turn, when the most recent release of issued patents are received, all corresponding patent identifiers such as serial numbers, patent numbers, and publication numbers are then retrieved and updated in step 545 in a master issued patent identifier database. After both databases are updated, an updated list of all application identifiers that are in both the master patent pending identifier database and master issued patent identifier database can be generated in step 550.

FIG. 19b is a flow chart illustrating the steps performed for notifying client of at least a portion of an updated list of identifiers in accordance with the present invention. When an updated list of all application identifiers that are in both the master patent pending identifier database and master issued patent identifier database are generated (step 550), it can de determined in step 560 whether to provide the entire list to any client(s). If so, then a complete list including hyperlinks with access to all issued patents that have previously been published while pending are sent in step 565 to all clients who have designated receiving such information otherwise a custom list having hyperlink access to at least a portion of all issued patents that have previously been published while pending with can be prepared with the option of consulting client account/watch list for each client and in turn sent in step 570 to each client.

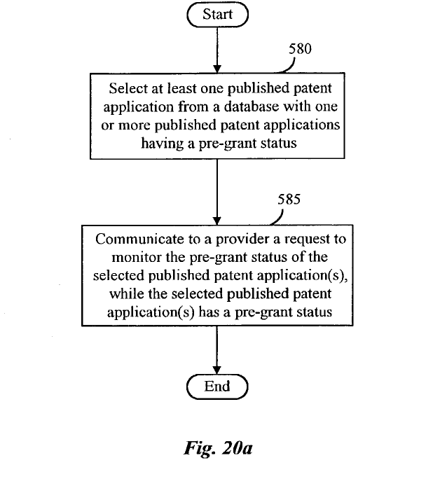

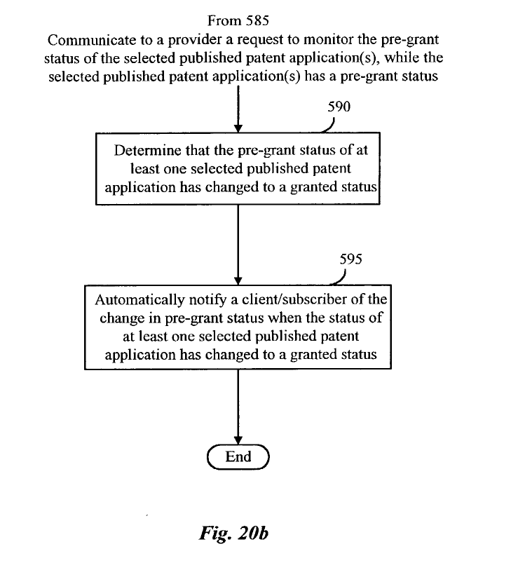

FIG. 20a is a flow chart illustrating the steps performed for communicating a monitoring request to a provider in accordance with the present invention. A client/customer/subscriber can select from a list in step 580 at least one published patent application from a database with one or more published patent applications having a pre-grant status. A request to monitor the pre-grant status of the selected published patent application(s), while the selected published patent application(s) has a pre-grant status can then be communicated in step 585 to a provider.

FIG. 20b is a flow chart illustrating the steps performed for notifying a client of a status change in accordance with the present invention. After a request to monitor the pre-grant status of the selected published patent application(s) is communicated to the provider (step 585) and when a provider determines in step 590 that the pre-grant status of at least one selected published patent application has changed to a granted status, the client/subscriber can then be automatically notified in step 595 of the change in pre-grant status when the status of at least one selected published patent application has changed to a granted status.

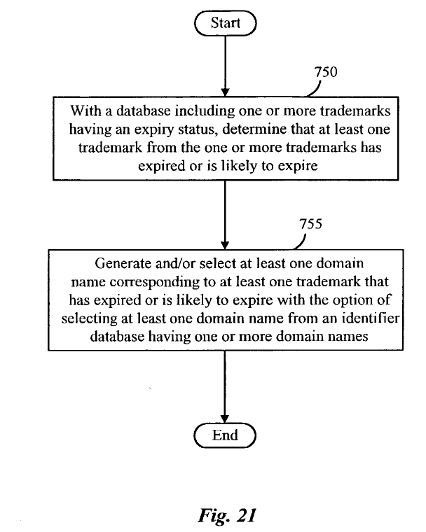

FIG. 21 is a flow chart illustrating the steps performed for selecting both trademark and domain name identifiers in accordance with the present invention. With a database including one or more trademarks having an expiry status, it can be determined in step 750 when at least one trademark from the one or more trademarks has expired or the likelihood of soon expiring. At least one domain name corresponding to such at least one trademark can then be generated and/or selected in step 755 with the option of selecting at least one domain name from an identifier database having one or more domain names. For instance, a script such as a Perl or CGI script can be used to autofetch and compile trademark and/or domain name data. A URL can be constructed representative of each trademark in a weekly dataset of trademarks that could potentially expire for failure to renew and then used to locate and access a network resource with respect to status and/or payment information corresponding to the trademark.

USPTO publishes weekly in OG notices the serial and registration numbers of expiring trademarks. The release of these trademark identifiers only, limits the public to a manual, exhaustive, and inefficient cross-referenced retrieval of the newest trademark information that have expired, thereby creating for a new need to compile this information for the purpose of mitigating such unnecessary human resources. More recently, since the 23rd week of 2001, the USPTO has reflected these trademark identifiers in electronic OG notices accessible via the Internet. The following template includes variables called year and weekno used for constructing a URL to locate and access the list of expiring trademark identifiers:

[““.year.http://www.uspto.gov/web/offices/com/sol/og/”/week”.weekno.“/pattmex.htm”]

A program or script can be adapted to generate a URL for each week for the purpose of extracting identifiers of expiring trademarks from the USPTO OG notice week after week. The extracted trademark identifiers can then be further used to construct URLs for the purpose of accessing and compiling expiring trademark summaries. For example, the following template includes a variable called serialno used for constructing a URL to locate and access a network resource with respect to status information corresponding to the trademark:

[“http://tarr.uspto.gov/servlet/tarr?regser=serial&entry=”.serialno]

When such status information is accessed, the mark and/or word only portion of the mark can be extracted and presented to a client via a communication network thereby adding value to the weekly list of identifiers corresponding to expiring trademarks. Furthermore, the script can be further used to remove any characters that does not include a-z, 0-9, and hyphen from the word only portion of each mark transforming the word only portion into an DNS friendly identifier. This friendly identifier can then be further used for the purpose of generating domain names that are similar to the expired trademark by concatenating one or more TLDs, prefixes, suffixes, variants, etc. and then performing a RRP, EPP, or WHOIS request as a means for determining whether such a generated domain name is available for registration similar to that of the newly expired trademark that can now be available for registration.

FIG. 22a is a flow chart illustrating the steps performed for building an property right creator/holder database such as an inventor/patent knowledgebase in accordance with the present invention. When newly published patent data including pending or issued patent data records are received in step 760, contact information from bibliographic data, file wrapper, and/or white pages corresponding to at least one inventor and/or assignee, attorney, agent, or firm for each received and/or selected patent data record can then be generated in step 765. With the generated contact information or from a contact list, a provider can then contact or communicate in step 770 via a communication network with at least one inventor and/or assignee, attorney, agent, or firm to obtain any supplemental information corresponding to a selected patent of interest including annotations and resume, skills, or qualifications of inventor with the option of indicating from the provider to either inventor/assignee or attorney/agent/firm of the use of patent recovery services as an alternative to allowing a patent expire early. All such gathered and/or obtained information can then be added/updated in step 775 to an inventor/patent knowledge base.

Only by obtaining the property right creator's unique insight and domain expertise with respect to the property right can real value be added to otherwise generic public information and assist in transforming an abandoned project into a saleable commodity. This symbiotic relationship with the inventor is a critical function in reducing the abandonment of a the creator's property right. For purposes of this application, the word “practitioner” and/or “designated agent/representative” is intended to include attorneys, agents, or any other individuals authorized to represent a client in legal cases including real property or intellectual property cases. For example, patent practitioners may include patent attorneys, patent agents, foreign attorneys dealing with patent cases, foreign patent agents, and the like.

FIG. 22b is a flow chart illustrating the steps performed for assessing the likelihood of assisting in maintaining the property right in accordance with the present invention. In another aspect, when newly published patent data including pending or issued patent data records are received (step 760), a value/weighted factor representative of the likelihood of assisting in maintaining the property right at a later date can be calculated/determined in step 780 with a master patent database/knowledge base updated in step 785.

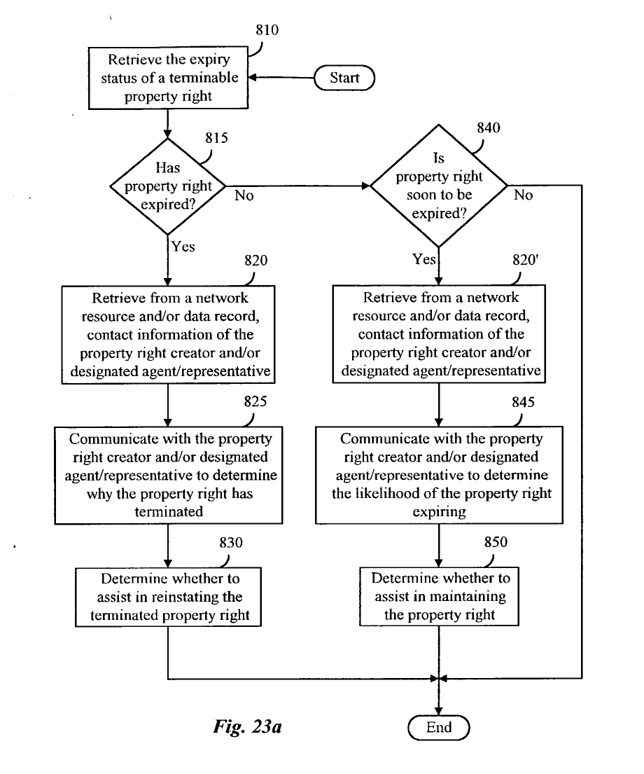

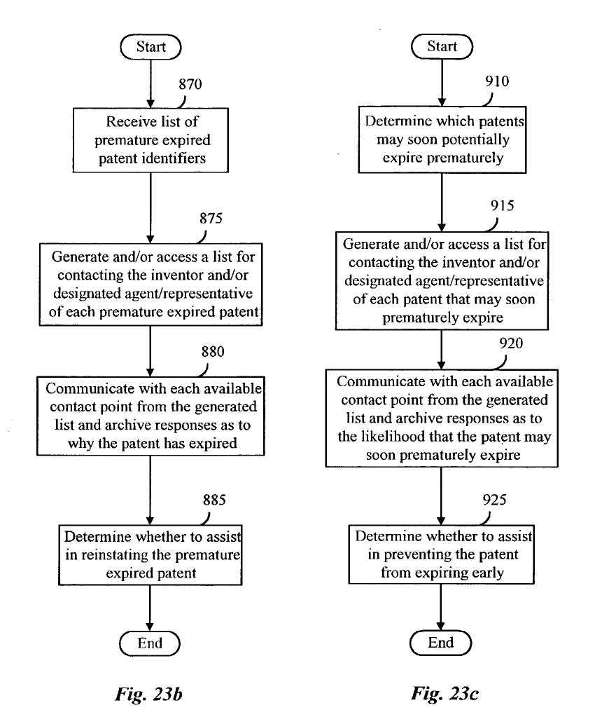

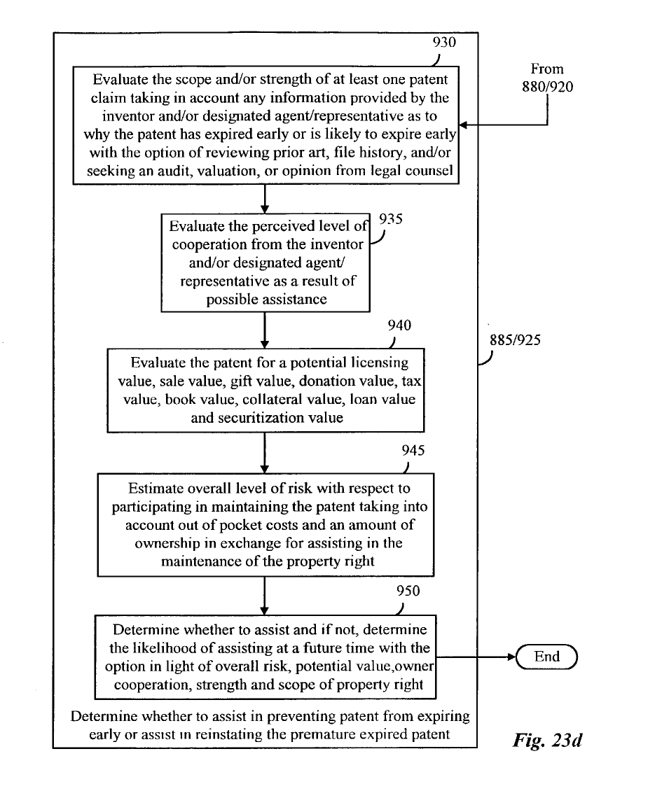

FIG. 23a is a flow chart illustrating the steps performed for communicating with a property right creator and/or designated agent/representative in accordance with the present invention. When the expiry status of a terminable property right is retrieved in step 810 and determined in step 815 that the property right has expired or terminated, a network resource and/or data record can be accessed in step 820 to obtain contact information of the property right creator and/or designated agent/representative. A provider or interested third party can then contact or communicate in step 825 via a communication network with the property right creator and/or designated agent/representative to determine why the property right has terminated. A determination can then be made in step 830 as to whether to assist the property creator in reinstating the terminated property right. When the property right has not expired or terminated (step 815), it can then be determined in step 840 whether the property right may be soon to be expired. If so, then a network resource and/or data record can be accessed in step 820′ to obtain contact information of the property right creator and/or designated agent/representative. A provider or interested third party can then contact or communicate in step 845 via a communication network with the property right creator and/or designated agent/representative to determine the likelihood of the property right expiring. A determination can then be made in step 850 as to whether to assist the property creator in maintaining the property right.

A terminable property right can be compared to a table having at least one terminated property right. The table can include contact information corresponding to one of a most recent owner and practitioner of most recent owner for each terminated property right. It can be determined whether to assist the most recent owner in reinstating at least a portion of the term of the terminated property right by communicating with one of a most recent owner and practitioner of most recent owner to learn why the term of the terminable property right has terminated and make a decision based on one or more reinstatement factors including evaluating the communication with one of a most recent owner and practitioner. Reinstatement factors can include evaluating one of an overall risk, value of property right, out-of-pocket expenses, cooperation level of the most recent owner, and scope of property right. A property right holder knowledgebase having at least one data record can be updated corresponding to the terminated property right with one of a communication with a most recent owner and with one or more reinstatement factors. The most recent owner can be the property right creator.

FIG. 23b is a flow chart illustrating the steps performed for determining whether to assist in reinstating a premature expired patent in accordance with the present invention. When a list of premature expired patent identifiers is received and/or accessed in step 870, a list for contacting the inventor and/or designated agent/representative of each premature expired patent can the be generated and/or accessed in step 875. A provider or interested third party can then contact or communicate in step 875 via a communication network with at least one available contact point from the contact list and archive responses into a knowledge base as to why the patent has expired early. A determination can then be made in step 880 as to whether to participate or assist in reinstating the premature expired patent.

FIG. 23c is a flow chart illustrating the steps performed for determining whether to assist in preventing the patent from expiring early in accordance with the present invention. When it is determined in step 910 which patents may soon potentially expire early, a list for contacting the inventor and/or designated agent/representative of each patent that may soon prematurely expire can the be generated and/or accessed in step 915. A provider or interested third party can then contact or communicate in step 920 via a communication network with at least one available contact point from the contact list and archive responses into a knowledge base as to the likelihood that the patent may soon expire early. A determination can then be made in step 925 as to whether to participate in preventing the patent from expiring early.

FIG. 23d is a flow chart illustrating in further detail the step performed for determining whether to assist in preventing the patent from expiring early or in reinstating a premature expired patent in accordance with the present invention. The scope and/or strength of at least one patent claim can be analyzed and evaluated in step 930 taking in account any information provided by the inventor and/or designated agent/representative as to why the patent has expired early or is likely to expire early with the option of reviewing prior art, file history, and/or seeking an audit, valuation, or opinion from legal counsel. The perceived level of cooperation of the inventor and/or designated agent/representative can be evaluated in step 935 as a result of possibly assisting. The property right or in this case the patent can be evaluated in step 940 for a potential licensing value, sale value, gift value, donation value, tax value, book value, collateral value, loan value, and securitization value. An overall level of risk with respect to assisting in maintaining the patent can be evaluated in step 945 taking into account out of pocket costs and an amount of ownership in exchange for assisting in the maintenance of the property right. After any one or combination of the above it can then be determined in step 950 whether to assist in the maintenance and if not, determine the likelihood of possibly assisting at a future time with the option in light of overall risk, potential value, owner cooperation, strength and scope of property right.

When a decision to assist is made, a decision maker such as a provider can then enter into an agreed arrangement with the property right holder and as a result prevent a property right from terminating and/or abandoning for failure to pay renewal/maintenance fees and the like. By so doing, the property right holder can continue to participate in the potential rewards of maintaining the property right that may otherwise have gone abandoned and the provider or entity that has assisted in the maintenance of the property right can now participate in the potential rewards immediately rather than wait for the abandonment/termination of such a property right and potentially lose the benefits of exclusivity.

As mentioned, there are numerous benefits for determining when a maintenance fee has been paid including the ability to increase the subscription period on a portable storage media and more quickly and accurately with less resources identify, locate, and communicate with a new market segment of patent owners that have a high likelihood of failing to pay for an upcoming maintenance fee. Without access to such information, all property right creators and their designated agents/representatives would need to be contacted for determining the likelihood of expiration. (e.g., 4,000 or more patents have the potential to expire early in any given week, but only 1,000 or so do). This means that 1 out of every 4 communications can result in identifying such potentially expiring patent. However, by determining from the compilation of distributed patent payment information that at least 90%-95% of all maintenance fee payments on average are made during the first six months of the one year payment window, only 1,200 property right holders would need to be contacted enabling the provider to more quickly and accurately with significant less time and resource determine the likelihood of premature expiration. With access to payment information, the ratio can increase to having 5 out of every 6 communications result in identifying such expiring patent giving a provider up to a near six month window to decide whether to assist the property right holder.

FIG. 24 is a flow chart illustrating the steps performed for generating contact information of a property right creator and/or designated agent/representative in accordance with the present invention. When patent office or fee payment gateway monitor system information on one or more patents each having a patent identifier, maintenance fee payment status including late fee surcharge if applicable a payment date, is received/accessed in step 960 then a master patent database and/or property right holder knowledgebase can be updated (step 775/785). More particularly, a patent weekly data set can be accessed at the start of a payment grace period for the purpose of identifying which patent identifiers are representative of those patents having a high likelihood of expiring early. A list for contacting the inventor and/or designated agent/representative of each patent can then be generated (step 915) that may soon expire early.

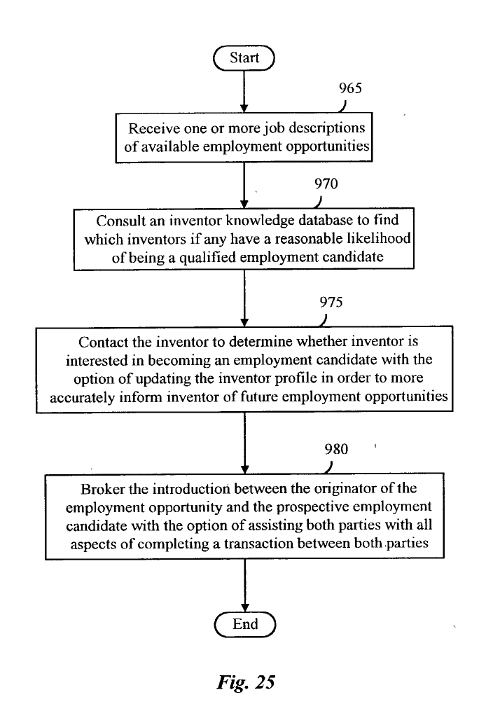

FIG. 25 is a flow chart illustrating the steps performed for brokering an employment transaction between two or more parties in accordance with the present invention. When one or more job descriptions of available employment opportunities is received in step 965, an inventor knowledge database can be consulted in step 970 to find which inventors if any have a reasonable likelihood of being a qualified employment candidate. Employment opportunities can include temporary employment, permanent employment, temp to perm employment, and contracting work. Each possible inventor can then be contacted by an employment broker in step 975 via a communication network to determine whether inventor is interested in becoming an employment candidate with the option of updating the inventor profile in order to more accurately inform inventor of future employment opportunities. Upon inventor interest, the introduction between the originator of the employment opportunity and the prospective employment candidate can then be brokered in step 980 with the option of assisting both parties with all aspects of completing an employment transaction between both parties. Brokering the employment transaction does not need to rely on the knowledgebase but can match employment opportunities with published patent information as a means to identify and locate one or more candidate inventors of interest.

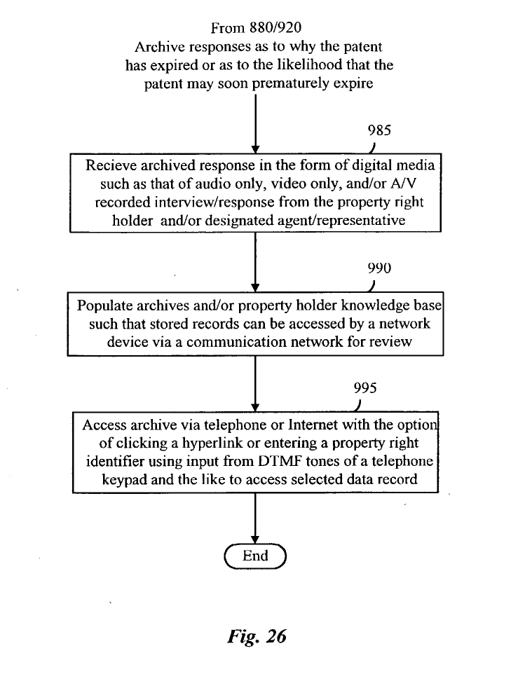

FIG. 26 is a flow chart illustrating the steps performed for accessing a property right holder knowledgebase via a communication network in accordance with the present invention. When responses as to why the patent has expired or as to the likelihood that the patent may soon prematurely expire have been archived (step 880 or step 920), such an archived response is created and/or received in step 985 in the form of digital media such as that of audio only (e.g., MP3 or WAV file), video only (AVI or MPEG file), and/or A/V recorded interview/response from the property right holder and/or designated agent/representative, such archived responses can then be stored/populated in step 990 into a property holder knowledge base and the like such that stored records can be accessed for review by a network device via a communication network. The knowledgebase/archive can then be accessed in step 995 via the telephone or Internet with the option of clicking a hyperlink or entering a property right identifier using input from DTMF tones of a telephone keypad and the like to access selected property right data record. For instance, a knowledgebase can be accessed via a touch-tone telephone by dialing a general number such as 1-800-INVENTBASE. Upon connecting to an information resource from a designated phone number, a caller can be prompted to dial digits representative of a property right identifier as a means to access a stored digital media archive pertaining to the property right (e.g., the identifier 6338082 can be dialed, to access an audio recording of the inventor of Pat. No. 6,338,082 where the recording includes annotations, supplementary information, and even a personal account of how the property right was first conceived, created, and the like).

FIG. 27 is a flow chart illustrating the steps performed for requesting a network resource in accordance with the present invention. When a request for a network resource from a first identifier having a domain name is received in step 1210, it can be determined in step 1215 whether the domain name is resolvable. If not, then it can be further determined in step 1220 whether the domain name is available for registration. When the domain name is available, a domain name registration form can then be provided in step 1225. When the domain name is determined (step 1215) to be resolvable (e.g., domain name can be translated into an IP address), then it can be determined in step 1230 whether the network resource can be located. If so, then the network resource can be requested in step 1235 from the first identifier. When the network resource is not locatable then it can be determined in step 1240 whether the domain name is available for back-order. If not, then the network resource can be requested in step 1245 from a locatable second identifier corresponding to the first identifier (e.g., www.trythis.com corresponds to trythis.com, office.microsoft.com corresponds to the fictitious domain name microsoft.office). However, when the domain name is not available for registration (step 1220) or when the domain name is available for back-order (step 1240), a domain name registrant record including back-order information can be provided to the requestor in step 1250 with the option of registering and/or back-ordering other similar domain names. In addition, search request processing (as discussed in U.S. patent application Ser. No. 09/598,134—U.S. patent application Ser. No. 09/653,100—U.S. patent application Ser. No. 09/682,133) can be integrated with the above steps in addition to processing one of a navigation, registration, and back-order request in response to failing to access a network resource from an identifier.

FIG. 28 is a flow chart illustrating the steps performed for communicating to a provider a desired action to take on behalf of the client to obtain an ownership interest in accordance with the present invention. When it is established in step 1260 that at least one identifier of significance to a client is unavailable for ownership by the client in a communication network having at least one communication link connecting at least one provider and the client, where each provider is in communication with at least one database storing at least one identifier having variable ownership status, information can be communicated in step 1265 to the at least one provider of at least one desired action the at least one provider is to take on behalf of the client to obtain an ownership interest in the at least one identifier of significance to the client, where the at least one identifier of significance to the client is unavailable for ownership by the client at the time of the communication. In turn, it can then be determined in step 1270 whether to perform the at least one desired action without monitoring the ownership status of the at least one identifier of significance to the client.

Identifiers of significance to the client that is unavailable for ownership by the client can be established in response to said performing one of a navigation request, search request, registration request, subscription request, and WHOIS request corresponding to at least a portion of the at least one identifier. Furthermore, identifiers of significance to the client that is unavailable for ownership by the client can be established by communicating from the at least one provider to the client the at least one identifier and selecting said at least one identifier of significance to the client from the at least one identifier.

Identifiers can be one of a telephone number, domain name, mark, motor vehicle registration, IP address, keyword, stock symbol, and station identifier. Ownership interest can include an interest in one of a title, deed, certificate, assignment, license, mortgage, registration, subscription, and contractual agreement. A desired action can be one of a notifying, transferring, registering, assigning, provisioning, bidding, escrowing, reserving, queuing, subscribing, ordering, pre-ordering, back-ordering, and pre-registering action.

Performing the at least one desired action can be attempted when it is determined that the at least one desired action is to be performed without monitoring the ownership status of said at least one identifier of significance to the client. Monitoring the ownership status of said at least one identifier of significance to the client and performing the at least one desired action can be attempted hen it is determined that said at least one desired action is not to be performed without monitoring the ownership status of said at least one identifier of significance to the client. Notification indicating a change in the ownership status of said at least one identifier of significance to the client can be communicated from the at least one provider to the client.

The communication network can be one of telephone network and Internet, the client can be one of a subscriber and registrant, and the at least one provider can be one of a registry, registrar, pooling administrator, subscription provider, and registration provider. A newly available domain name, mark, and/or phone number can correspond to said at least one identifier of significance to the client. The newly available domain name can be automatically registered in response to determining that the newly available domain name corresponds to the at least one identifier of significance to the client. A mark application can be automatically filed in response to determining that the newly available trademark corresponds to the at least one identifier of significance to the client. A newly available telephone number can be one of a reserved, assigned, and provisioned in response to determining that said newly available telephone number corresponds to the at least one identifier of significance to the client.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

I claim:

1-50. (canceled)

51. A computer-implemented method for maintaining a terminable property right having a term and a most recent owner comprising:
determining by a processor whether the term of the terminable property right has terminated;
determining from a source other than the most recent owner whether there is an increase in likelihood that the term of the terminable property right will terminate, when it is determined that the term of the terminable property right has not terminated, and,
determining whether to assist the most recent owner in maintaining the term of the terminable property right in response to said determining said increase in likelihood that the term of the terminable property right will terminate.

52. A method, as set forth in claim 51, further including selecting the terminable property right from a data set corresponding to one or more terminable property rights that each have a same future termination date.

53. A method, as set forth in claim 52, further including determining whether a status of a maintenance fee payment window corresponding to said data set of terminable property right is a one of a grace period status, surcharge period status, late fee period status, and renewal fee period status.

54. A method, as set forth in claim 51, wherein the terminable property right is one of a patent, trademark, copyright, domain name, and telephone number.

55. A computer-implemented method for maintaining a terminable property right having a term and a most recent owner comprising:
determining by a processor whether the term of the terminable property right has terminated;
determining from a source other than the most recent owner whether there is an increase in likelihood that the term of the terminable property right will terminate, when it is determined that the term of the terminable property right has not terminated; and,
notifying a provider that the most recent owner may need assistance in maintaining the term of the terminable property right in response to said determining said increase in likelihood that the term of the terminable property right will potentially terminate.

56. A method, as set forth in claim 55, further including determining whether to assist the most recent owner in maintaining the term of the terminable property right in response to said determining th said increase in likelihood that the term of the terminable property right will terminate.

57. A method, as set forth in claim 55, further including selecting the terminable property right from a data set corresponding to one or more terminable property rights that each have a same future termination date.

58. Amethod, as set forth in claim 57, further including determining whether a status of a maintenance fee payment window corresponding to said data set of terminable property right is a one of a grace period status, surcharge period status, late fee period status, and renewal fee period status.

59. A method, as set forth in claim 55, wherein the terminable property right is one of a patent, trademark, copyright, domain name, and telephone number.

60. A computer-implemented method for maintaining a terminable property right having a term and a most recent owner, wherein at least a portion of the term of the terminable property right that has terminated may be reinstated, comprising:
determining by a processor whether the term of the terminable property right has terminated;
determining whether to assist the most recent owner in reinstating said at least a portion of the term of the terminated property right when it is determined that the term of the terminable property right has terminated; and,
calculating from a source other than the most recent owner an amount of likelihood as to whether the term of the terminable property right will terminate at any time before an end of said term, when it is determined that the term of the terminable property right has not terminated.

61. A method, as set forth in claim 60, wherein said determining by said processor whether the term of the terminable property right has terminated further includes comparing the terminable property right to a table having at least one terminated property right.

62. A method, as set forth in claim 61, wherein said table includes contact information corresponding to one of a most recent owner and practitioner of most recent owner for each said terminated property right and said determining whether to assist the most recent owner in reinstating said at least a portion of the term of the terminated property right includes communicating with said one of a most recent owner and practitioner of most recent owner to learn why the term of the terminable property right has terminated.

63. A method, as set forth in claim 62, wherein said determining whether to assist the most recent owner in reinstating said at least a portion of the term of the terminated property right includes making a decision based on one or more reinstatement factors including evaluating said communication with said one of a most recent owner and practitioner of most recent owner.

64. A method, as set forth in claim 63, wherein said one or more reinstatement factors includes evaluating one of an overall risk, value of property right, out-of-pocket expenses, cooperation level of the most recent owner, and scope of property right.

65. A method, as set forth in claim 63, further including updating a property right holder knowledgebase having at least one data record corresponding to the terminated property right with one of a communication with said one of a most recent owner and practitioner of most recent owner and one or more reinstatement factors.

66. A method, as set forth in claim 60, further including determining whether to assist the most recent owner in maintaining the term of the terminable property right in response to said calculating from a source other than the most recent owner said amount of likelihood as to whether the term of the terminable property right will terminate at any time before said end of said term.

67. A method, as set forth in claim 60, wherein said determining by said processor that the term of the terminable property right has not terminated further includes comparing the terminable property right to a table having at least one terminable property right corresponding to a maintenance fee payment window.

68. A method, as set forth in claim 67, wherein said table includes contact information corresponding to one of a most recent owner and practitioner of most recent owner for each said terminable property right corresponding to said maintenance fee payment window and said determining whether to assist the most recent owner in maintaining the term of the terminable property right includes communicating with said one of a most recent owner and practitioner of most recent owner to learn why there is a likelihood that the most recent owner will allow the term of the terminable property right to terminate.

69. A method, as set forth in claim 68, wherein said determining whether to assist the most recent owner in maintaining the term of the terminable property right includes making a decision based on one or more maintenance factors including evaluating said communication with said one of a most recent owner and practitioner of most recent owner.

70. A method, as set forth in claim 69, wherein said one or more maintenance factors includes evaluating one of an overall risk, value of property right, out-of-pocket expenses, cooperation level of the most recent owner, and scope of property right.

71. A method, as set forth in claim 69, further including updating a property right holder knowledgebase having at least one data record corresponding to the terminable property right corresponding to said maintenance fee payment window with one of a communication with said one of a most recent owner and practitioner of most recent owner, and one or more maintenance factors.

72. A method, as set forth in claim 60, wherein said calculating from a source other than the most recent owner said amount of likelihood as to whether the term of the terminable property right will terminate at any time before said end of said term includes determining whether a status of a maintenance fee payment window corresponding to the terminable property right is a grace period status or surcharge period status.

73. A method, as set forth in claim 60, further including selecting the terminable property right from a data set corresponding to one or more terminable property rights that each have a same said end of said term.

74. A method, as set forth in claim 60, wherein said end of said term includes one or more possible termination dates.

75. A method, as set forth in claim 60, wherein the terminable property right is one of a patent, trademark, copyright, domain name, and telephone number.

76. A computer-implemented method for maintaining a terminable property right having a term and a most recent owner comprising:
determining by a processor whether the terminable property right includes an active maintenance fee payment window;
determining whether a status of said maintenance fee payment window corresponding to the terminable property right is a grace period status or surcharge period status, when it is determined that the terminable property right includes said active maintenance fee payment window; and,
determining whether to assist the most recent owner in maintaining the term of the terminable property right in response to said determining said status of said maintenance fee payment window corresponding to the terminable property right is said surcharge period status.
